(19) United States
(12) Patent Application Publication
(10) Pub. No.: US 2005/0048422 A1
(43) Pub. Date: Mar. 3, 2005

(54) Packaged member of photothermographic material and image forming method for photothermographic material

(76) Inventor: Hajime Nakagawa, Kanagawa (JP)

Correspondence Address: TAIYO CORPORATION, 2111 JEFFERSON DAVIS HIGHWAY, #412, NORTH, ARLINGTON, VA, 22202, US

(21) Appl. No.: 10/921,997

(22) Filed: Aug. 20, 2004

(30) Foreign Application Priority Data
Sep. 1, 2003 (JP) 2003-308663

(51) Int. Cl. G03C 1/46

(52) U.S. Cl. 430/502

(57) ABSTRACT

The invention provides a packaged member which comprises a photothermographic material and a packaging bag, wherein an interior of the packaging bag has a humidity of 50% RH or less at 25° C., the photothermographic material includes, on one surface of a substrate, an image forming layer comprising a photosensitive silver halide, a non-photosensitive organic silver salt, a reducing agent and a binder, and at least one of the following conditions (1) to (4) is satisfied. (1) 50 mass % or more of the binder is a polymer having a glass transition temperature from 70 to 110° C. (2) 50 mol. % or more of the non-photosensitive organic silver salt is silver behenate (3) The reducing agent is a specific organic polyhalogen compound. (4) The photothermographic material includes a development accelerator. The invention further provides a image forming method which uses the packaged member.

### CROSS-REFERENCE TO RELATED APPLICATION

This application claims benefit of and priority to Japanese Patent Application No. 2003-308663, filed on Sep. 1, 2003, which is incorporated herein by reference in its entirety for all purposes.

### BACKGROUND OF THE INVENTION

1. Field of the Invention

The present invention relates to a photothermographic material, and more particularly to a packaged member of a photothermographic material having excellent unprocessed stock storability, and an image forming method for a photothermographic material.

2. Description of the Related Art

In recent years, it has been strongly desired in the medical field and in the printing plate-making field to adopt dry photographic development processing in consideration of environmental conservation and space saving. In these fields, digital data processing is showing rapid progress, and a system of delivering image information into a computer, storing the information therein, and processing the information according to necessity is rapidly expanding. It is now possible to output the information on a photosensitive material by a laser image setter or a laser imager at a location where it is needed through communication, and to develop an image at the site. For this reason, requirements for photosensitive materials are becoming stricter, and there is desired a photosensitive material capable of recording with laser exposure of a high intensity and of forming a sharp black image with high resolution and high sharpness. For such digital image recording material, various hard copy systems utilizing pigments or dyes, such as an ink jet system and an electrophotographic system, are available as ordinary image forming systems, but no such system yet is satisfactory in image quality (sharpness, granularity, gradation and color tone) which is a decisive factor determining diagnostic ability in, for example, a medical image, and in recording speed (sensitivity), and has reached a level of replacing conventional silver halide film for medical use, based on wet processing.

On the other hand, a thermal image forming system utilizing an organic silver salt has been disclosed in various references. In such a system, a photothermographic material is heated, after image exposure, to a high temperature (for example 80° C. or higher) to form a black silver image by a redox reaction between a silver halide or a reducible silver salt (functioning as an oxidizing agent) and a reducing agent. The redox reaction is accelerated by a catalytic effect of a latent image formed in silver halide by the exposure. As a result, a black silver image is formed in an exposed area.

The photothermographic material, incorporating all of the chemical substances required for image development within the photosensitive material, is inherently associated with drawbacks of “fog”, a phenomenon in which an unexposed area becomes black even if the material is used immediately after manufacture, and of “fog-increase” in unprocessed stock storability, a phenomenon in which an unexposed area becomes black due to storage of the photosensitive material from the manufacture thereof until use. These drawbacks become conspicuous particularly in a photosensitive material based on a highly active redox reaction system designed so that the thermal development can proceed at a practical temperature and within a practical amount of time.

For improving such fog and unprocessed stock storability, it has been proposed to use an organic polyhalogen compound (for example, see Japanese Patent Application Laid-Open (JP-A) No. 9-258367).

However, the organic polyhalogen compound, although being significantly effective for these drawbacks, has been found to also have a drawback of suppressing thermal development, thus resulting in decreases in image density and in sensitivity.

In particular, photothermographic material of the organic solvent coating type exhibits drawbacks such as fog more conspicuously in comparison with that of the aqueous coating type, and has a drawback of being easily influenced by an environment during storage after coating and drying, or by an environment during the development process, and further improvement has been desired.

There are references referring to a humidity in a bag packaging a photosensitive material (for example, see JP-A No. 11-316441), but such references refer principally to an aqueous coating, and do not refer to the aforementioned drawbacks in an organic solvent system.

There are also references relating to an equilibrated water content of a photosensitive material (for example, see JP-A No. 2000-310830), but there is no reference to a water content of the photosensitive material in a packaged state.

### SUMMARY OF THE INVENTION

In consideration of the foregoing, the present invention provides a packaged member of a photothermographic material with good storability of photosensitive material over time, and an image forming method for a photothermographic material.

In a first aspect, the invention provides a packaged member which comprises a photothermographic material and a packaging bag, wherein an interior of the packaging bag into which the photothermographic material is packed has a humidity of 50 % RH or less at 25° C., the photothermographic material includes, on one surface of a substrate, an image forming layer comprising a photosensitive silver halide, a non-photosensitive organic silver salt, a reducing agent and a binder, and at least one of the following conditions (1) to (4) is satisfied.
(1) 50 mass % or more of the binder is a polymer having a glass transition temperature from 70 to 110° C.
(2) 50 mol. % or more of the non-photosensitive organic silver salt is silver behenate.
(3) The reducing agent is a compound represented by the following Formula (B).

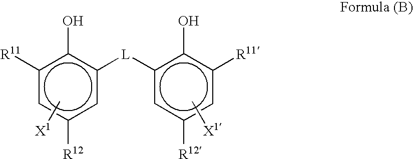

In Formula (B), R¹¹ and R^{11′} each independently represent a secondary or tertiary alkyl group having 3 to 15 carbon atoms; R¹² and R^{12′} each independently represent a hydrogen atom or a substituent on a benzene ring; L represents an —S— group or a CHR¹³— group; R¹³ represents a hydrogen atom or an alkyl group having 1 to 20 carbon atoms; and X¹ and X^{1′} each independently represent a hydrogen atom or a substituent on a benzene ring.
(4) The photothermographic material includes a development accelerator.

In a second aspect, the invention provides an image forming method which comprises exposing the photothermographic material and thermally developing the photothermographic material within a developing time from 1 to 60 seconds.

As a result of intensive investigations on fog immediately after manufacture and fog-increase during a storage after manufacture, the present inventors have found that water contained in a photothermographic material is an extremely important factor. By preparing and developing samples of different water contents, it is found effective for suppressing fog to maintain a humidity of 50 % RH or less at 25° C. in a bag which packages a photothermographic material, and the invention of the foregoing first aspect is thus achieved. It is also found important, against fog immediately after manufacture, to regulate a water content of the photosensitive material at 3 mass % or less at 25° C. It is further found important, for obtaining a photosensitive material of satisfactory storability with a low fog generation, to sufficiently lower the water content before packaging the photosensitive material in a bag.

The photosensitive material is designed at a relatively low sensitivity in order to suppress fog. However, in the aforementioned photosensitive material, it is rendered possible to reduce an amount of addition of an organic polyhalogen compound which reduces sensitivity, and also to employ a reducing agent of a high activity. As a result, it is made possible to significantly reduce a thermal development time.

### DETAILED DESCRIPTION OF THE INVENTION

The present invention provides a packaged member which comprises a photothermographic material and a packaging bag, wherein an interior of the packaging bag into which the photothermographic material is packed has a humidity of 50% RH or less at 25° C., the photothermographic material includes, on one surface of a substrate, an image forming layer comprising a photosensitive silver halide, a non-photosensitive organic silver salt, a reducing agent and a binder, and at least one of the following conditions (1) to (4) is satisfied, and no other limitations are necessarily applicable.
(1) 50 mass % or more of the binder is a polymer having a glass transition temperature from 70 to 110° C.
(2) 50 mol. % or more of the non-photosensitive organic silver salt is silver behenate.
(3) The reducing agent is a compound represented by Formula (B).
(4) the photothermographic material includes a development accelerator.

In the following each component of the configuration will be explained.

1. Packaged Member

An explanation on a packaged member of the invention will be given in the following.

In the packaged member of the invention, it is required that an interior of the packaging bag into which the photothermographic material is packed has a humidity of 50% RH or less at 25° C. The humidity in the bag can be determined by forming a small hole in a part of a bag packaging a photosensitive material, sealing the hole after promptly inserting a detector therein, and measuring a relative humidity after storing for 3 hours or longer in an environment of 25° C.

The humidity in the bag is to be 50% RH or less as explained above, preferably 10 to 50% RH and more preferably 10 to 40% RH. The water content in the bag exceeding 50% RH is undesirable because fog generation and deterioration of unprocessed stock storability show evident deterioration.

In the invention, the humidity in the bag can be regulated in the following manners.

The humidity in the bag can be regulated at 50% RH or less for example by preparing a coating liquid for the photosensitive material with a solvent having a low solubility for water, using a dehydrating agent on the coating liquid, subjecting the photosensitive material, after drying, to a humidity adjustment in a thermostat chamber of a low humidity (60% RH or less at 25° C.), or heating the photosensitive material, after drying, in such a manner that a film surface becomes 70 to 90° C. Among them, the humidity in the bag is preferably regulated by effecting the dehydrating agent to the coating liquid.

When a dehydrating agent is effected to the coating liquid, it is preferable to add a dehydrating agent, that is insoluble to a solvent of the coating liquid, to the solvent, or to filtrate the solvent with layers containing a dehydrating agent packed therein.

Examples of chemical compositions as the dehydrating agent to dehydrate organic solvents include diphosphorus pentaoxide, potassium hydroxide, concentrated sulfuric acid, dehydrated calcium sulfate, magnesium sulfate, sodium sulfate, magnesium oxide, sodium hydroxide, calcium oxide, dehydrated calcium chloride, dehydrated copper sulfate, basic alumina, aluminum chloride, potassium chloride, sodium chloride, silica gel, a molecular sieve, and the like. Among them, a molecular sieve, magnesium sulfate, sodium sulfate, dehydrated calcium sulfate, dehydrated calcium chloride, and alumina are generally frequently used.

Mixtures that contain calcium oxide and inorganic compounds that cause a hydration with calcium oxide can be also used as the dehydrating agent. For example, an inorganic coagulating agent, that contains 90 wt % or more of a mixed powder that contains 5 to 30 wt % of calcium oxide and the rest of the mixed powder consists of silicon oxide, aluminum oxide and sulfonates, is available as the dehydrating agent. Specifically, a mixed powder, that contains 20 to 40 wt % of silicon oxide, 1 to 10 wt % of aluminum oxide, 10 to 30 wt % of calcium oxide, and 1 to 40 wt % of sulfonates, is available as the dehydrating agent.

Immediately after opening the bag and taking out the photothermographic material, the photosensitive material itself preferably has a water content of 3 mass % or less at 25° C. The water content is more preferably 0.01 to 3 mass %, and further preferably 0.01 to 2 mass %. The water content of the photosensitive material itself means a value obtained by dividing a water amount, measured by Karl-Fischer method, with amass of the photosensitive material and multiplying 100. The measuring method is as follows.

A photothermographic material, in a state packaged in a packaging material of characteristics to be explained later, is stored for 7 days or more in a thermostat chamber of 25° C. and 50% RH, then the packaging material is opened and the photosensitive material is taken out. The photosensitive material thus taken out is promptly cut into a size of 5×26 cm, then, after a mass measurement, is cut into small pieces and heated at 120° C., and an evaporated water amount is measured by Karl-Fischer method.

The water content of the photosensitive material itself can be regulated in a similar manner as the aforementioned regulation of the humidity in the bag.

Characteristics of Packaging Material

The packaging material of the invention preferably has no or extremely low permeability to water and oxygen, as in a metal film laminated with a resin.

More specifically, the packaging material of the invention preferably has the following oxygen permeation rate and water permeation rate, when measured by a following method.

The oxygen permeation rate was measured under conditions of a test temperature of 25° C., a test humidity of 0% RH and a gas concentration of 100%.

The water permeation rate was measured under conditions of a test temperature of 25° C. and a relative humidity of 90% RH.

The oxygen permeation rate measured under the foregoing conditions is preferably 10 ml/atm·m²·25° C.·day or less, more preferably 1 ml/atm·m²·25° C.·day or less, and further preferably 0 ml/atm·m²·25° C.·day.

The water permeation rate measured under the foregoing conditions is preferably 5 ml/atm·m²·25° C.·day or less, more preferably 1 ml/atm·m²·25° C.·day or less, and further preferably 0 ml/atm·m²·25° C.·day.

In the foregoing oxygen permeation rate and water permeation rate, 0 ml/atm·m²·25° C.·day means a level below a detection limit of the measuring methods mentioned above.

Specific examples of such packaging material include those described in JP-A Nos. 8-254793 and 2000-206653.

Configuration of Packaged Member

The packaged member of the invention is a photosensitive material cut into sheets, stacked and packaged in the aforementioned packaging bag, or a photosensitive material rolled into a roll and packaged in the aforementioned packaging bag. Therefore the humidity in the packaging bag containing the photosensitive material is originated by the water content of the photosensitive material and/or influenced by an environment at the packaging.

The packaged member is not particularly restricted in configuration as long as it includes a sheet stack or a roll of a photosensitive material and a packaging bag, and may also incorporate for example a carrier member (cardboard) for preventing a scratch on the photosensitive material. However, the humidity in the bag may be affected by an incorporated substance and may have to be regulated to a humidity of 50% RH or less at 25° C.

2. Photothermographic Material

Explanation on Binder

As a binder for an image forming layer of the photosensitive material of the invention, any polymer can be employed, and a preferable binder is transparent or semi-transparent and generally colorless, and can be a natural resin, polymer or copolymer, a synthetic resin, polymer or copolymer, or another film-forming material, such as a gelatin, a rubber, a poly(vinyl alcohol), a hydroxyethyl cellulose, a cellulose acetate, a cellulose acetate butyrate, a poly(vinylpyrrolidone), casein, starch, a poly(acrylic acid), a poly(methylmethacrylic acid), a poly(vinyl chloride), a poly(methacrylic acid), a styrene-maleic anhydride copolymer, a styrene-acrylonitrile copolymer, a styrene-butadiene copolymer, a poly(vinylacetal) (such as poly(vinylformal) or poly(vinylbutyral)), a poly(ester), a poly(urethane), a phenoxy resin, a poly(vinylidene chloride), a poly(epoxide), a poly(carbonate), a poly(vinyl acetate), a poly(olefin), a cellulose ester or a poly(amide).

The binder may be employed in a combination of two or more kinds, if necessary. In such case, two or more polymers having different glass transition temperatures (hereinafter represented as Tg) may be used in a blend.

In the present specification, Tg is calculated by the following equation:
1/Tg=Σ(Xi/Tgi)
in which it is assumed that the polymer is formed by a copolymerization of n monomer components of i=1 to n. Xi represents a weight fraction of an i-th monomer (EXi=1), and Tgi represents a glass transition temperature (absolute temperature) of a homopolymer of the i-th monomer. X indicates a summation from i=1 to n. The glass transition temperature (Tgi) of a homopolymer of each monomer was obtained from “Polymer Handbook (3rd edition)” (J. Brandrup, E. H. Immergut (Wiley-Interscience, 1989)).

In an embodiment of the invention, the humidity in the packaging bag is 50% RH or less at 25° C., and a polymer having a glass transition temperature (Tg) of 70 to 110° C. is used in an amount of 50 mass % or more of the binder contained in the image forming layer of the photothermographic material. Such binder is preferably employed in the case of coating utilizing an organic solvent to be explained in the following. Use of the binder having such Tg suppresses fog generation and also provides satisfactory unprocessed stock storability. The binder has Tg of preferably from 70 to 100° C., more preferably 70 to 90° C. In the case two or more polymers of different Tg's are blended for use, it is preferred that a weight-averaged Tg falls within the aforementioned range.

The binder may be employed in a combination of two or more kinds, if necessary. In such case, two or more polymers having different glass transition temperatures (hereinafter represented as Tg) may be used in a blend.

The binder to be employed in the photothermographic material of the invention has Tg of 70 to 110° C., a number-averaged molecular weight from 1,000 to 1,000,000, preferably 10,000 to 500,000, and a polymerization degree of about 50 to 1000. Examples of such binder include a compound formed by a polymer or a copolymer including, as a constituent unit, an ethylenic unsaturated monomer such as vinyl chloride, vinyl acetate, vinyl alcohol, maleic acid, acrylic acid, an acrylic acid ester, vinylidene chloride, acrylonitrile, methacrylic acid, a methacrylic acid ester, styrene, butadiene, ethylene, vinylbutyral, vinylacetal, or vinyl ether, a polyurethane resin and various rubber type resins. Examples also include phenolic resin, epoxy resin, polyurethane settable resin, urea resin, melamine resin, alkyd resin, formaldehyde resin, silicone resin, epoxy-polyamide resin, and polyester resin. These resins are described in detail in “Plastic Handbook”, published by Asakura Shoten. Such polymer compound is not particularly restricted and may be a single polymer or a copolymer as long as the glass transition temperature (Tg) of a derived polymer is within a range of 70 to 110° C.

Examples of polymer or copolymer including an ethylenic unsaturated monomer as a constituent unit include an acrylic acid alkyl ester, an acrylic acid aryl ester, a methacrylic acid alkyl ester, a methacrylic acid aryl ester, a cyanoacrylic acid alkyl ester and a cyanoacrylic acid aryl ester, and the alkyl group or the aryl group thereof may be substituted or non-substituted, and can be, more specifically, methyl, ethyl, n-propyl, isopropyl, n-butyl isobutyl, sec-butyl, tert-butyl, amyl, hexyl, cyclohexyl, benzyl, chlorobenzyl, octyl, stearyl, sulfopropyl, N-ethyl-phenylaminoethyl, 2-(3-phenylpropyloxy)ethyl, dimethylaminophenoxyethyl, furfuryl, tetrahydrofurfuryl, phenyl, cresyl, naphthyl, 2-hydroxyethyl, 4-hydroxybutyl, triethylene glycol, dipropylene glycol, 2-methoxyethyl, 3-methoxybutyl, 2-acetoxyethyl, 2-acetacetoxyethyl, 2-ethoxyethyl, 2-iso-propoxyethyl, 2-butoxyethyl, 2-(2-methoxyethoxy)ethyl, 2-(2-ethoxyethoxy)ethyl, 2-(2-butoxyethoxy)ethyl, 2-diphenylphosphorylethyl, ω-methoxypolyethylene glycol (number of molar addition n=6), allyl, and dimethylaminoethylmethyl chloride salt. Besides, there can be employed the following monomers:
a vinyl ester such as vinyl acetate, vinyl propionate, vinyl butyrate, vinyl isobutyrate, vinyl caproate, vinyl chloroacetate, vinyl methoxyacetate, vinyl phenylacetate, vinyl benzoate, or vinyl salicylate; an N-substituted acrylamide, an N-substituted methacrylamide, acrylamide or methacrylamide, in which an N-substituent is methyl, ethyl, propyl, butyl, tert-butyl, cyclohexyl, benzyl, hydroxymethyl, methoxyethyl, dimethylaminoethyl, phenyl, dimethyl, diethyl, β-cyanoethyl, N-(2-acetacetoxyethyl), diacetone, etc.; an olefin such as dicyclopentadiene, ethylene, propylene, 1-butene, 1-pentene, vinyl chloride, vinylidene chloride, isoprene, chloroprene, butadiene, or 2,3-dimethylbutadiene; a styrene such as methylstyrene, dimethylstyrene, trimethylstyrene, ethylstyrene, isopropylstyrene, tert-butylstyrene, chloromethylstyrene, methoxystyrene, acetoxystyrene, chlorostyrene, dichlorostyrene, bromostyrene, or methyl vinylbenzoate; a vinyl ether such as methyl vinyl ether, butyl vinyl ether, hexyl vinyl ether, methoxyethyl vinyl ether, or dimethylaminoethyl vinyl ether; an N-substituted maleimide in which an N-substituent is methyl, ethyl, propyl, butyl, tert-butyl, cyclohexyl, benzyl, n-dodecyl, phenyl, 2-methylphenyl, 2,6-diethylphenyl, 2-chlorophenyl, etc., or other compounds such as butyl crotonate, hexyl crotonate, dimethyl itaconate, dibutyl itaconate, diethyl maleate, dimethyl maleate, dibutyl maleate, diethyl fumalate, dimethyl fumalate, dibutyl fumalate, methyl vinyl ketone, phenyl vinyl ketone, methoxyethyl vinyl ketone, glycidyl acrylate, glycidyl methacrylate, N-vinyloxazolidone, N-vinylpyrrolidone, acrylonitrile, methacrylonitrile, methylene malonitrile or vinylidene chloride.

Among these polymer compounds, it is preferable to employ a polymer compound having an acetal group. The polymer compound having an acetal group is preferred because it shows an excellent mutual solubility with a generated organic acid, thereby avoiding film softening.

Also in the invention, the binder is preferably polyvinyl acetal practically having an acetacetal structure, which can for example be polyvinyl acetal disclosed in U.S. Pat. Nos. 2,358,836, 3,003,879 and 2,828,204 and BP No. 771,155.

As the polymer compound having an acetal group of the invention, a compound represented by the following Formula (V) is particularly preferable.

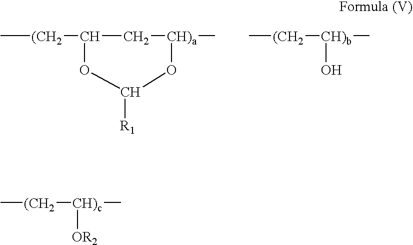

In the formulas, R₁ represents an alkyl group, a substituted alkyl group, an aryl group or a substituted aryl group, preferably an alkyl group or a substituted alkyl group; R₂ represents a non-substituted alkyl group, a substituted alkyl group, a non-substituted aryl group, a substituted aryl group, —COR₃ or —CONHR₃; and R₃ has the same meaning as R₁.

A non-substituted alkyl group represented by R₁, R₂, or R₃ preferably has 1 to 20 carbon atoms, particularly preferably 1 to 6 carbon atoms. Such group may be linear or ramified, and preferably a linear alkyl group. Such non-substituted alkyl group can be, for example, a methyl group, an ethyl group, an n-propyl group, an isopropyl group, an n-butyl group, an isobutyl group, a t-butyl group, an n-amyl group, a t-amyl group, an n-hexyl group, a cyclohexyl group, an n-heptyl group, an n-octyl group, a t-octyl group, a 2-ethylhexyl group, an n-nonyl group, an n-decyl group, an n-dodecyl group or an n-octadecyl group, but is particularly preferably a methyl group or a propyl group.

A non-substituted aryl group preferably has 6 to 20 carbon atoms, for example a phenyl group or a naphthyl group. A group substitutable on the aforementioned alkyl or aryl group can be an alkyl group (for example a methyl group, an n-propyl group, a t-amyl group, a t-octyl group, an n-nonyl group or a dodecyl group), an aryl group (for example a phenyl group), a nitro group, a hydroxyl group, a cyano group, a sulfo group, an alkoxy group (for example a methoxy group), an aryloxy group (for example a phenoxy group), an acyloxy group (for example an acetoxy group), an acylamino group (for example an acetylamino group), a sulfonamide group (for example a methanesulfonamide group), a sulfamoyl group (for example a methylsulfamoyl group), a halogen atom (for example a fluorine atom, a chlorine atom or a bromine atom), a carboxy group, a carbamoyl group (for example a methylcarbamoyl group), an alkoxycarbonyl group (for example a methoxycarbonyl group), or a sulfonyl group (for example a methylsulfonyl group). In the case there are two or more substituents, they may be the same or different. As to the total number of carbon atoms, the substituted alkyl group preferably has 1 to 20 carbon atoms in total and the substituted aryl group preferably has 6 to 20 carbon atoms.

R₂ is preferably —COR₃ (R₃ being preferably an alkyl group or an aryl group), or —CONHR₃ (R₃ being preferably an aryl group) a, b and c are masses of respective repeating units in mol. %, and represents numbers satisfying a+b+c=100 mol. %, wherein a is within a range of 40 to 86 mol. %, b is within a range of 0 to 30 mol. % and c is within a range of 0 to 60 mol. %, particularly preferably a is within a range of 50 to 86 mol. %, b is within a range of 5 to 25 mol. % and c is within a range of 0 to 40 mol. %. Each repeating unit a, b or c of such composition ratio may be constituted of a same component or different components.

Polyurethane resin employable in the invention may have a known structure such as polyester-polyurethane, polyether-polyurethane, polyether-polyester-polyurethane, polycarbonate-polyurethane, polyester-polycarbonate-polyurethane, or polycaprolactone-polyurethane. In all the polyurethanes mentioned above, it is preferable to use one in which at least a polar group selected from —COOM, —SO₃M, —OSO₃M, —P═O(OM)₂, —O—P═O(OM)₂ (M representing a hydrogen atom or an alkali metal salt group), —NR₂, —N⁺R₂ (R₂ representing a hydrocarbon group), an epoxy group, —SH, —CN, etc. is introduced, according to necessity, by copolymerization or by an addition reaction. An amount of such polar group is 10⁻¹ to 10⁻⁸ mol/g, preferably 10⁻² to 10⁻⁶ mol/g. It is preferable, in addition to such polar group, to have at least one OH group at each end of the polyurethane molecule, namely two or more OH groups in total. Preferably the OH group, forming a three-dimensional network structure by crosslinking with polyisocyanate constituting a hardening agent, is present in a larger number in the molecule. In particular, the OH group is preferably present at an end of the molecule because of a higher reactivity with the hardening agent. The polyurethane preferably has three or more OH groups at the ends of the molecule, particularly preferably four or more. In the invention, in the case of employing polyurethane, there are preferred a glass transition temperature of 70 to 110° C., a breaking elongation of 100 to 200% and a breaking stress of 0.5 to 100 N/mm².

The polymer compound represented by Formula (V) of the invention can be synthesized by an ordinary synthesizing method, described for example in “Vinyl Acetate Resin” edited by Ichiro Sakurada (Kobunshi Kagaku Kankokai, 1962). In the following a representative example of a synthesizing method will be shown, but the invention is not limited to such representative example of synthesis.

### Synthesis Example 1

### Synthesis of P-1

20 g of polyvinyl alcohol (trade name: Gesenol GH18, manufactured by Nippon Gosei Co.) and 180 g of purified water were charged, then polyvinyl alcohol was dispersed in purified water so as to obtain a 10 mass % solution, and polyvinyl alcohol was dissolved by elevating temperature to 95° C. Then it was cooled to 75° C. to prepare an aqueous polyvinyl alcohol solution, to which 1.6 g of hydrochloric acid of 10 mass % as an acid catalyst were added to obtain a dropping solution A. Then, a mixture of butyl aldehyde and acetaldehyde of a molar ratio 4:6 was measured by an amount of 11.5 g to prepare a dropping solution B. In a four-necked 1000-ml flask equipped with a cooling tube and an agitator, 100 ml of purified water was charged and heated to 85° C. under a strong agitation. The dropping solution A and the dropping solution B were simultaneously dropped thereto, utilizing dropping funnels maintained at 75° C., over 2 hours and under agitation. The reaction was conducted while paying attention to the agitating speed, so as to avoid fusion of precipitating particles. After the end of the dropping, 7 g of hydrochloric acid of 10 mass % were added as an acid catalyst, and then agitation was conducted for 2 hours at 85° C. to achieve a sufficient reaction. Then the mixture was cooled to 40° C., neutralized with sodium bicarbonate, washed with water five times and filtered to separate polymer, which was taken out and dried to obtain P-1. The obtained P-1, showed Tg of 85° C. in a Tg measurement with a DSC.

Other polymer compounds shown in Table 1 were also similarly synthesized. These polymer compounds may be employed singly or in a blend of two or more kinds. In the invention, the layer containing the photosensitive silver salt (image forming layer) preferably employs a polymer represented by Formula (V) as a main binder. The main binder used herein means “a state where the aforementioned polymer constitutes 50 mass % or more of all the binders in the layer containing the photosensitive silver salt”. Therefore, another polymer may be blended within a range of less than 50 mass % of all the binders. Such polymer is not particularly restricted as long as it is soluble in a solvent capable of dissolving the polymer of the invention. More preferably it can be polyvinyl acetate, a polyacrylic resin or an urethane resin.

In the following, polymer compounds of the invention and comparative compounds are shown. In the table, Tg was measured with a differential scanning calorimeter (DSC) manufactured by Seiko Denshi Kogyo Co.

TABLE 1

| | | | | | c | |
|---|---|---|---|---|---|---|
| | a | | | b | acetyl | |
| Polymer | acetacetal | butyral | acetal | hydroxyl | (mol. | Tg |
| name | (mol. %) | (mol. %) | (mol. %) | (mol. %) | %) | (° C.) |
| P-1 | 6 | 4 | 73.7 | 24.6 | 1.7 | 85 |
| P-2 | 3 | 7 | 75 | 23.4 | 1.6 | 75 |
| P-3 | 10 | 0 | 73.6 | 24.5 | 1.9 | 110 |
| P-5 | 7 | 3 | 71.1 | 27.3 | 1.6 | 88 |
| P-6 | 10 | 0 | 73.3 | 24.8 | 1.9 | 104 |
| P-7 | 10 | 0 | 73.5 | 24.6 | 1.9 | 104 |
| P-8 | 3 | 7 | 74.4 | 24 | 1.6 | 75 |
| P-9 | 3 | 7 | 75.4 | 23 | 1.6 | 74 |
| Comp-1 | — | — | — | — | — | 65 |
| Comp-2 | — | — | — | 53 | 2 | 131 |

Comparative compound-2

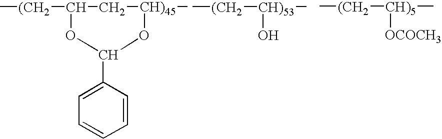

The comparative compound-1 is B-79 (trade name: Butuvar manufactured by Monsant Co.).

Coating Solvent

Examples of a coating solvent are described for example in “Shimpan Yozai Pocketbook” (Ohm Sha, 1994), but the present invention is not limited to such examples. The solvent to be employed in the invention preferably has a boiling point from 40 to 180° C. The solvent can be an organic solvent or water, but is preferably an organic solvent. Specific examples of the organic solvent include hexane, cyclohexane, toluene, methanol, ethanol, isopropanol, acetone, methyl ethyl ketone, ethyl acetate, 1,1,1-trichloroethane, tetrahydrofuran, triethylamine, thiophene, trifluoroethanol, perfluoropentane, xylene, n-butanol, phenol, methyl isobutyl ketone, cyclohexanone, butyl acetate, diethyl carbonate, chlorobenzene, dibutyl ether, anisole, ethylene glycol diethyl ether, N,N-dimethylformamide, morpholine, propanesultone, and perfluorotributylamine. Among these, methyl ethyl ketone is employed advantageously as it has an appropriate boiling point, provides a uniform surface on a coated film, shows a low load for drying, and can reduce a remaining amount of the solvent.

The solvent employed for coating preferably remains in the film as little as possible after coating and drying. The remaining solvent generally evaporates into the environment at the exposure or the thermal development of the photothermographic material, thus causing an unpleasant feeling and being undesirable for health.

In the invention, an amount of the remaining solvent, in the case the solvent is MEK, is preferably from 0.1 to 150 mg/m², more preferably from 0.1 to 80 mg/m², and further preferably from 0.1 to 40 mg/m².

Reducing Agent

The photothermographic material of the invention preferably includes a thermal development agent which is a reducing agent for the organic silver salt. The reducing agent for the organic silver salt can be an arbitrary substance (preferably organic substance) capable of reducing a silver ion into metallic silver. Examples of such reducing agent are described in JP-A No. 11-65021, paragraphs 0043-0045 and EP-A No. 0803764A1, page 7, line 34 to page 18, line 12.

A reducing agent employed in the invention is preferably so-called hindered phenol reducing agent or a bisphenol reducing agent having a substituent in an ortho-position of a phenolic hydroxyl group, and more preferably a compound represented by the following Formula (R).

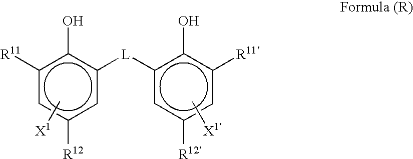

In Formula (R), R¹¹ and R^{11′} each independently represent an alkyl group having 1 to 20 carbon atoms; R¹² and R^{12′} each independently represent a hydrogen atom or a substituent on a benzene ring; L represents —S— or —CHR¹³—; R¹³ represents a hydrogen atom or an alkyl group having 1 to 20 carbon atoms; and X¹ and X^{1′} each independently represent a hydrogen atom or a substituent on a benzene ring.

A detailed explanation on Formula (R) will be given in the following.

In the following, an alkyl group also includes a cycloalkyl group unless otherwise specified.

1) R¹¹ and R^{11′}

R¹¹ and R^{11′} each independently represent a substituted or non-substituted alkyl group having 1 to 20 carbon atoms. A substituent on the alkyl group is not particularly limited, but is preferably an aryl group, a hydroxyl group, an alkoxy group, an aryloxy group, an alkylthio group, an arylthio group, an acylamino group, a sulfonamide group, a sulfonyl group, a phosphoryl group, an acyl group, a carbamoyl group, an ester group, an ureido group, an urethane group or a halogen atom.

2) R¹² and R^{12′}, X¹ and X^{1′}

R¹² and R^{12′} each independently represent a hydrogen atom or a substituent on a benzene ring, and X¹ and X^{1′} each independently represent a hydrogen atom or a substituent on a benzene ring. Each group substitutable on a benzene ring can preferably be an alkyl group, an aryl group, a halogen atom, an alkoxy group or an acylamino group.

3) L

L represents a —S— group or a —CHR¹³— group. R¹³ represents a hydrogen atom or an alkyl group having 1 to 20 carbon atoms, and the alkyl group may have a substituent. Specific examples of the non-substituted alkyl group for R¹³ include a methyl group, an ethyl group, a propyl group, a butyl group, a heptyl group, an undecyl group, an isopropyl group, a 1-ethylpentyl group, a 2,4,4-trimethylpentyl group, a cyclohexyl group, 2,4-dimethyl-3-cyclohexenyl group, and 3,5-dimethyl-3-cyclohexenyl group. Examples of the substituent of the alkyl group are similar to the substituents of R¹¹, and include a halogen atom, an alkoxy group, an alkylthio group, an aryloxy group, an arylthio group, an acylamino group, a sulfonamide group, a sulfonyl group, a phosphoryl group, an oxycarbonyl group, a carbamoyl group and a sulfamoyl group.

4) Preferred Substituent

Each of R¹¹ and R^{11′} is preferably a primary, secondary or tertiary alkyl group having 1 to 15 carbon atoms, and can specifically be a methyl group, an isopropyl group, a t-butyl group, a t-amyl group, a t-octyl group, a cyclohexyl group, a cyclopentyl group, a 1-methylcyclohexyl group or a 1-methylcyclopropyl group. Each of R¹¹ and R^{11′} is more preferably a secondary or tertiary alkyl group having 3 to 15 carbon atoms, among which more preferred is a t-butyl group, a t-amyl group or a 1-methylcyclohexyl group, and most preferred is a t-butyl group.

Each of R¹² and R^{12′} is preferably an alkyl group having 1 to 20 carbon atoms, and can specifically be a methyl group, an ethyl group, a propyl group, a butyl group, an isopropyl group, a t-butyl group, a t-amyl group, a cyclohexyl group, a 1-methylcyclohexyl group, a benzyl group, a methoxymethyl group, or a methoxyethyl group. More preferably it can be a methyl group, an ethyl group, a propyl group, an isopropyl group or a t-butyl group, and particularly preferably a methyl group or an ethyl group. Each of X¹ and X^{1′} is preferably a hydrogen atom, a halogen atom, or an alkyl group, more preferably a hydrogen atom.

L is preferably a —CHR¹³— group.

R¹³ preferably represents a hydrogen atom or an alkyl group having 1 to 15 carbon atoms, and in addition to a chain-shaped alkyl group a cyclic alkyl group can also be employed advantageously as the alkyl group. Such alkyl group including a c=c bond can also be employed advantageously. Examples of the alkyl group include a methyl group, an ethyl group, a propyl group, an isopropyl group, a 2,4,4-trimethylpentyl group, a cyclohexyl group, a 2,4-dimethyl-3-cyclohexenyl group, and 3,5-dimethyl-3-cyclohexenyl group. As R¹³, there is particularly preferred a hydrogen atom, a methyl group, an ethyl group, a propyl group, an isopropyl group, or 2,4-dimethyl-3-cyclohexenyl group.

In the case R¹¹ and R^{11′} are tertiary alkyl groups and R¹² and R^{12′} are methyl groups, R¹³ is preferably a primary or secondary alkyl group having 1 to 8 carbon atoms (such as a methyl group, an ethyl group, a propyl group, an isopropyl group, or 2,4-dimethyl-3-cyclohexenyl group).

In the case R¹¹ and R^{11′} are tertiary alkyl groups and R¹² and R^{12′} are alkyl groups other than methyl groups, R¹³ is preferably a hydrogen atom.

In the case R¹¹ and R^{11′} are not tertiary alkyl groups, R¹³ is preferably a hydrogen atom or a secondary alkyl group, particularly preferably a secondary alkyl group. The secondary alkyl group for R¹³ is preferably an isopropyl group or a 2,4-dimethyl-3-cyclohexenyl group.

The aforementioned reducing agent behaves differently in thermal development property and in the color of developed silver by a combination of R¹¹, R^{11′}, R¹², R^{12′} and R¹³. These properties can be regulated by employing two or more reducing agents, and it is preferable to employ two or more kinds in combination according to the purpose.

In an embodiment of the invention, the humidity in the packaging bag is 50% RH or less at 25° C., and a compound represented by the following Formula (B) is used. Therefore, among the aforementioned formula (R), it is preferred to employ a following Formula (B).

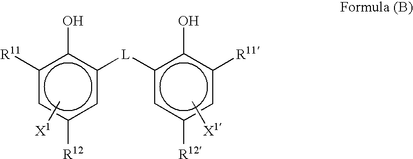

In the formula, R¹¹ and R^{11′} each independently represent a secondary or tertiary alkyl group having 3 to 15 carbon atoms; R¹² and R^{12′} each independently represent a hydrogen atom or a substituent on a benzene ring; L represents —S— or —CHR¹³—; R¹³ represents a hydrogen atom or an alkyl group having 1 to 20 carbon atoms; and X¹ and X^{1′} each independently represent a hydrogen atom or a substituent on a benzene ring.

R¹², R^{12′}, L, X¹ and X^{1′} are respectively similar to those explained in the Formula (R).

In the following, specific examples of the reducing agent of the invention, including the compounds represented by Formula (R) and those represented by the Formula (B), but the present invention is not limited to such examples.

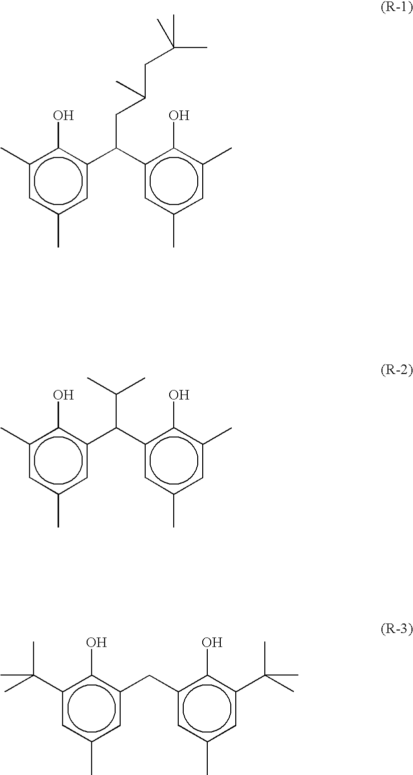

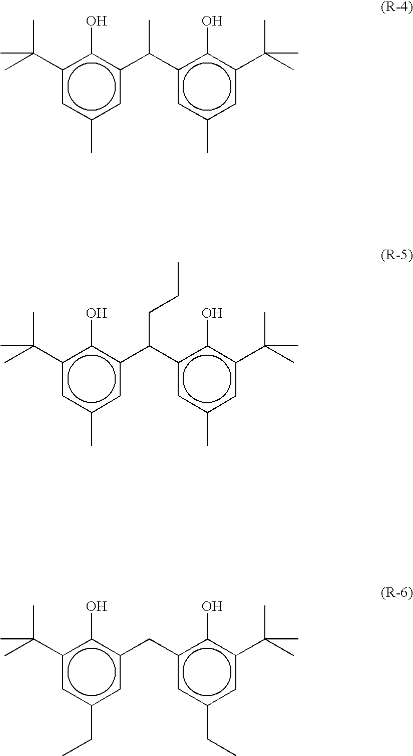

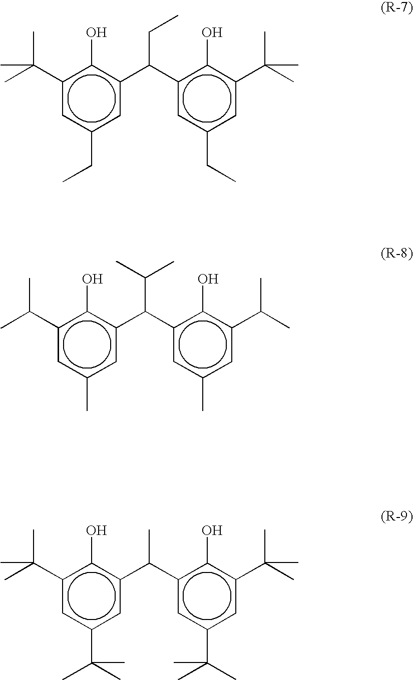

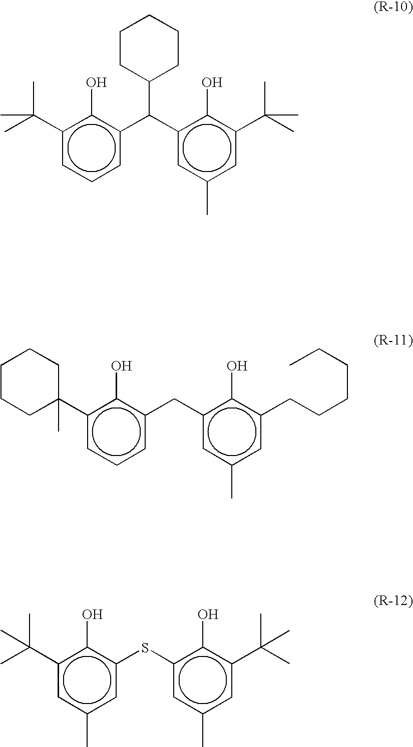

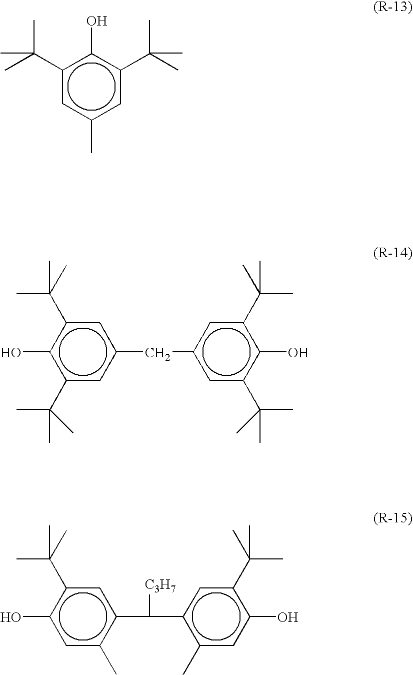

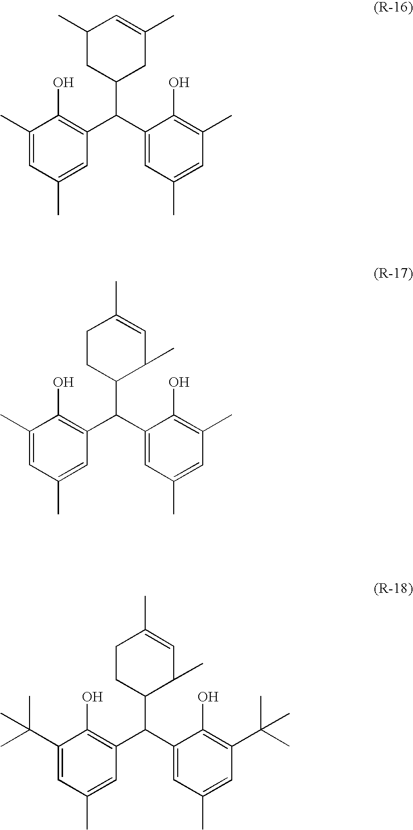

Other preferred examples of the reducing agent of the invention are described in JP-A Nos. 2001-188314, 2001-209145, 2001-350235 and 2002-156727, and EP 1278101A2.

In the invention, the reducing agent is preferably added in an amount of 0.1 to 3.0 g/m², more preferably 0.2 to 2.0 g/m², further preferably 0.3 to 1.0 g/m². It is preferably included in an amount of 5 to 50 mol. % per 1 mole of silver on the surface having the image forming layer, more preferably 8 to 30 mol. %, and further preferably 10 to 20 mol. %. The reducing agent is preferably included in the image forming layer.

The reducing agent of the invention may be contained in the coating liquid and in the photosensitive material by any method, for example in a state of a solution, an emulsified dispersion or a dispersion of fine solid particles.

In the case the coating solvent is an organic solvent, a method in a solution, by dissolving the reducing agent in the aforementioned coating solvent, is preferred. In the case the coating solvent is aqueous, a method of dispersing solid particles of the reducing agent is employed.

Development Accelerator

In the photothermographic material of the invention, a development accelerator is preferably added. A preferable development accelerator in the case of addition is a sulfonamidephenol compound represented by the general formula (A) in JP-A Nos. 2000-267222 and 2000-330234, a hindered phenol compound represented by the general formula (II) in JP-A No. 2001-92075, a hydrazine compound represented by the general formula (I) in JP-A Nos. 10-62895 and 11-15116, by the general formula (D) in JP-A No. 2002-156727 and by the general formula (1) in JP-A No. 2002-278017, or a phenol or naphthol compound represented by the general formula (2) in JP-A No. 2001-264929. A phenol compound described in JP-A Nos. 2002-311533 and 2002-341484 is also preferred. In particular, a naphthol compound described in JP-A No. 2003-66558 is preferred. Such development accelerator is used within a range of 0.1 to 20 mol. % with respect to the reducing agent, preferably 0.5 to 10 mol. % and more preferably 1 to 5 mol. %. It can be introduced into the photosensitive material by a method similar to that for the reducing agent, and it is particularly preferably added as a solid dispersion or an emulsified dispersion in the case of an aqueous coating liquid. In the case of addition as an emulsified dispersion, the addition is preferably made as an emulsified dispersion prepared with a high-boiling solvent which is solid at the normal temperature and a low-boiling auxiliary solvent, or as so-called oilless emulsified dispersion without utilizing the high-boiling solvent.

In the invention, among the aforementioned development accelerator, more preferred are a hydrazine compound described in JP-A Nos. 2002-156727 and 2002-278017, and a naphthol compound described in JP-A No. 2003-66558.

In the invention, a particularly preferred development accelerator is compounds represented by following formulas (A-1) and (A-2).
Q₁-NHNH-Q₂ Formula (A-1)

In the formula, Q, represents an aromatic group or a heterocyclic group bonded at a carbon atom to —NHNH-Q₂; and Q₂ represents a carbamoyl group, an acyl group, an alkoxycarbonyl group, an aryloxycarbonyl group, a sulfonyl group or a sulfamoyl group.

In Formula (A-1), the aromatic group or the heterocyclic group represented by Q₁ is preferably a 5- to 7-membered unsaturated ring. Preferred examples include a benzene ring, a pyridine ring, a pyradine ring, a pyrimidine ring, a pyridazine ring, a 1,2,4-triazine ring, a 1,3,5-triazine ring, a pyrrole ring, an imidazole ring, a pyrazole ring, a 1,2,3-triazole ring, a 1,2,4-triazole ring, a tetrazole ring, a 1,3,4-thiadiazole ring, a 1,2,4-thiadiazole ring, a 1,2,5-thiadiazole ring, a 1,3,4-oxadiazole ring, a 1,2,4-oxadiazole ring, a 1,2,5-oxadiazole ring, a thiazole ring, an oxazole ring, an isothiazole ring, an isooxazole ring and a thiophene ring, and there is also preferred a condensed ring formed by mutual condensation of these rings.

These rings may have a substituent, and, in the case two or more substituents are present, such substituents may be mutually the same or different. Examples of the substituent include a halogen atom, an alkyl group, an aryl group, a carbonamide group, an alkylsulfonamide group, an arylsulfonamide group, an alkoxy group, an aryloxy group, an alkylthio group, an arylthio group, a carbamoyl group, a sulfamoyl group, a cyano group, an alkylsulfonyl group, an arylsulfonyl group, an alkoxycarbonyl group, an aryloxycarbonyl group and an acyl group. In the case such substituent is a substitutable group, it may further have a substituent, and examples of preferred substituent include a halogen atom, an alkyl group, an aryl group, a carbonamide group, an alkylsulfonamide group, an arylsulfonamide group, an alkoxy group, an aryloxy group, an alkylthio group, an arylthio group, an acyl group, an alkoxycarbonyl group, an aryloxycarbonyl group, a carbamoyl group, a cyano group, a sulfamoyl group, an alkylsulfonyl group, an arylsulfonyl group and an acyloxy group.

A carbamoyl group represented by Q₂ preferably has 1 to 50 carbon atoms, more preferably 6 to 40 carbon atoms, and can be, for example, non-substituted carbamoyl, methylcarbamoyl, N-ethylcarbamoyl, N-propylcarbamoyl, N-sec-butylcarbamoyl, N-octylcarbamoyl, N-cyclohexylcarbamoyl, N-tert-butylcarbamoyl, N-dodecylcarbamoyl, N-(3-dodecyloxypropyl)carbamoyl, N-octadecylcarbamoyl, N-{3-(2,4-tert-pentylphenoxy)propyl}carbamoyl, N-(2-hexyldecyl)carbamoyl, N-phenylcarbamoyl, N-(4-dodecyloxyphenyl)carbamoyl, N-(2-chloro-5-dodecyloxylcarbonylphenyl)carbamoyl, N-naphthylcarbamoyl, N-3-pyridylcarbamoyl, or N-benzylcarbamoyl.

An acyl group represented by Q₂ preferably has 1 to 50 carbon atoms, more preferably 6 to 40 carbon atoms, and can be, for example, formyl, acetyl, 2-methylpropanoyl, cyclohexylcarbonyl, octanoyl, 2-hexyldecanoyl, dodecanoyl, chloroacetyl, trifluoroacetyl, benzoyl, 4-dodecyloxybenzoyl, or 2-hydroxymethylbenzoyl. An alkoxycarbonyl group represented by Q₂ preferably has 2 to 50 carbon atoms, more preferably 6 to 40 carbon atoms, and can be, for example, methoxycarbonyl, ethoxycarbonyl, isobutyloxycarbonyl, cyclohexyloxycarbonyl, dodecyloxycarbonyl or benzyloxycarbonyl.

An aryloxycarbonyl group represented by Q₂ preferably has 7 to 50 carbon atoms, more preferably 7 to 40 carbon atoms, and can be, for example, phenoxycarbonyl, 4-octyloxyphenoxycarbonyl, 2-hydroxymethylphenoxycarbonyl, or 4-dodecyloxyphenoxycarbonyl. A sulfonyl group represented by Q₂ preferably has 1 to 50 carbon atoms, more preferably 6 to 40 carbon atoms, and can be, for example, methylsulfonyl, butylsulfonyl, octylsulfonyl, 2-hexadecylsulfonyl, 3-dodecyloxypropylsulfonyl, 2-octyloxy-5-tert-octylphenylsulfonyl or 4-dodecyloxyphenylsulfonyl.

A sulfamoyl group represented by Q₂ preferably has 0 to 50 carbon atoms, more preferably 6 to 40 carbon atoms, and can be, for example, non-substituted sulfamoyl, N-ethylsulfamoyl, N-(2-ethylhexyl)sulfamoyl, N-decylsulfamoyl, N-hexadecylsulfamoyl, N-[3-(2-ethylhexyloxy)propyl}sulfamoyl, N-(2-chloro-5-dodecyloxycarbonylphenyl)sulfamoyl, or N-(2-tetradecyloxyphenyl)sulfamoyl. A group represented by Q₂ may further have, in a substitutableposition, a group cited before as a substituent group for a 5- to 7-membered unsaturated ring represented by Q₁, and, in the case two or more substituents are present, they may be mutually the same or different.

In the following there will be explained a preferred range of the compound represented by Formula (A-1). For Q₁, there is preferred a 5- or 6-membered unsaturated ring, and more preferred is a benzene ring, a pyrimidine ring, a 1,2,3-triazole ring, a 1,2,4-triazole ring, a tetrazole ring, a 1,3,4-thiadiazole ring, a 1,2,4-thiadiazole ring, a 1,3,4-oxadiazole ring, a 1,2,4-oxadiazole ring, a thiazole ring, an oxazole ring, an isothiazole ring, an isooxazole ring or a ring formed by a condensation of the foregoing ring with a benzene ring or an unsaturated hetero ring. Also for Q₂, there is preferred a carbamoyl group, more preferably a carbamoyl group having a hydrogen atom on a nitrogen atom.

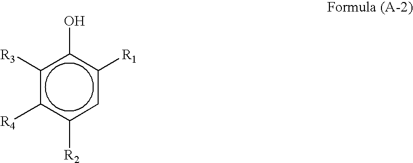

In Formula (A-2), R₁ represents an alkyl group, an acyl group, an acylamino group, a sulfonamide group, an alkoxycarbonyl group, or a carbamoyl group. R₂ represents a hydrogen atom, a halogen atom, an alkyl group, an alkoxy group, an aryloxy group, an alkylthio group, an arylthio group, an acyloxy group or a carbonate ester group. R₃ and R₄ each independently represent a group substitutable on the benzene ring, as cited in the examples of the substituent for Formula (A-1). R₃ and R₄ may be mutually bonded to form a condensed ring.

R₁ is preferably an alkyl group having 1 to 20 carbon atoms (such as a methyl group, an ethyl group, an isopropyl group, a butyl group, a tert-octyl group, or a cyclohexyl group), an acylamino group (such as an acetylamino group, a benzoylamino group, a methylureide group or a 4-cyanophenylureide group), or a carbamoyl group (such as an n-butylcarbamoyl group, an N,N-diethylcarbamoyl group, a phenylcarbamoyl group, 2-chlorophenylcarbamoyl group, or a 2,4-dichlorophenylcarbonyl group), and more preferably an acylamino group (including an ureide group and an urethane group). R₂ is preferably a halogen atom (more preferably a chlorine atom or a bromine atom), an alkoxy group (such as a methoxy group, a butoxy group, an n-hexyloxy group, an n-decyloxy group, a cyclohexyloxy group, or a benzyloxy group), or an aryloxy group (such as a phenoxy group or a naphthoxy group).

R₃ is preferably a hydrogen atom, a halogen atom or an alkyl group having 1 to 20 carbon atoms, and a halogen atom is most preferred. R₄ is preferably a hydrogen atom, an alkyl group, or an acylamino group, and an alkyl group or an acylamino group is more preferred. Preferred examples of such substituent are similar to those for R₁. In the case R₄ is an acylamino group, it is also preferred that R₄ is bonded with R₃ to form a carbostyryl ring.

In Formula (A-2), in the case R₃ and R₄ are mutually bonded to form a condensed ring, a naphthalene ring is particularly preferred as such condensed ring. The naphthalene ring may have a substituent of which examples are the same as those of the substituent for Formula (A-1). In the case Formula (A-2) represents a naphthol compound, R₁ is preferably a carbamoyl group, and particularly a benzoyl group. R₂ is preferably an alkoxy group or an aryloxy group, particularly an alkoxy group.

In the following specific preferred examples of the development accelerator of the invention are shown, but the invention is not limited to such examples. 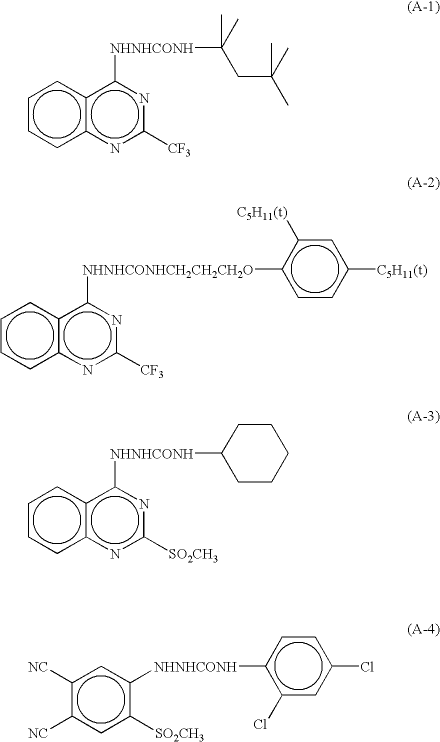 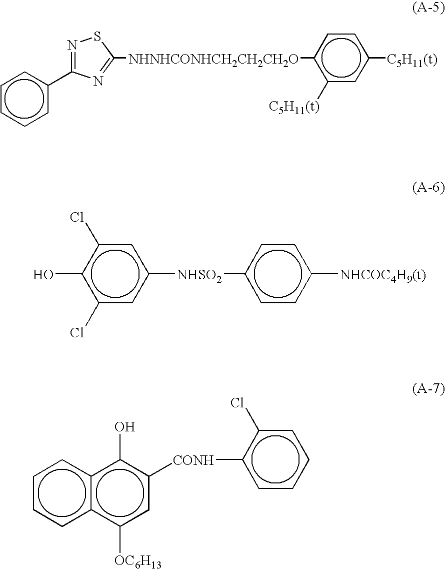 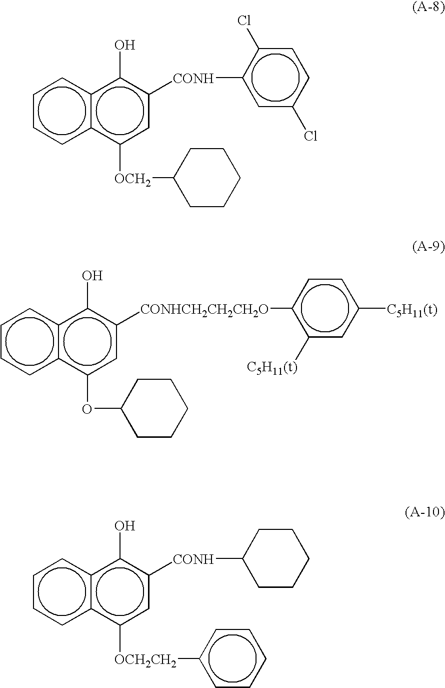 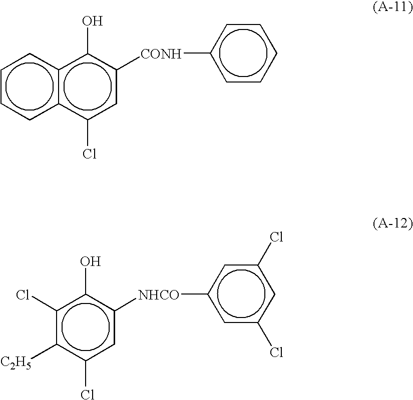
Photosensitive Silver Halide
1) Halogen Composition

A photosensitive silver halide to be employed in the present invention is not particularly restricted in the halogen composition, and can be silver chloride, silver chlorobromide, silver bromide, silver iodobromide, silver iodochlorobromide or silver iodide. Among these, silver bromide, silver iodobromide and silver iodide are preferred. A halogen composition within a grain may be uniform, or show a stepwise change or a continuous change. Also a silver halide grain having a core/shell structure may be preferably employed. There is preferred a core/shell grain with a 2- to 5-layered structure, more preferably 2- to 4-layered structure. It is also possible to advantageously employ a technology of localizing silver bromide or silver iodide on a surface of grains of silver chloride, silver bromide or silver chlorobromide.

2) Grain Forming Method

A method for forming photosensitive silver halide grains is well known in the related art, and there can be utilized, for example, methods described in Research Disclosure 17029, June 1978 and U.S. Pat. No. 3,700,458. More specifically, there is employed a method of adding a silver supplying compound and a halogen supplying compound to a solution of gelatin or another polymer thereby preparing a photosensitive silver halide, and thereafter mixing an organic silver salt. There are also preferred a method described in JP-A No. 11-119374, paragraphs 0217 to 0224, and methods described in JP-A Nos. 11-352627 and 2000-347335.

—3) Grain Size

A grain size of the photosensitive silver halide is preferably smaller for a purpose of suppressing turbidity after image formation, and, more specifically it is preferably 0.20 μm or less, more preferably 0.01 to 0.15 μm and further preferably 0.02 to 0.12 μm. The grain size mentioned above means a diameter of a circle, when a projected area of a silver halide grain (a projected area of a principal plane in the case of a flat plate-shaped grain) is converted into a circle of the same area.

4) Grain Shape

Silver halide grains can assume a cubic shape, an octahedral shape, a flat plate shape, a spherical shape, a rod shape, a potato-like shape, etc., but cubic grains are particularly preferable in the invention. There can also be advantageously employed grains of which corners are rounded. The photosensitive silver halide grains are not particularly restricted in a plane index (Miller's index) of an external surface, but it is preferable that a {100} plane, showing a high spectral sensitization efficiency under an adsorption of a spectral sensitizing dye, has a high proportion. Such proportion is preferably 50% or higher, more preferably 65% or higher and further preferably 80% or higher. The Miller's index of the {100} plane can be determined by a method described in T. Tani; J. Imaging Sci., 29, 165 (1985), utilizing adsorption dependences of {111} and {100} planes in the adsorption of sensitizing dye.

5) Heavy Metal

The photosensitive silver halide grains of the invention may include a metal or a metal complex of groups 8 to 10 of the periodic table (having groups 1 to 18). A metal or a central metal of a metal complex belonging to the groups 8 to 10 of the periodic table is preferably rhodium, ruthenium or iridium. Such metal complex may be used singly, or in a combination of two or more complexes of a same metal or different metals. A preferred content is within a range of 1×10⁻⁹ to 1×10⁻³ moles per 1 mole of silver. Such heavy metals, complexes thereof and method of addition thereof are described in JP-A Nos. 7-225449, 11-65021, paragraphs 0018 to 0024, and 11-119374, paragraphs 0227 to 0240.

In the invention, there are preferred silver halide grains in which a hexacyano metal complex is present at the outermost surface of the grains. Examples of the hexacyano metal complex include [Fe(CN)₆]⁴⁻, [Fe(CN)₆]³⁻, [Ru(CN)₆]⁴⁻, [Os(CN)₆]⁴⁻, [Co(CN)₆]³⁻, [Rh(CN)₆]³⁻, [Ir(CN)₆]³⁻, [Cr(CN)₆]³⁻, and [Re(CN)₆]³⁻. In the invention, a hexacyano Fe complex is preferred.

A counter cation is not important since the hexacyano metal complex is present in a state of an ion in an aqueous solution, but it is preferable to employ an ion that is easily miscible with water and is adapted to a precipitating operation of silver halide emulsion, for example an alkali metal ion such as sodium ion, potassium ion, rubidium ion, cesium ion or lithium ion, an ammonium ion or an alkylammonium ion (such as tetramethylammonium ion, tetraethylammonium ion, tetrapropylammonium ion or tetra(n-butyl)ammonium ion).

The hexacyano metal complex can be added by mixing with water, or a mixed solvent of water and a suitable water-miscible organic solvent (for example an alcohol, an ether, a glycol, a ketone, an ester or an amide), or gelatin.

An amount of addition of hexacyano metal complex is preferably 1×10⁻⁵ to 1×10⁻² moles per 1 mole of silver, more preferably 1×10⁻⁴ to 1×10⁻³ moles.

In order to cause the hexacyano metal complex to be present on the outermost surface of silver halide grains, the hexacyano metal complex is directly added before the end of a charging step, namely within a period from the end of an addition of an aqueous silver nitrate solution for grain formation to the start of a chemical sensitization step for a chalcogen sensitization such as sulfur sensitization, selenium sensitization or tellurium sensitization, or a precious metal sensitization such as gold sensitization, or during a rinsing step or a dispersing step, or before a chemical sensitization step. In order not to cause a growth of the silver halide fine grains, it is preferable to add the hexacyano metal complex promptly after the grain formation, and to execute the addition before the end of the charging step.

The addition of the hexacyano metal complex is preferably started after 96 mass % of the total silver nitrate for grain formation is added, more preferably after 98 mass % and particularly preferably after 99 mass %.

Such hexacyano metal complex, in the case of addition after the addition of aqueous silver nitrate solution but immediately before the completion of grain formation, can be adsorbed on the outermost surface of silver halide grains, and mostly forms a low-soluble salt with silver ions on the surface of the grains. Such silver salt of hexacyano ferrate (II), being less soluble than AgI, can avoid re-dissolution of small grains, thereby enabling to produce fine silver halide grains of a smaller grain size.

Also metal atoms (for example [Fe(CN)₆]⁴⁻) that can be included in the silver halide grains to be employed in the invention, a desalting method and a chemical sensitizing method of the silver halide emulsion are described in JP-A No. 11-84574, paragraphs 0046-0050, No. 11-65021, paragraphs 0025-0031, and No. 11-119374, paragraphs 0242-0250.

6) Gelatin

Various gelatins can be used as gelatin contained in the photosensitive silver halide emulsion to be employed in the invention. It is necessary to maintain a satisfactory dispersion state of the photosensitive silver halide emulsion in a coating liquid containing an organic silver salt, and it is preferable to use gelatin having a molecular weight of 10,000 to 1,000,000. It is also preferable to execute a phthalation process on a substituent of gelatin. Such gelatin may be used at grain formation or at dispersion after desalting process, however it is preferably used at the grain formation.

7) Sensitizing Dye

For use in the invention, there can be advantageously selected a sensitizing dye that can spectrally sensitize the silver halide grains in a desired wavelength region upon adsorption thereon and has a spectral sensitivity matching the spectral characteristics of an exposure light source. Examples of sensitizing dye and a method of addition thereof are given by JP-A No. 11-65021, paragraphs 0103-0109, a compound represented by Formula (II) in JP-A No. 10-186572, a dye represented by Formula (I) and a description of a paragraph 0106 in JP-A No. 11-119374, a description in U.S. Pat. No. 5,510,236, a dye described in the example 5 of U.S. Pat. No. 3,871,887, dyes disclosed in JP-A Nos. 2-96131 and 59-48753, and descriptions in EP-A No. 0803764A1, page 19, line 38 to page 20, line 35, and JP-A Nos. 2001-272747, 2001-290238 and 2002-23306. These sensitizing dyes may be used singly or in combination of two or more kinds. In the invention, the sensitizing dye is added to the silver halide emulsion preferably in a period from the end of a desalting process to a coating, and more preferably in a period from the end of the desalting process to the end of a chemical ripening process.

An amount of the sensitizing dye to be added in the invention can be selected according to a desired sensitivity or a desired fog level, however it is preferably within a range of 10⁻⁶ to 1 mole per 1 mole of silver halide in the photosensitive layer, preferably 10⁻⁴ to×10⁻¹ moles.

In the invention, in order to improve the spectral sensitizing efficiency, there may be employed a super-sensitizer. Examples of the super-sensitizer employable in the invention include compounds described in EP-A No. 587,338, U.S. Pat. Nos. 3,877,943 and 4,873,184 and JP-A Nos. 5-341432, 11-109547 and 10-111543.

8) Chemical Sensitization

The photosensitive silver halide grains to be employed in the invention are preferably chemically sensitized by a sulfur sensitizing method, a selenium sensitizing method or a tellurium sensitizing method. For the sulfur sensitization, the selenium sensitization and the tellurium sensitization, a known compound can be advantageously employed such as one described in JP-A No. 7-128768. In the invention, the tellurium sensitization is particularly preferable, and a compound described in JP-A No. 11-65021, paragraph 0030 and those represented by the formulas (II), (III) and (IV) in JP-A No. 5-313284 are more preferable.

The photosensitive silver halide grains of the invention are preferably chemically sensitized by a gold sensitization method either in combination with the aforementioned chalcogen sensitization or singly. A gold sensitizer with monovalent or trivalent gold is preferable, and is preferably an ordinarily employed gold sensitizer. Representative examples include chloroauric acid, bromoauric acid, potassium chloroaurate, potassium bromoaurate, auric trichloride, potassium aurithiocyanate, potassium iodoaurate, tetracyanoauric acid, ammonium aurothiocyanate, and pyridyl trichlorogold. In addition, there may also be advantageously employed gold sensitizers described in U.S. Pat. No. 5,858,637 and Japanese Patent Application No. 2001-79450.

In the invention, the chemical sensitization may be executed any time after grain formation and before coating, and can be executed, after desalting, (1) before spectral sensitization, (2) simultaneous with spectral sensitization, (3) after spectral sensitization, or (4) immediately before coating.

An amount of the sulfur, selenium or tellurium sensitizer employed in the invention is variable depending on the silver halide grains to be used and chemical ripening conditions, however it is within a range of 10⁻⁸ to 10⁻² moles per 1 mole of silver halide, preferably 10⁻⁷ to 10⁻³ moles.

An amount of the gold sensitizer to be added is variable depending on various conditions, however it is generally within a range of 10⁻⁷ to 10⁻³ moles per 1 mole of silver halide, preferably 10⁻⁶ to 5×10⁻⁴ moles.

The chemical sensitization in the invention is not particularly restricted in conditions, but there are generally selected a pH of 5 to 8, a pAg value of 6 to 11 and a temperature of 40 to 95° C.

In the silver halide emulsion to be employed in the invention, a thiosulfonic acid compound may be added by a method described in EP-A No. 293,917.

In the photosensitive silver halide grains of the invention, a reducing agent is preferably employed. As a specific compound for the reduction sensitization, ascorbic acid or aminoiminomethane sulfinic acid is preferable, and there may also be advantageously employed stannous chloride, a hydrazine derivative, a borane compound, a silane compound, or a polyamine compound. The reduction sensitizer may be added in any step in the photosensitive emulsion preparing process from a grain growing step to an adjusting step immediately before coating. It is also preferred to execute the reduction sensitization by ripening the emulsion at a pH value of 7 or higher or at a pAg value of 8.3 or lower, or by introducing a single addition part of silver ions in the course of grain formation.

9) Compound of Which a 1-Electron Oxidized Member, Formed by a 1-Electron Oxidation, is Capable of Releasing 1 or More Electrons

The photothermographic material of the invention preferably includes a compound of which a 1-electron oxidized member, formed by a 1-electron oxidation, is capable of releasing 1 or more electrons. Such compound is employed either singly or in combination with various aforementioned chemical sensitizers and can provide an increase in the sensitivity of silver halide.

The compound a 1-electron oxidized member, formed by a 1-electron oxidation, of which is capable of releasing 1 or more electrons, to be included in the photothermographic material of the invention, is a compound selected from the following types 1 and 2.

In the following, the compounds of types 1 and 2 to be included in the silver halide photosensitive material of the invention will be explained.

Type 1

A compound of which a 1-electron oxidized member, formed by a 1-electron oxidation, is capable of causing an ensuing bond cleaving reaction thereby further releasing one or more electrons.

Type 2

A compound of which a 1-electron oxidized member, formed by a 1-electron oxidation, is capable, after an ensuing bond forming process, of further releasing one or more electrons.

At first the compound of type 1 will be explained.

Examples of the compound of type 1, of which a 1-electron oxidized member, formed by a 1-electron oxidation, is capable of causing an ensuing bond cleaving reaction thereby further releasing one electron, include compounds described as “1-photon 2-electron sensitizer” or “deprotonation electron donating sensitizer” in JP-A No. 9-211769 (compounds PMT-1 to S-37 described in Tables E and F on pages 28 to 32), JP-A No. 9-211774, JP-A No. 11-95355 (compounds INV1-36), JP-A No. 2001-500996 (specific examples: compounds 1-74, 80-87, 92-122), U.S. Pat. Nos. 5,747,235 and 5,747,236, EP No. 786692A1. (specific examples: compounds INV1-35), EP No. 893732A1, U.S. Pat. Nos. 6,054,260 and 5,994,051. Preferred ranges of these compounds are the same as those described in the cited patents.

Also examples of the compound of type 1, of which a 1-electron oxidized member, formed by a 1-electron oxidation, is capable of causing an ensuing bond cleaving reaction thereby further releasing one or more electrons, include compounds represented by Formula (1) (same meaning as in a general formula (1) described in JP-A No. 2003-114487), by Formula (2) (same meaning as in a general formula (2) described in JP-A No. 2003-114487), by Formula (3) (same meaning as in the general formula (1) described in JP-A No. 2003-114488), by Formula (4) (same meaning as in the general formula (2) described in JP-A No. 2003-114488), by Formula (5) (same meaning as in a general formula (3) described in JP-A No. 2003-114487), by Formula (6) (same meaning as in the general formula (1) described in JP-A No. 2003-75950), by Formula (7) (same meaning as in the general formula (2) described in JP-A No. 2003-75950), by Formula (8) (same meaning as in the general formula (1) described in Japanese Patent Application No. 2003-25886), and by Formula (9) (same meaning as in a general formula (3) described in Japanese Patent Application No. 2003-33446) among compounds capable of causing a reaction represented by the chemical reaction formula (1) (same meaning as in a chemical reaction formula (1) described in Japanese Patent Application No. 2003-33446). Preferred ranges of these compounds are the same as those described in the cited patents.

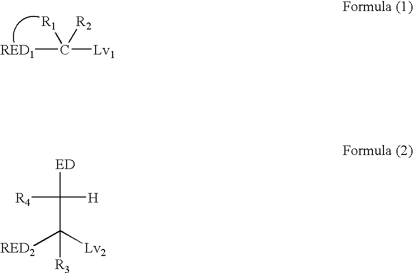

In Formulas (1) and (2), RED₁ and RED₂ each represents a reducing group; R₁ represents a non-metal atomic group capable of forming, together with a carbon atom (C) and RED₁, a cyclic structure corresponding to a tetrahydro member or a hexahydro member of a 5- or 6-membered aromatic ring (including an aromatic heterocycle); R₂, R₃ and R₄ each represents a hydrogen atom or a substituent; Lv₁ and Lv₂ each represents a releasable group; and ED represents an electron donating group.

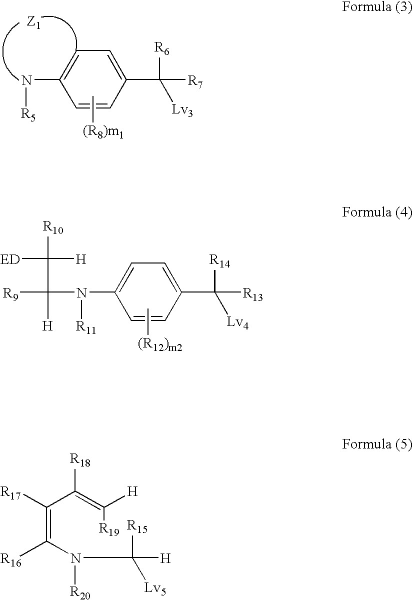

In Formulas (3), (4) and (5), Z₁ represents an atomic group capable of forming a 6-membered ring together with a nitrogen atom and two carbon atoms of a benzene ring; R₅, R₆, R₇, R₈, R₁₀, R₁₁, R₁₃, R₁₄, R₁₅, R₁₆, R₁₇, R₁₈ and R₁₉ each represents a hydrogen atom or a substituent; R₂₀ represents a hydrogen atom or a substituent, but, in the case R₂₀ represents a group other than an aryl group, R₁₆ and R₁₇ are mutually bonded to form an aromatic ring or an aromatic hetero ring; R₈ and R₁₂ each represents a substituent substitutable on the benzene ring; ml represents an integer from 0 to 3; m2 represents an integer from 0 to 4; and Lv₃, Lv₄ and Lv₅ each represents a releasable group.

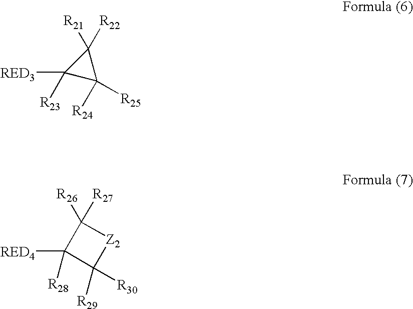

In Formulas (6) and (7), RED₃ and RED₄ each represents a reducing group; R₂₁ to R₃₀ each represents a hydrogen atom or a substituent; Z₂ represents —CR₁₁₁R₁₁₂—, —NR₁₁₃— or —O—; R₁₁₁ and R₁₁₂ each independently represent a hydrogen atom or a substituent; and R₁₁₃ represents a hydrogen atom, an alkyl group, an aryl group or a heterocyclic group.

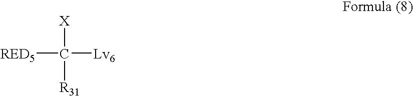

In Formula (8), RED₅ is a reducing group and represents an arylamino group or a heterocyclic amino group; R₃₁ represents a hydrogen atom or a substituent; X represents an alkoxy group, an aryloxy group, a heterocyclic oxy group, an alkylthio group, an arylthio group, a heterocyclic thio group, an alkylamino group, an arylamino group, or a heterocyclic amino group; Lv₆ is a releasable group and represents a carboxy group, a salt thereof or a hydrogen atom.

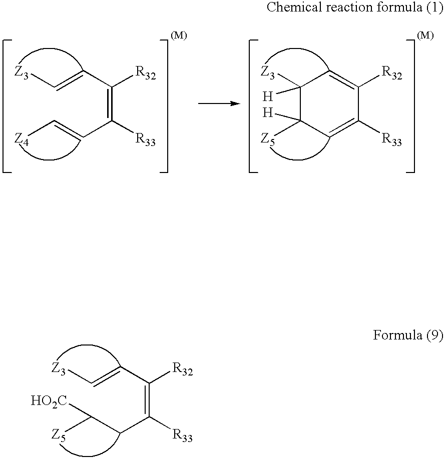

The compound represented by Formula (9) is a compound capable, after a 2-electron oxidation involving decarboxylation, of being further oxidized to causing a bond forming reaction represented by the chemical reaction formula (1). In the chemical reaction formula (1), R₃₂ and R₃₃ each represents a hydrogen atom or a substituent; Z₃ represents a group forming, together with C═C, a 5- or 6-membered hetero ring; Z₄ represents a group forming, together with C═C, a 5- or 6-membered aryl or heterocyclic group; and M represents a radical, a radical cation or a cation. In Formula (9), R₃₂, R₃₃ and Z₃ have the same meaning as those in the chemical reaction formula (1), and Z₅ represents a group forming, together with C—C, a 5- or 6-membered alicyclic hydrocarbon or heterocyclic group.

In the following, the compound of type 2 will be explained.

Examples of the compound of type 2, of which a 1-electron oxidized member, formed by a 1-electron oxidation, is capable of causing an ensuing bond forming reaction thereby further releasing one or more electrons, include compounds represented by Formula (10) (same meaning as in a general formula (1) described in JP-A No. 2003-140287), and by Formula (11) (same meaning as in a general formula (2) described in Japanese Patent Application No. 2003-33446) among compounds capable of causing a reaction represented by the chemical reaction formula (1) (same meaning as in a chemical reaction formula (1) described in Japanese Patent Application No. 2003-33446). Preferred ranges of these compounds are the same as those described in the cited patents.
RED₆-Q-Y Formula (10)

In Formula (10), RED₆ represents a reducing group to be subjected to a 1-electron oxidation; Y represents a reactive group including a carbon-carbon double bond site, a carbon-carbon triple bond site, an aromatic group site, or a non-aromatic heterocyclic site of a benzo condensed ring, capable of forming a new bond by reacting with a 1-electron oxidized member generated by a 1-electron oxidation of RED₆; and Q represents a connecting group for connecting RED₆ and Y.

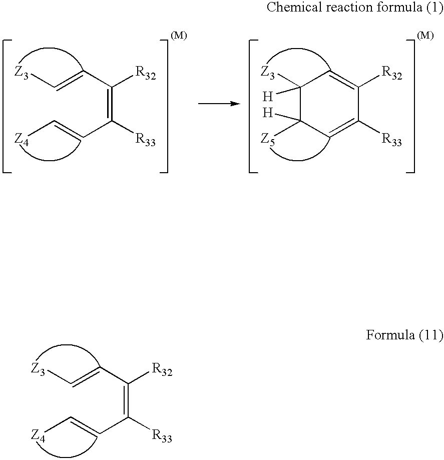

The compound represented by Formula (11) is a compound capable, upon being oxidized, of causing a bond forming reaction represented by the chemical reaction formula (1). In the chemical reaction formula (1), R₃₂ and R₃₃ each represents a hydrogen atom or a substituent; Z₃ represents a group forming, together with C═C, a 5- or 6-membered hetero ring; Z₄ represents a group capable of forming, together with C═C, a 5- or 6-membered aryl or heterocyclic group; Z₅ represents a group capable of forming, together with C—C, a 5- or 6-membered alicyclic hydrocarbon or heterocyclic group; and M represents a radical, a radical cation or a cation. In Formula (11), R₃₂, R₃₃, Z₃ and Z₄ have the same meaning as those in the chemical reaction formula (1).

Among the compounds of types 1 and 2, either “a compound having, within the molecule, a group adsorptive to silver halide” or “a compound having, within the molecule, a partial structure of a spectral sensitizing dye” is preferable. A group adsorptive to silver halide is represented by the group described in JP-A No. 2003-156823, page 16, right column, line 1 to page 17, right column, line 12. A partial structure of a spectral sensitizing dye is a structure described in the aforementioned patent, page 17, right column, line 34 to page 18, left column, line 6.

Among the compounds of types 1 and 2, “a compound having, within the molecule, at least a group adsorptive to silver halide” is more preferable. More preferably, it is “a compound having, within the molecule, two or more groups adsorptive to silver halide”. In the case two or more adsorptive groups are present within a same molecule, such adsorptive groups may be the same or different.

The adsorptive group is preferably a mercapto-substituted nitrogen-containing heterocyclic group (such as a 2-mercaptothiadiazole group, a 3-mercapto-1,2,4-triazole group, a 5-mercaptotetrazole group, a 2-mercapto-1,3,4-oxadiazole group, a 2-mercaptobenzoxazole group, a 2-mercaptobenzothiazole group, or a 1,5-dimethyl-1,2,4-triazolium-3-thiolate group), or a nitrogen-containing heterocyclic group having an —NH— group capable of forming imino silver (>NAg) as a partial structure of the hetero ring (such as a benzotriazole group, a benzimidazole group, or an indazole group). It is particularly preferably a 5-mercaptotetrazole group, a 3-mercapto-1,2,4-triazole group, or a benzotriazole group, and most preferably a 3-mercapto-1,2,4-triazole group or a 5-mercaptotetrazole group.

As the adsorptive group, there is also preferred a case having two or more mercapto groups as a partial structure within the molecule. The mercapto group (—SH) may become a thion group in the case a tautomerism is possible. Preferred examples of the adsorptive group having two or more mercapto groups as a partial structure (such as dimercapto-substituted nitrogen-containing heterocyclic group) include a 2,4-dimercaptopyrimidine group, a 2,4-dimercaptotriazine group, and a 3,5-dimercapto-1,2,4-triazole group.

A quaternary salt structure of nitrogen or phosphor can also be advantageously employed as an adsorptive group. Specific examples of the quaternary salt structure of nitrogen include an ammonio group (such as a trialkylammonio group, a dialkylaryl (or heteroaryl) ammonio group, or an alkyldiaryl (or heteroaryl) ammonio group), or a group including a nitrogen-containing heterocyclic group containing a quaternary nitrogen atom. Examples of the quaternary salt structure of phosphor include a phosphonio group (such as a trialkylphosphonio group, a dialkylaryl (or heteroaryl)phosphonio group, an alkyldiaryl (or heteroaryl)phosphonio group, or a triaryl (or heteroaryl)phosphonio group). There is more preferably employed a quaternary salt structure of nitrogen, further preferably a 5- or 6-membered nitrogen-containing aromatic heterocyclic group including a quaternarized nitrogen atom. Particularly preferably a pyridinio group, a quinolinio group or an isoquinolinio group. Such nitrogen-containing aromatic heterocyclic group including a quaternarized nitrogen atom may have an arbitrary substituent.

Examples of a counter anion for the quaternary salt include a halogen ion, a carboxylate ion, a sulfonate ion, a sulfate ion, a perchlorate ion, a carbonate ion, a nitrate ion, a BF₄ ion, a PF₆ ion and a Ph₄B ion. In the case a group having a negative charge such as a carboxylate group is present in the molecule, an intramolecular salt may be formed with such group. As a counter anion not present within the molecule there is particularly preferred a chloro ion, a bromo ion or a methanesulfonate ion.

The compound of type 1 or 2, having a quaternary salt structure of nitrogen or phosphor as the adsorptive group, has a preferred structure represented by Formula (X).
(P-Q₁-)ᵢ-R(-Q₂-S)ⱼ Formula (X)

In Formula (X), P and R each independently represent a quaternary salt structure of nitrogen or phosphor not constituting a partial structure of a sensitizing dye; Q₁ and Q₂ each independently represent a connecting group, more specifically a single bond, an alkylene group, an arylene group, a heterocyclic group, —O—, —S—, —NR_{N}—, —C(═O)—, —SO₂—, —SO—, or —P(═O)—, either singly or a combination of these groups; R_{N} represents a hydrogen atom, an alkyl group, an aryl group, or a heterocyclic group; S represents a residue formed by eliminating an atom from a compound represented by type (1) or (2); i and j represent integers of 1 or more, which are selected within a range that i+j is from 2 to 6, preferably i is 1 to 3 and j is 1 to 2, more preferably i is 1 or 2 and j is 1, and particularly preferably i is 1 and j is 1. The compound represented by Formula (X) preferably has a total number of carbon atoms of 10 to 100, more preferably 10 to 70, further preferably 11 to 60 and particularly preferably 12 to 50.

In the following there are shown specific examples of the compound of types 1 and 2, but the present invention is not limited to such examples.

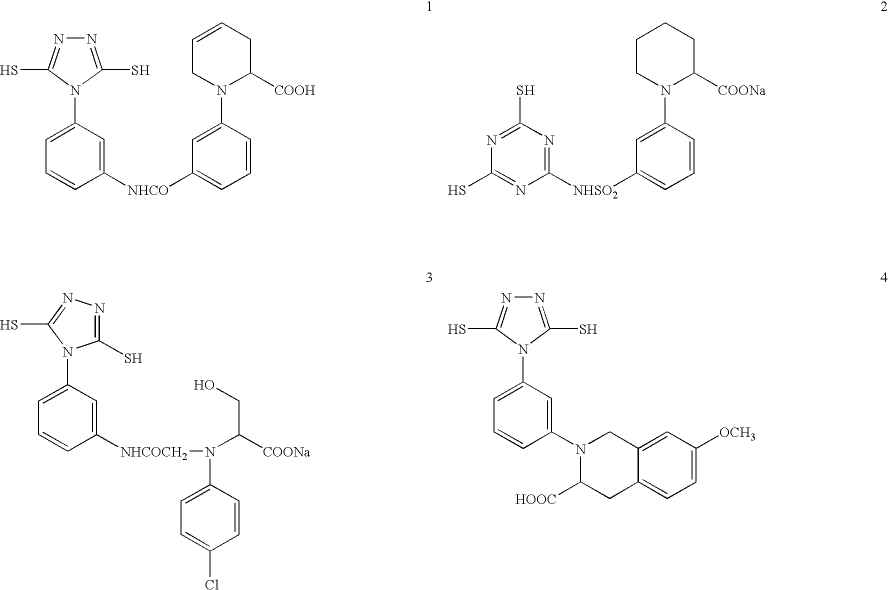

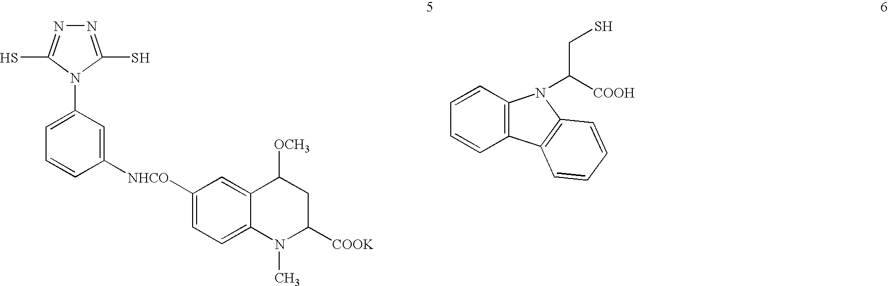

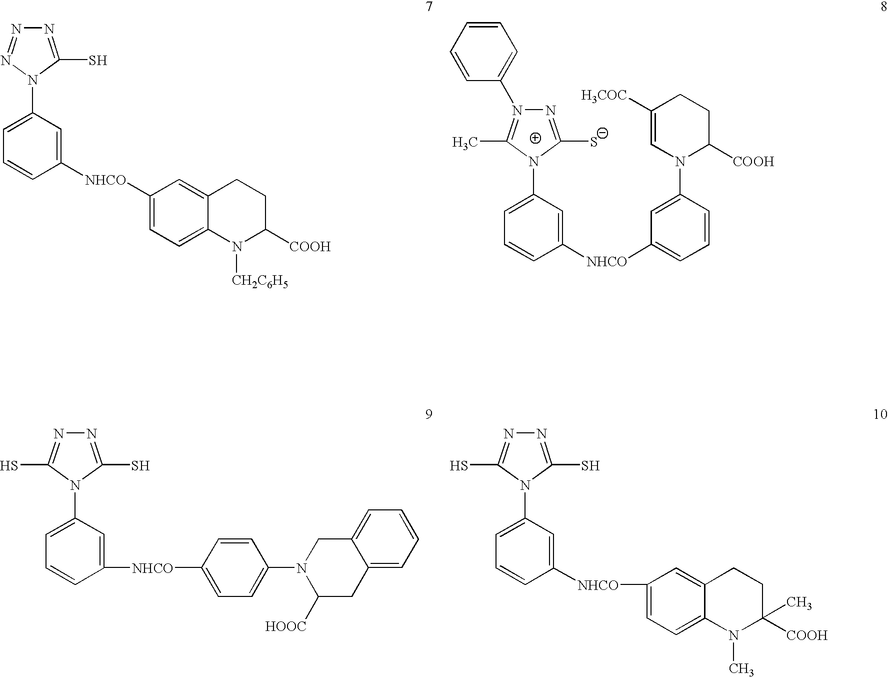

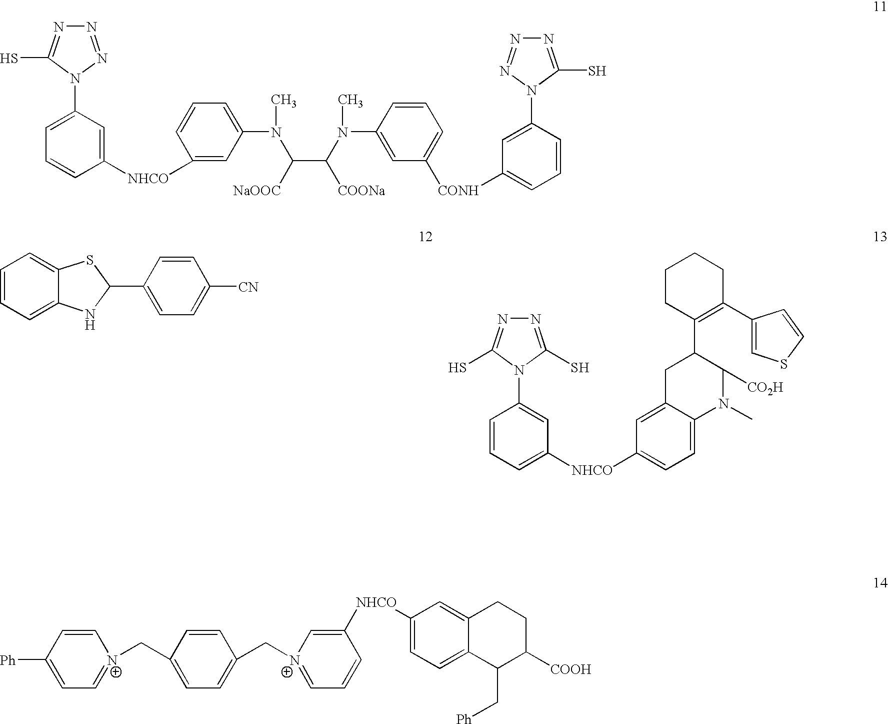

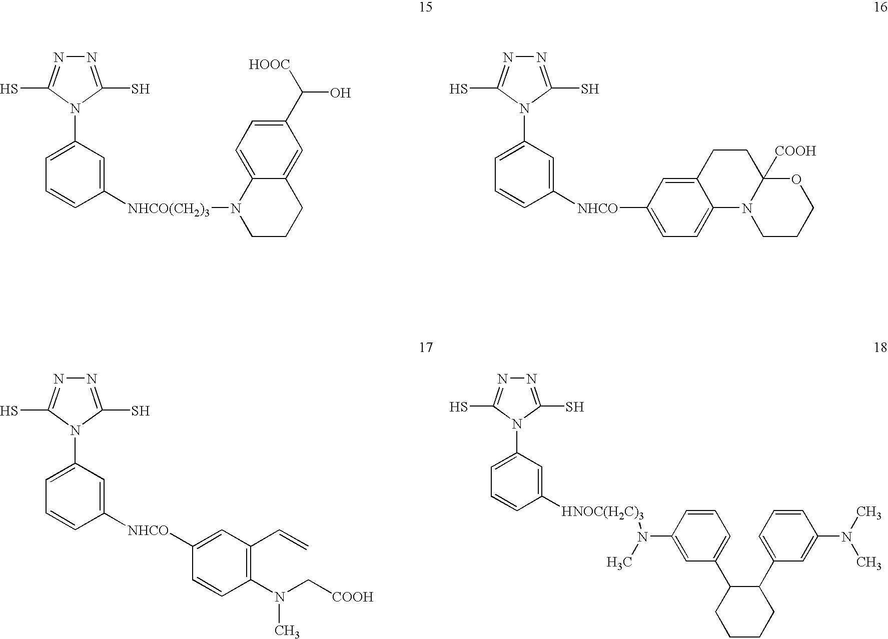

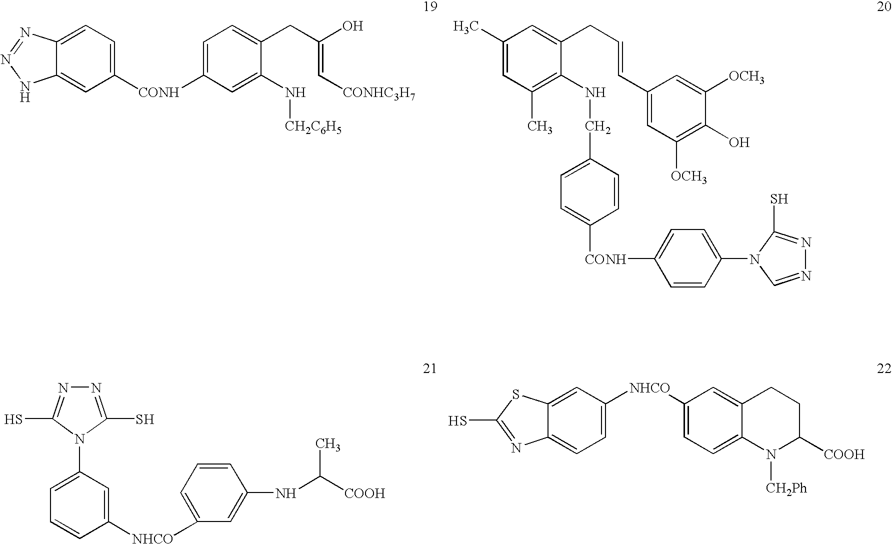

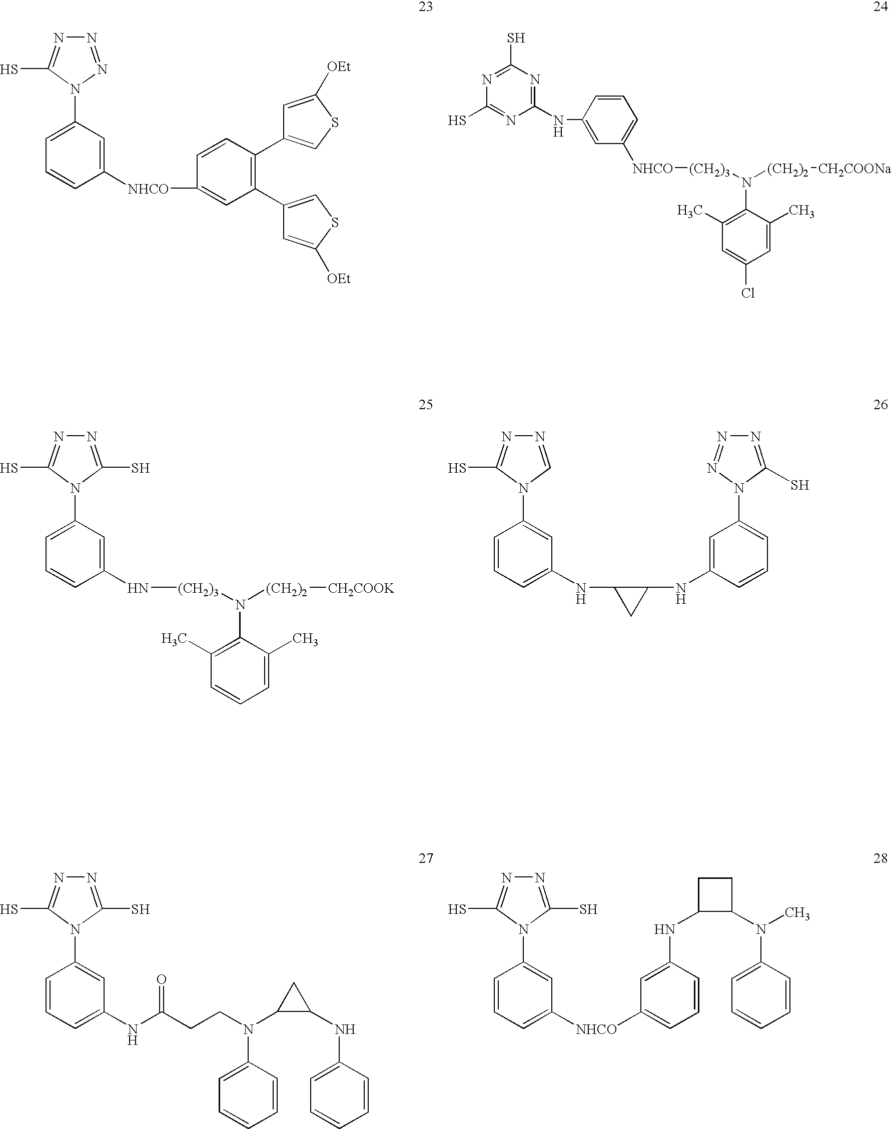

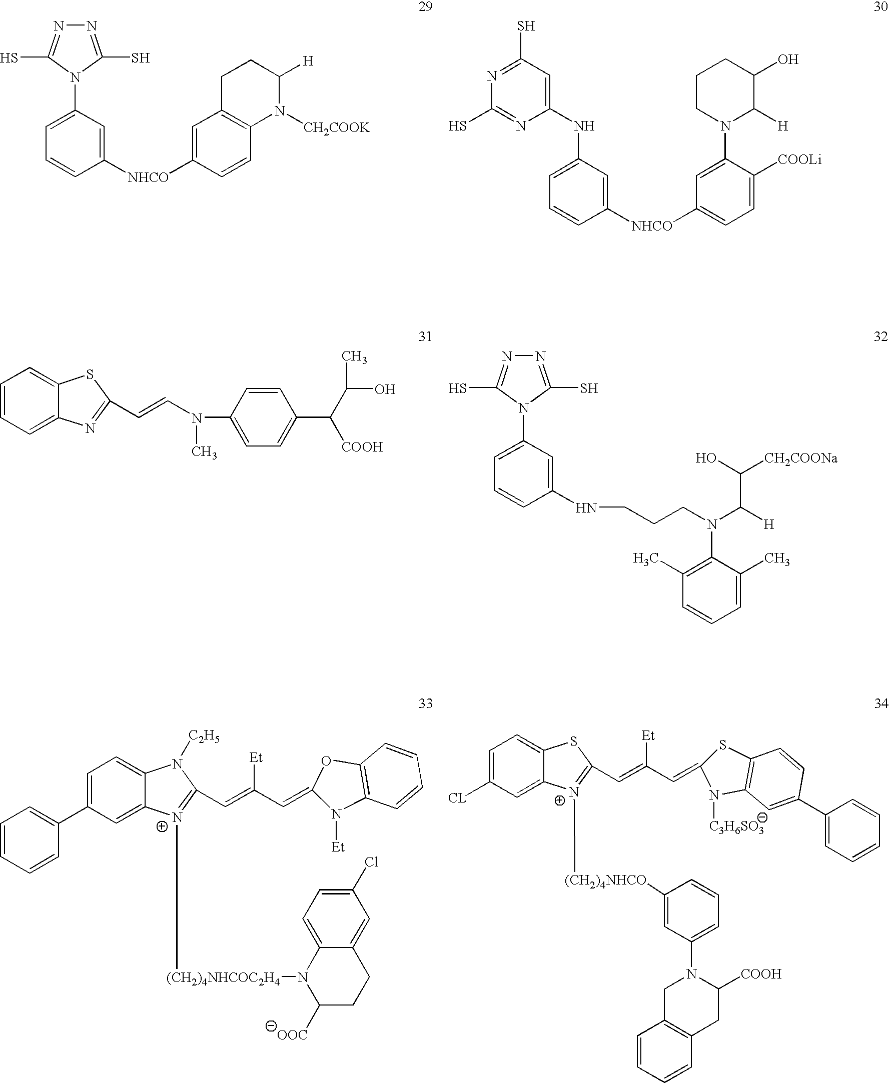

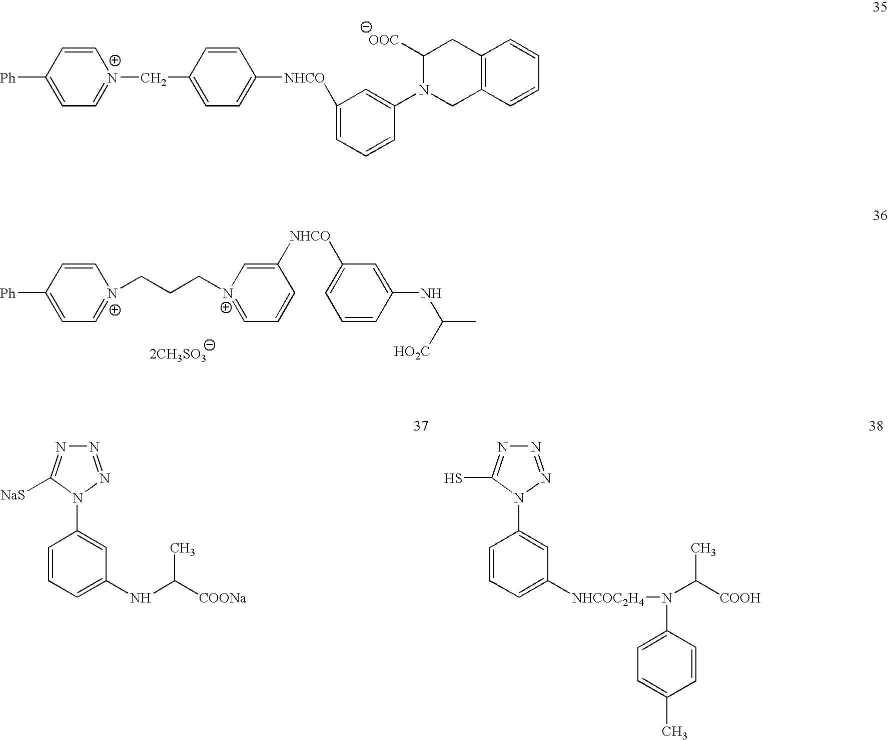

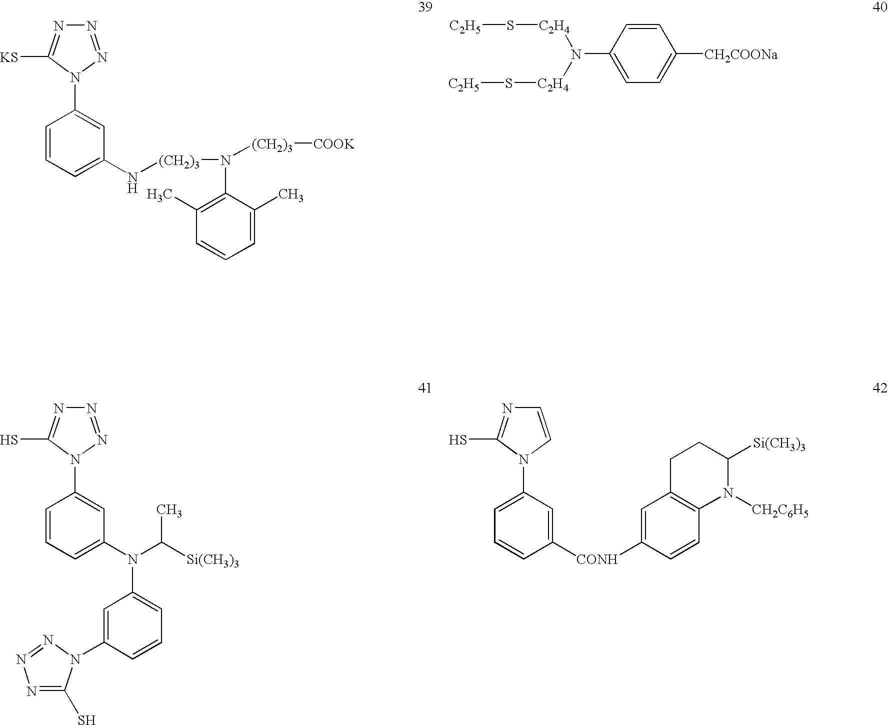

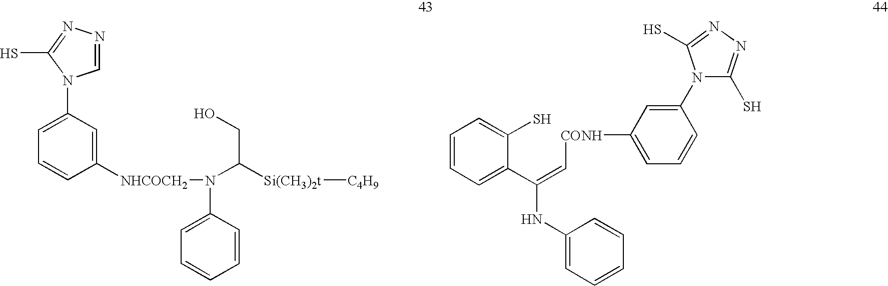

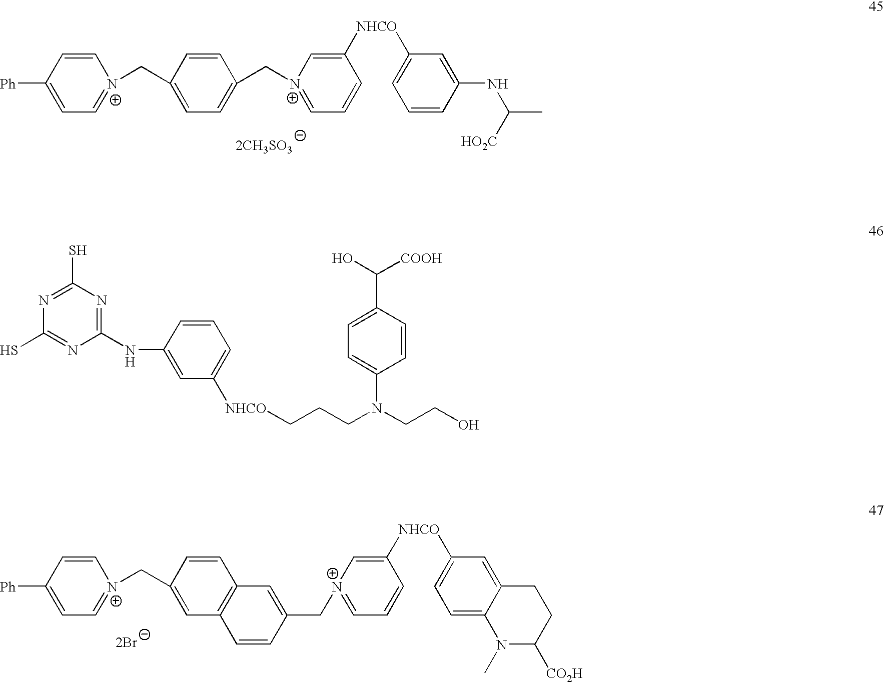

The compound of types 1 and 2 of the invention may be used in any stage in a preparation of an emulsion in a producing process of a photosensitive material. For example it may be used in a grain formation, in a desalting step, at a chemical sensitization or before coating. It may also be added in a divided manner in plural times in these steps. A timing of addition is preferably within a period from the end of grain formation to the start of a desalting step, or at a chemical sensitization (from immediately before the start of chemical sensitization to immediately after the end of chemical sensitization), or prior to a coating, and more preferably at the chemical sensitization or before the coating.

The compound of types 1 and 2 of the invention is added preferably by dissolving in water, a water-soluble solvent such as methanol or ethanol, or a mixture thereof. In the case of dissolving in water, a compound showing a higher solubility at a higher or lower pH may be dissolved at a higher or lower pH.

The compound of types 1 and 2 of the invention is preferably used in an emulsion layer (image forming layer), however it may be added in a protective layer or an intermediate layer in addition to the image forming layer, and may be diffused at the coating. The compound of the invention may be added before or after an addition of a sensitizing dye, and is included in the silver halide emulsion layer (image forming layer) in an amount of 1×10⁻⁹ to 5×10⁻² moles per 1 mole of silver halide, more preferably 1×10⁻⁸ to 2×10⁻³ moles.

10) Adsorptive Redox Compound Having Adsorptive Group and Reducing Group

In the invention, there is preferably included an adsorptive redox compound having an adsorptive group to silver halide and a reducing group within a molecule. Such adsorptive redox compound is preferably represented by the following Formula (I).
A-(W)ₙ—B Formula (I)

In Formula (I), A represents a group adsorptive to silver halide (hereinafter called adsorptive group); W represents a divalent connecting group; n represents 0 or 1; and B represents a reducing group.

In Formula (1), the absorbable group represented by A means a group directly adsorptive to silver halide or a group capable of accelerating an adsorption to silver halide, and is specifically a mercapto group (or a salt thereof), a thion group (—C(═S)—), a heterocyclic group containing at least an atom selected from a nitrogen atom, a sulfur atom, a selenium atom and a tellurium atom, a sulfide group, a disulfide group, a cationic group, or an ethinyl group.

A mercapto group (or a salt thereof) as the adsorptive group means not only a mercapto group (or a salt thereof) itself but also, more preferably, a heterocyclic group, an aryl group or an alkyl group substituted with at least a mercapto group (or a salt thereof). The heterocyclic group is a 5- to 7-membered, single-ringed or condensed-ringed, aromatic or non-aromatic heterocyclic group such as an imidazole ring group, a thiazole ring group, an oxazole ring group, a benzimidazole ring group, a benzothiazole ring group, a benzoxazole ring group, a triazole ring group, a thiadiazole ring group, an oxadiazole ring group, a tetrazole ring group, a purine ring group, a pyridine ring group, a quinoline ring group, an isoquinoline ring group, a pyrimidine ring group or a triazine ring group. It can also be a heterocyclic group including a quaternary nitrogen atom, and, in such case, a substituted mercapto group may be dissociated to form a meso ion. In the case the mercapto group forms a salt, a counter ion can be a cation of an alkali metal, an alkali earth metal or a heavy metal (Li⁺, Na⁺, K⁺, Mg²⁺, Ag⁺, Zn²⁺, etc.), an ammonium ion, a heterocyclic group containing a quaternary nitrogen atom, or a phosphonium ion.

The mercapto group as the adsorptive group may also become a thion group by a tautomerism.

The thion group as the adsorptive group also includes a linear or cyclic thioamide group, a thioureido group, a thiourethane group, or a dithiocarbamate ester group.

The heterocyclic group containing at least an atom selected from a nitrogen atom, a sulfur atom, a selenium atom and a tellurium atom, as the adsorptive group, is a nitrogen-containing heterocyclic group having an —NH— group capable of forming an imino silver (>NAg) as a partial structure of the hetero ring, or a heterocyclic group having —S—, —Se—, —Te— or ═N— capable of coordinating with a silver ion by a coordinate bond as a partial structure of the hetero ring. Examples of the former include a benzotriazole group, a triazole group, an indazole group, a pyrrazole group, a tetrazole group, a benzimidazole group, an imidazole group and a purine group, while examples of the latter include a thiophene group, a thiazole group, an oxazole group, a benzothiophene group, a benzothiazole group, a benzoxazole group, a thiadiazole group, an oxadiazole group, a triazine group, a selenoazole group, a benzselenoazole group, a tellurazole group and a benztellurazole group.

A sulfide group or a disulfide group as the adsorptive group can be any group having an —S— or —S—S-partial structure.

A cationic group as the adsorptive group means a group containing a quaternary nitrogen atom, and specifically includes an ammonio group or a nitrogen-containing heterocyclic group containing a quaternary nitrogen atom. A nitrogen-containing heterocyclic group including a quaternary nitrogen atom can be, for example, pyridinio group, quinolinio group, isoquinolinio group or imiazolio group.

An ethinyl group as the adsorptive group means —C≡CH, in which the hydrogen atom may be substituted.

Such adsorptive group mentioned in the foregoing may have an arbitrary substituent.

Specific examples of the adsorptive group also include those described in JP-A No. 11-95355, pages 4 to 7.

In Formula (I), the adsorptive group represented by A is preferably a mercapto-substituted heterocyclic group (such as a 2-mercaptothiadiazole group, a 2-mercapto-5-aminothiadiazole group, a 3-mercapto-1,2,4-triazole group, a 5-mercaptotetrazole group, a 2-mercapto-1,3,4-oxadiazole group, a 2-mercaptobenzimidazole group, a 1,5-dimethyl-1,2,4-triazolium-3-thiolate group, 2,4-dimercaptopyrimidine group, 2,4-dimercaptotriazine group, 3,5-dimercapto-1,2,4-triazole group or 2,5-dimercapto-1,3-thiazole group), or a nitrogen-containing heterocyclic group having an —NH— group capable of forming imino silver (>NAg) as a partial structure of the hetero ring (such as a benzotriazole group, a benzimidazole group, or an indazole group). It is further preferably a 2-mercaptobenzimidazole group, or a 3,5-dimercapto-1,2,4-triazole group.

In Formula (I), W represents a divalent connecting group. Such connecting group can be of any type, as long as it does not detrimentally affect the photographic properties. For example, there can be utilized a divalent connecting group constituted of a carbon atom, a hydrogen atom, an oxygen atom, a nitrogen atom, and a sulfur atom. Specific examples include an alkylene group having 1 to 20 carbon atoms (such as methylene group, ethylene group, trimethylene group, tetramethylene group, or hexamethylene group), an alkenylene group having 2 to 20 carbon atoms, an alkinylene group having 2 to 20 carbon atoms, an arylene group having 6 to 20 carbon atoms (such as phenylene group or naphthylene group), —CO—, —SO₂—, —O—, —S—, —NR₁— and a combination thereof, wherein R₁ represents a hydrogen atom, an alkyl group, a heterocyclic group or an aryl group.

The connecting group represented by W may have an arbitrary substituent.

In Formula (I), the reducing group represented by B represents a group capable of reducing silver ion, for example a triple bond group such as a formyl group, an amino group, an acetylene group or a propalgyl group, a mercapto group, or a residue obtained by eliminating a hydrogen atom from a hydroxylamine, a hydroxamic acid, a hydroxyurea, a hydroxyurethane, a hydroxysemicarbazide, a reductone (including a reductone derivative), an aniline, a phenol (including a chroman-6-ol, 2,3-dihydrobenzofuran-5-ol, an aminophenol, a sulfonamidephenol, and a polyphenol such as hydroquinone, cathecol, resorcinol, benzenetriol or bisphenol), an acilhydrazine, a carbamoylhydrazine, or 3-pyrazolidone. These may naturally have an arbitrary substituent.

In Formula (I), an oxidation potential of the reducing group represented by B can be measured by a measuring method described in Akira Fujishima, “Denki Kagaku Sokuteiho (electrochemical measuring method)” (pp.150-208, published by Gihodo) and “Jikken Kagaku Koza”, edited by Chemical Society of Japan, 4th ed. (vol. 9, pp.282-344, Maruzen). The measurement can be executed, for example, by a rotary disk voltammetry method, by dissolving a sample in a solution of methanol: pH 6.5 Britton-Robinson buffer=10%:90% (vol. %), passing nitrogen gas for 10 minutes, and executing a measurement with a sweeping rate of 20 mV/sec at 25° C. and 1000 rpm, utilizing a glassy carbon rotary disk electrode (RDE) as an operating electrode, a platinum wire as a counter electrode and a saturated calomel electrode as a reference electrode. A half-peak potential (E1/2) can be determined from an obtained voltammogram.

The reducing group represented by B of the invention, in the measurement with the aforementioned method, preferably has an oxidation potential within a range from about −0.3 to 1.0 V, more preferably about −0.1 to 0.8 V, and particularly preferably about 0 to 0.7 V.

In Formula (I), the reducing group represented by B is preferably a residue obtained by eliminating a hydrogen atom from a hydroxylamine, a hydroxamic acid, a hydroxyurea, a hydroxysemicarbazide, a reductone, a phenol, an acylhydrazine, a carbamoylhydrazine, or a 3-pyrazolidone.

The compound of Formula (I) of the invention may incorporate a ballast group or a polymer chain, which is ordinarily employed in an immobile photographic additive such as a coupler. Also the polymer can be for example those described in JP-A No. 1-100530.

The compound of Formula (I) of the invention may also be a bis or tris member. The compound of Formula (I) of the invention preferably has a molecular weight within a range of 100 to 10,000, more preferably 120 to 1,000 and particularly preferably 150 to 500.

In the following, examples of the compound of Formula (I) of the invention will be shown, but the present invention is not limited to these examples.

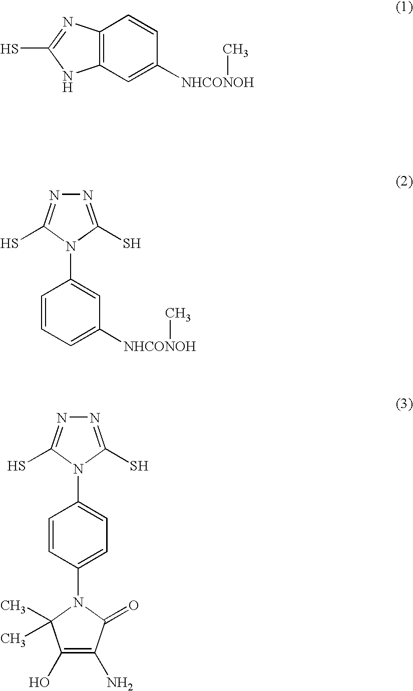

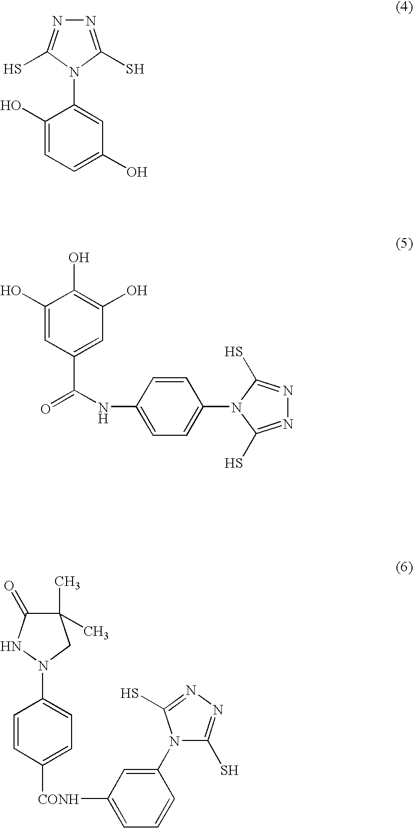

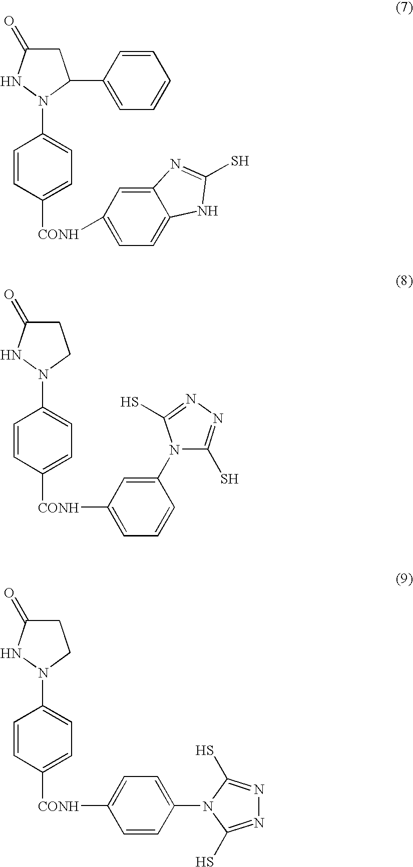

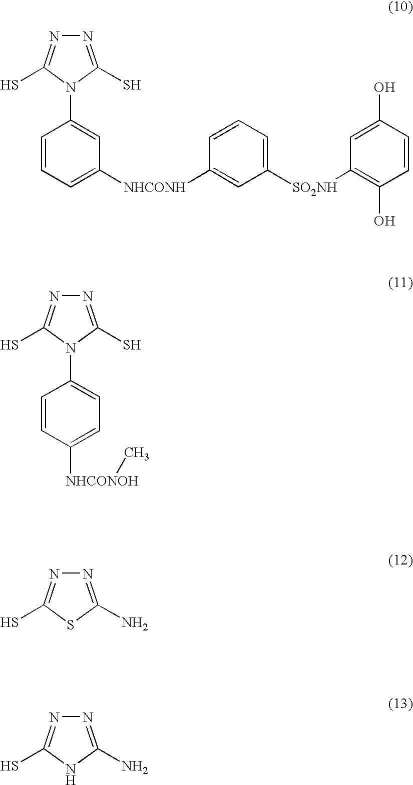

Also specific compounds 1 to 30 and 1″-1 to 1″-77, described in EP No. 1308776A2, pages 73 to 87, can be preferred examples of the compound having the adsorptive group and the reducing group in the invention.

These compounds can be easily synthesized by a known method. The compound of Formula (I) of the invention may be employed singly, but it is also preferable to use two or more compounds at the same time. In the case of employing two or more compounds, they may be added in a same layer or in different layers, and may be used in different adding methods.

The compound of Formula (I) of the invention is preferably added in a silver halide emulsion layer, and is more preferably added at the preparation of the emulsion. In the case of addition at the preparation of the emulsion, the addition may be made in any step of the preparation process, for example in a step of forming silver halide grains, before the start of a desalting step, in a desalting step, before the start of a chemical ripening, in a chemical ripening step, or a step prior to the preparation of a final emulsion. It may also be added in divided manner in plural times in these steps. It is preferably added to the image forming layer, but it may also be added, in addition to the image forming layer, in a protective layer or an intermediate layer adjacent thereto and may be diffused at the coating.

A preferred amount of addition is variable significantly depending on the aforementioned method of addition and the kind of the compound to be added, however it is generally 1×10⁻⁶ to 1 mole per 1 mole of photosensitive silver halide, preferably 1×10⁻⁵ to 5×10⁻¹ moles and further preferably 1×10⁻⁴ to 1×10⁻¹ moles.

The compound of Formula (I) of the invention may be added by dissolving in water, a water-soluble solvent such as methanol or ethanol, or a mixture thereof. In such case, a pH adjustment may be executed with an acid or an alkali, and a surfactant may also be made present. It may also be added in a state of an emulsified dispersion by dissolving in a high-boiling organic solvent. It may also be added as a solid dispersion.

11) Combined Use of Plural Silver Halides

A photosensitive silver halide emulsion to be used in the photosensitive material of the invention may be formed by a single type, or by a combination of two or more types (for example types different in an average grain size, in a halogen composition, in a crystallizing tendency, or in chemical sensitizing conditions). A gradation may be regulated by employing photosensitive silver halides of plural types of different sensitivities. Technologies relating thereto are described for example in JP-A Nos. 57-119341, 53-106125, 47-3929, 48-55730, 46-5187, 50-73627 and 57-150841. As to a difference in sensitivity, there is preferred a difference of 0.2 log E or larger between the emulsions.

12) Coating Amount

An addition amount of the photosensitive silver halide, in terms of a coated silver amount per 1 m² of the photosensitive material, is preferably 0.03 to 0.6 g/m², more preferably 0.05 to 0.4 g/m², and most preferably 0.07 to 0.3 g/m². With respect to 1 mole of organic silver salt, the photosensitive silver halide is preferably present within a range of 0.01 to 0.5 moles, more preferably 0.02 to 0.3 moles and further preferably 0.03 to 0.2 moles.

13) Mixing of Silver Halide to Coating Liquid

A preferred timing of addition of the silver halide of the invention to a coating liquid for forming an image forming layer is in a period from 180 minutes before coating to immediately before coating, preferably from 60 minutes to 10 seconds before coating, however a mixing method and a mixing condition are not particularly restricted as long as the effect of the invention can be sufficiently exhibited. Specific examples of the mixing method include a mixing method in a tank, so as to obtain a desired average stay time calculated from a flow rate of addition and a liquid supply rate to a coater, and a method using a static mixer described for example in N. Harnby, M. F. Edwards and A. W. Nienow, “Liquid mixing technology”, translated by Koji Takahashi and published by Nikkan Kogyo Shimbun, 1989, Chapter 8.

Non-photosensitive organic silver salt

1) Composition

An organic silver salt employable in the invention is a silver salt that is relatively stable to light but functions as a silver ion supplying substance when heated to 80° C. or higher in the presence of an exposed photosensitive silver halide and a reducing agent, thereby forming a silver image. The organic silver salt can be an arbitrary organic substance that can be reduced by the reducing agent and can supply silver ions. Such non-photosensitive organic silver salt is described for example in JP-A No. 10-62899, paragraphs 0048-0049, EP-A No. 0803764A1, page 18, line 24 to page 19, line 37, EP-A No. 0962812A1, and JP-A Nos. 11-349591, 2000-7683 and 2000-72711. There is preferred a silver salt of an organic acid, particularly a silver salt of a long-chain aliphatic carboxylic acid (with 10 to 30 carbon atoms, preferably 15 to 28 carbon atoms). Preferable examples of the aliphatic acid silver salt include silver lignocerate, silver behenate, silver arachidate, silver stearate, silver oleate, silver laurate, silver caproate, silver myristate, silver palmitate, silver erucate and a mixture thereof.

In an embodiment of the invention, the humidity in the packaging bag is 50% RH or less at 25° C., and a an organic silver salt having a behenate content of 50 moles or higher is used. In the invention, it is therefore preferable to use, among such fatty acid silver salts, a fatty acid silver salt with a silver behenate content preferably of 50 to 100 mol. %, more preferably 80 to 100 mol. % and further preferably 90 to 100 mol. %. Besides it is preferable to employ a fatty acid silver salt with a silver erucate content of 2 mol. % or less, more preferably 1 mol. % or less and further preferably 0.1 mol. % or less.

2) Shape

A shape of the organic silver salt employable in the invention is not particularly restricted, and may have an acicular shape, a rod shape, a flat shape or a scale shape.

In the invention, an organic silver salt of scale shape is preferable. There is also advantageously employed a grain of a short acicular shape with a ratio of a longer axis and a shorter axis not exceeding 5, a rectangular parallelepiped shape, a cubic shape or a potato-like amorphous shape. These organic silver grains have an advantage of a lower fog level at thermal development in comparison with a grain of a long acicular shape having a ratio of a longer axis and a shorter axis 5 or more. In particular, a grain with a ratio of a longer axis and a shorter axis of 3 or less is preferable because of an improved mechanical stability of a coated film. In the present specification, an organic silver salt of a scale shape is defined in the following manner. The organic silver salt is observed under an electron microscope, and the grain shape is approximated by a rectangular parallelepiped with sides a, b and c in the increasing order (c may be equal to b), and the following value x is determined with the smaller values a and b in the following manner:
x=b/a

The value x is determined on about 200 grains to determine an average value x (average), and a scale shape is defined by a relation x (average)>1.5. There is preferred a relation 30≧x (average)≧1.5, more preferably 15≧x (average)≧1.5. For reference, an acicular shape is defined by 1≦x (average)<1.5.

In a scale-shaped grain, the value a can be regarded as a thickness of a flat grain having a principal plane defined by sides b and c. An average of the value a is preferably within a range from 0.01 to 0.3 μm, more preferably from 0.1 to 0.23 μm. Also an average of c/b is preferably within a range from 1 to 9, more preferably 1 to 6, further preferably from 1 to 4, and most preferably from 1 to 3.

A sphere-corresponding diameter maintained within a range from 0.05 to 1 μm hinders coagulation in the photosensitive material and provides a satisfactory image storability. The sphere-corresponding diameter is preferably 0.1 to 1 μm. In the present invention, the sphere-corresponding diameter can be determined by taking a photograph of a sample by an electron microscope and then executing an image processing on a negative film.

In the aforementioned scale-shaped grains, a ratio of (sphere-corresponding diameter)/a of the grain is defined as an aspect ratio. The aspect ratio of the scale-shaped grain is preferably within a range from 1.1 to 30 in view of hindering coagulation in the photosensitive material and improving the image storability, more preferably from 1.1 to 15.

A grain size distribution of the organic silver salt is preferably a single dispersion. Single dispersion means that a percentage of a standard deviation of each length of the shorter axis and the longer axis, divided respectively by the shorter axis and the longer axis, is preferably 100% or less, more preferably 80% or less and further preferably 50% or less. The shape of the organic silver salt can be measured from a transmission electron microscope image of an organic silver salt dispersion. The single dispersion property can also be measured by determining a standard deviation of a volume-weighted average diameter of the organic silver salt, and a percentage (variation factor) obtained by dividing with the volume-weighted average diameter is preferably 100% or less, more preferably 80% or less and further preferably 50% or less. It can be determined for example from a particle size (volume-weighted average diameter) obtained by irradiating the organic silver salt, dispersed in a liquid, with a laser light and determining a self-correlation function of a fluctuation in time of the scattered light.

3) Preparation

The organic silver salt can be prepared by adding an alkali metal salt (such as sodium hydroxide or potassium hydroxide) to an organic acid to prepare an alkali metal soap of the organic acid, and then mixing a water-soluble silver salt (such as silver nitrate), and the silver halide may be added at any stage of such preparation. There are principally four mixing methods, namely A) to add silver halide in advance to the organic acid, then to add the alkali metal salt and then to mix with the water-soluble silver salt, B) to mix the alkali metal soap of organic acid with silver halide and then to mix with the water-soluble silver salt, C) to convert a part of the alkali metal soap of organic acid into silver salt, then to mix silver halide, and to execute conversion of the remainder into silver salt, and D) to mix silver halide in a step after the preparation of the organic silver salt is completed.

The method B) or C) is preferable, and the method B) is particularly preferable.

In the methods B) and C), it is important to mix the photosensitive silver halide, prepared in advance, in the course of preparation of the organic silver salt, thereby preparing a dispersion of organic silver salt containing silver halide. More specifically, the photosensitive silver halide is prepared in the absence of non-photosensitive organic silver salt, and is then mixed in the course of preparation of the organic silver salt. This is because a sufficient sensitivity may not be achievable in a method of preparing silver halide by adding a halogenating agent to organic silver salt.

In the method D) of mixing silver halide and organic silver salt, there can be employed a method of mixing the photosensitive silver halide and the organic silver salt, prepared separately, by a high-speed agitator, a ball mill, a sand mill, a colloid mill, a vibrating mill, a homogenizer, etc. or a method of preparing the organic silver salt by mixing the already prepared silver halide at any timing in the course of preparation of the organic silver salt thereby preparing the organic silver salt. The effect of the invention can be advantageously obtained in either methods.

These salt forming steps are all executed in water solvent, and, after dehydration and drying, re-dispersion into a solvent such as MEK is executed. The drying is executed with an air-flow flush jet dryer preferably with an oxygen partial pressure of 15 vol. % or less, more preferably 15 to 0.01 vol. % and further preferably 10 to 0.01 vol. %.

The organic silver salt can be employed in any desired amount, however it is preferably used in a range of 0.1 to 5 g/m² as a silver coating amount, and more preferably 1 to 3 g/m².

4) Amount of Addition

The organic silver salt of the invention may be employed in a desired amount, however a total coated silver amount including silver halide is preferably within a range of 0.1 to 5.0 g/m², more preferably 0.3 to 3.0 g/m², and further preferably 0.5 to 1.9 g/m². In particular, for improving the image storability, the total coated silver amount is preferably 1.8 g/m² or less, more preferably 1.6 g/m² or less. The preferred reducing agent of the invention allows to obtain a sufficient image density even at such low silver coating amount.

Antifogging Agent

An antifogging agent, a stabilizer and a stabilizer precursor employable in the invention can be compounds described in JP-A No. 10-62899, paragraph 0070, EP-A No. 0803764A1, page 20, line 57 to page 21, line 7, JP-A Nos. 9-281637 and 9-329864, U.S. Pat. No. 6,083,681, and European Patent No. 1048975. Also an antifogging agent advantageously employed in the invention is an organic halogen compound, which can be compounds described in JP-A No. 11-65021, paragraphs 0111-0112. There are particularly preferred an organic halogen compound represented by Formula (P) in JP-A No. 2000-284399, an organic polyhalogen compound represented by the general formula (II) in JP-A No. 10-339934, and an organic polyhalogen compound described in JP-A Nos. 2001-31644 and 2001-33911.

1) Polyhalogen Compound

In the following an organic polyhalogen compound preferable in the invention will be explained in detail. A polyhalogen compound preferred in the invention is represented by the following Formula (H).
Q-(Y)ₙ—C(Z₁)(Z₂)X Formula (H)

In Formula (H), Q represents an alkyl group, an aryl group or a heterocyclic group; Y represents a divalent connecting group; n represents 0 or 1; Z₁ and Z₂ each represents a halogen atom; and X represents a hydrogen atom or an electron-attracting group.

In Formula (H), Q is preferably an aryl group or a heterocyclic group.

In the case Q is a heterocyclic group in Formula (H), there is preferred a nitrogen-containing heterocyclic group including 1 or 2 nitrogen atoms, and particularly preferably a 2-pyridyl group or a 2-quinolyl group.

In the case Q is an aryl group in Formula (H), Q preferably represents a phenyl group substituted with an electron-attracting group of which a Hammett's substituent constant up assumes a positive value. As to the Hammett's substituent constant, reference may be made for example to Journal of Medicinal Chemistry, 1973, Vol. 16, No. 11, 1207-1216. Such electron-attracting group can be, for example, a halogen atom (such as fluorine atom (σₚ: 0.06), a chlorine atom (σₚ: 0.23), a bromine atom (σₚ: 0.23) or an iodine atom (σₚ: 0.18)), a trihalomethyl group (such as tribromomethyl (σₚ: 0.29), trichloromethyl (σₚ: 0.33) or trifluoromethyl (σₚ: 0.54)), a cyano group (σₚ: 0.66), a nitro group (σₚ: 0.78), an aliphatic, aryl or heterocyclic sulfonyl group (such as methanesulfonyl (σₚ: 0.72)), an aliphatic, aryl or heterocyclic acyl group (such as acetyl (σₚ: 0.50) or benzoyl (σₚ: 0.43)), an alkinyl group (such as C≡CH (σₚ: 0.23)), an aliphatic, aryl or heterocyclic oxycarbonyl group (such as methoxycarbonyl (σₚ: 0.45) or phenoxycarbonyl (σₚ: 0.44)), a carbamoyl group (σₚ: 0.36), a sulfamoyl group (σₚ: 0.57), a sulfoxide group, a heterocyclic group or a phosphoryl group. The up value is preferably within a range of 0.2 to 2.0, more preferably 0.4 to 1.0. The electron-attracting group is particularly preferably a carbamoyl group, an alkoxycarbonyl group, an alkylsulfonyl group, or an alkylphosphoryl group, and most preferably a carbamoyl group.

X is preferably an electron-attracting group, more preferably a halogen atom, an aliphatic, aryl or heterocyclic sulfonyl group, an aliphatic, aryl or heterocyclic acyl group, an aliphatic, aryl or heterocyclic oxycarbonyl group, a carbamoyl group or a sulfamoyl group, and particularly preferably a halogen atom. The halogen atom is preferably a chlorine atom, a bromine atom or an iodine atom, further preferably a chlorine atom or a bromine atom and particularly preferably a bromine atom.

Y preferably represents —C(═O)—, —SO— or —SO₂—, more preferably —C(═O)— or —SO₂— and particularly preferably —SO₂—, and n represents 0 or 1, preferably 1.

In the following, specific examples of the compound of Formula (H) are shown.

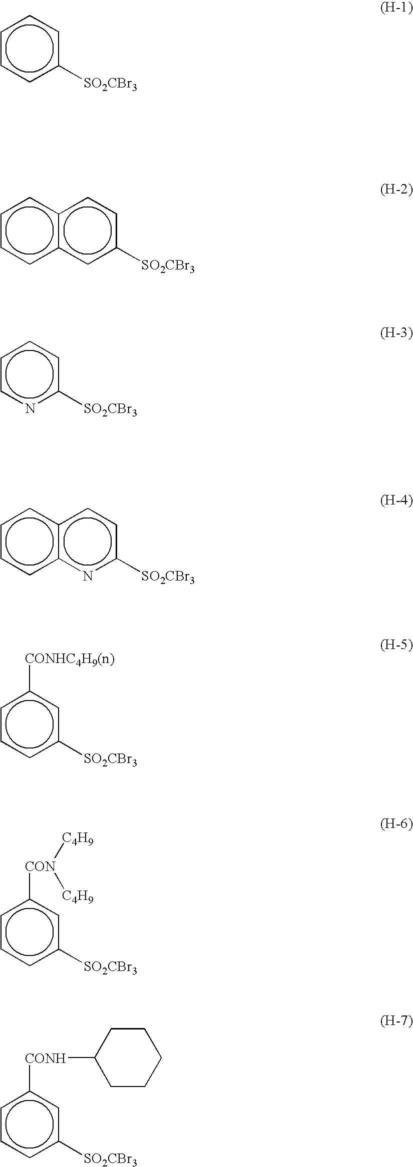

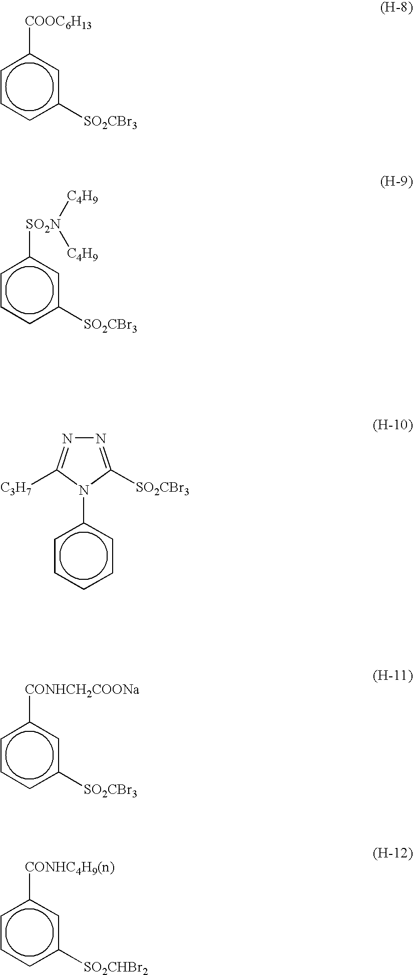

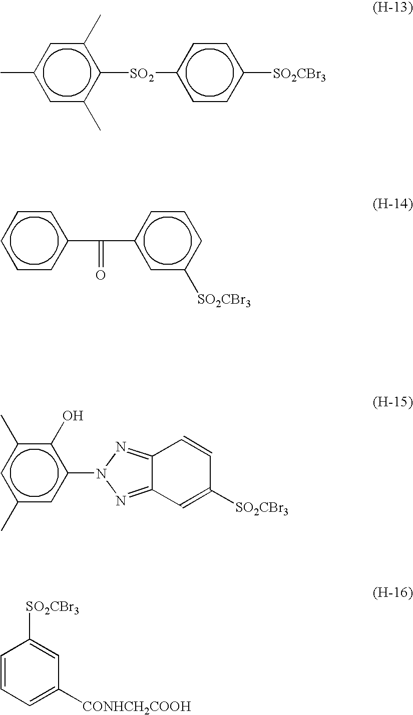

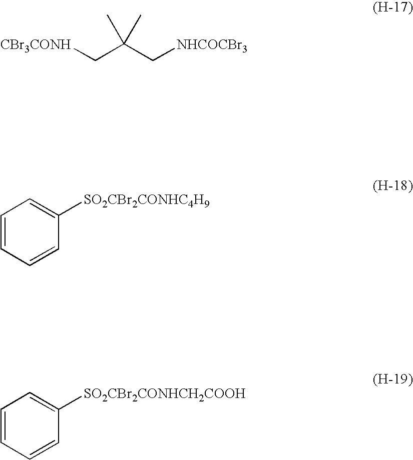

The polyhalogen compound preferable in the invention, other than those described above, can be those described in JP-A Nos. 2001-31644, 2001-56526 and 2001-209145.

The compound of formula (H) of the invention is preferably used within a range of 10⁻⁴ to 1 mole per 1 mole of the non-photosensitive silver salt in the image forming layer, more preferably 10⁻³ to 0.5 moles, and further preferably 1×10⁻² to 0.2 moles.

In the invention, the anti-fogging agent can be included in the photosensitive material by the aforementioned method described for including the reducing agent.

2) Other Anti-Fogging Agents

As another anti-fogging agent, there may be employed a mercury (II) salt described in JP-A No. 11-65021, paragraph 0113, a benzoic acid described in paragraph 0114 therein, a salicylic acid derivative described in JP-A No. 2000-206642, a formalin scavenger compound represented by Formula (S) in JP-A No. 2000-221634, a triazine compound described in claim 9 of JP-A No. 11-352624, a compound represented by Formula (III) in JP-A No. 6-11791, 4-hydroxy-6-methyl-1,3,3a,7-tetrazaindene, etc.

The photothermographic material of the invention may include an azolium salt for the purpose of fog prevention. The azolium salt can be a compound represented by the general formula (XI) in JP-A No. 59-193447, a compound described in JP-B No. 55-12581, or a compound represented by the general formula (II) in JP-A No. 60-153039. The azolium salt may be added to any part of the photosensitive material, but, as to a layer of addition, it is preferably added in a layer on a side having the image forming layer and more preferably added to the organic silver salt-containing layer. The azolium salt may be added in any step of preparation of the coating liquid, and, in the case of an addition to the organic silver salt-containing layer, in any step from the preparation of the organic silver salt to the preparation of the coating liquid, but preferably within a period from a time after the preparation of the organic silver salt to a time immediately before the coating. The azolium salt may be added in any method, such as powder, a solution or a dispersion of fine particles. Also it may be added as a mixed solution with another additive such as a sensitizing dye, a reducing agent or a color toning agent. In the invention, the azolium salt may be added in any amount, however there is preferred an amount from 1×10⁻⁶ to 2 moles per 1 mole of silver, more preferably from 1×10⁻³ to 0.5 moles.

Hydrogen Bonding Compound

In the invention, in the case the reducing agent has an aromatic hydroxyl group (—OH) or an amino group, particularly in the case it is an aforementioned bisphenol, it is possible to also employ a non-reducing compound having a group capable of forming a hydrogen bond with such aforementioned group.

A group capable of forming a hydrogen bond with a hydroxyl group or an amino group can be, for example, a phosphoryl group, a sulfoxide group, a sulfonyl group, a carbonyl group, an amide group, an ester group, an urethane group, an ureide group, a tertiary amino group or a nitrogen-containing aromatic group. Among these there is preferred a compound having a phosphoryl group, a sulfoxide group, an amide group (however not including >N-H but blocked as in >N—Ra (Ra being a substituent other than H)), an urethane group (however not including >N—H but blocked as in >N—Ra (Ra being a substituent other than H)), or an ureide group (however not including >N—H but blocked as in >N—Ra (Ra being a substituent other than H)).

In the invention, a particularly preferred hydrogen bonding compound is represented by the following Formula (D).

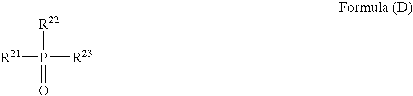

In Formula (D), R²¹ to R²³ each independently represent an alkyl group, an aryl group, an alkoxy group, an aryloxy group, an amino group or a heterocyclic group, which may be non-substituted or may have a substituent.

In the case any of R²¹ to R²³ has a substituent, such substituent can be a halogen atom, an alkyl group, an aryl group, an alkoxy group, an amino group, an acyl group, an acylamino group, an alkylthio group, an arylthio group, a sulfonamide group, an acyloxy group, an oxycarbonyl group, a carbamoyl group, a sulfamoyl group, a sulfonyl group or a phosphoryl group, among which preferred is an alkyl group or an aryl group such as a methyl group, an ethyl group, an isopropyl group, a t-butyl group, a t-octyl group, a phenyl group, a 4-alkoxyphenyl group or a 4-acyloxylphenyl group.

Specific examples of an alkyl group constituting any of R²¹ to R²³ include a methyl group, an ethyl group, a butyl group, an octyl group, a dodecyl group, an isopropyl group, a t-butyl group, a t-amyl group, a t-octyl group, a cyclohexyl group, a 1-methylcyclohexyl group, a benzyl group, a phenetyl group, and a 2-phenoxypropyl group.

Specific examples of the aryl group include a phenyl group, a cresyl group, a xylyl group, a naphthyl group, a 4-t-butylphenyl group, a 4-t-octylphenyl group, a 4-anisidyl group and a 3,5-dichlorophenyl group.

Specific examples of the alkoxy group include a methoxy group, an ethoxy group, a butoxy group, an octyloxy group, a 2-ethylhexyloxy group, a 3,5,5-trimethylhexyloxy group, a dodecyloxy group, a cyclohexyloxy group, a 4-methylcyclohexyloxy group and a benzyloxy group.

Specific examples of the aryloxy group include a phenoxy group, a cresyloxy group, an isopropylphenoxy group, a 4-t-butylphenoxy group, a naphthoxy group and a biphenyloxy group.

Specific examples of the amino group include a dimethylamino group, a diethylamino group, a dibutylamino group, a dioctylamino group, an N-methyl-N-hexylamino group, a dicyclohexylamino group, a diphenylamino group and an N-methyl-N-phenylamino group.

Each of R²¹ to R²³ is preferably an alkyl group, an aryl group, an alkoxy group, or an aryloxy group. For the effect of the invention, it is preferable that at least one of R²¹ to R²³ is an alkyl group or an aryl group, and more preferable that each of two or more is an alkyl group or an aryl group. It is also preferred that R²¹ to R²³ are the same groups, in consideration of inexpensive availability.

In the following, specific examples of the hydrogen bonding compound of the invention, including the compound of Formula (D), are shown, but the invention is not limited to such examples.

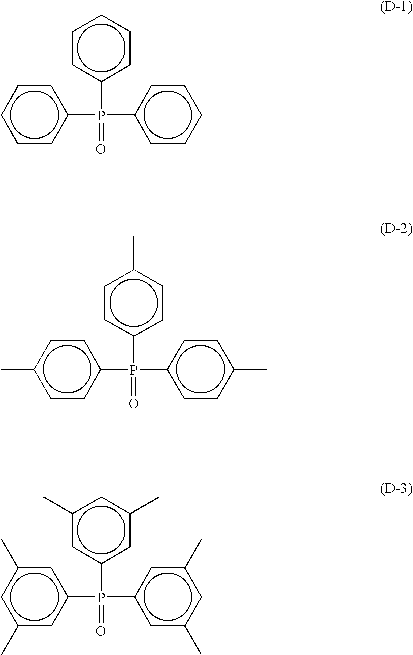

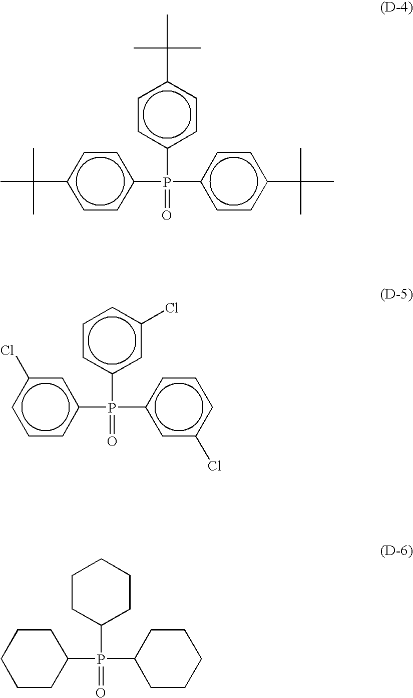

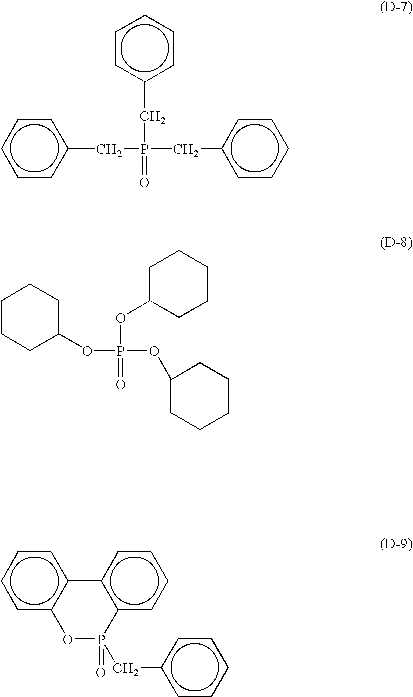

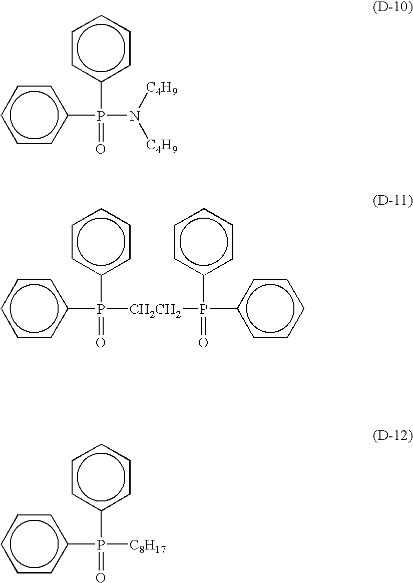

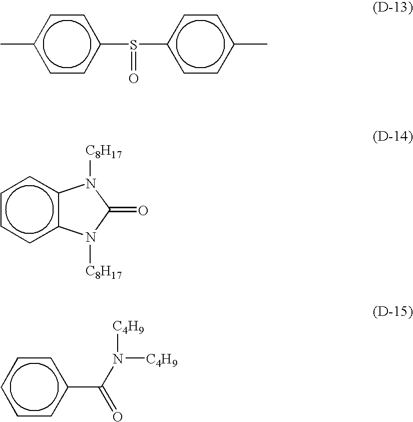

Specific examples of the hydrogen bonding compound, other than those in the foregoing, are described in European Patent No. 1096310, JP-A Nos. 2002-156727 and 2002-318431.

The compound of Formula (D) of the invention is preferably contained, like the reducing agent, in the coating liquid. The compound of the invention forms, in a solution state, a complex by a hydrogen bonding with a compound having a phenolic hydroxyl group or an amino group, and may be isolated in a crystalline state depending on the combination of the reducing agent and the compound of Formula (D) of the invention.

The compound of Formula (D) of the invention is preferably employed within a range of 1 to 200 mol. % with respect to the reducing agent, more preferably within a range of 10 to 150 mol. % and further preferably 20 to 100 mol. %.

Surfactant

A surfactant employable in the invention is described in JP-A No. 11-65021, paragraph 0132. Also the above-mentioned-reference describes a solvent in paragraph 0133, a substrate in paragraph 0134, an antistatic agent or a conductive layer in paragraph 0135, and a method for obtaining a color image in paragraph 0136. Also a lubricant is described in JP-A No. 11-84573, paragraphs 0061-0064 and JP-A No. 2000-208857, paragraphs 0049-0062.

In the invention, it is preferable to employ a fluorinated surfactant. Specific examples of the fluorinated surfactant include those described in JP-A Nos. 10-197985, 2000-19680 and 2000-214554. There can also be preferably employed a fluorinated polymer surfactant described in JP-A No. 9-281636. In the photothermographic material, it is particularly preferable to employ a fluorinated surfactant described in JP-A Nos. 2002-82411, 2003-057780 and 2003-149766. In particular, the fluorinated surfactant described in JP-A No. 2003-057780 and Japanese Patent Application No. 2001-264110 is preferable in charge regulating ability, stability of a coated surface and lubricating ability in the case of executing a coating with an aqueous coating liquid, and a fluorinated surfactant described in Japanese Patent Application No. 2001-264110 is most preferable in that it has a high charge regulating ability and it can be used in a small amount.

In the invention, the fluorinated surfactant can be employed in either of the emulsion surface and the back surface, and is preferably employed in both surfaces. It is particularly preferable to employ it in combination with a conductive layer including the aforementioned metal oxide. In such case, a sufficient performance can be obtained even in the case the fluorinated surfactant on a surface having the conductive layer is reduced in the amount or is eliminated.

An amount of use of the fluorinated surfactant, in each of the emulsion surface and the back surface, is preferably within a range of 0.1 to 100 mg/m², more preferably 0.3 to 30 mg/m², and further preferably 1 to 10 mg/m². In particular, a fluorinated surfactant described in Japanese Patent Application No. 2001-264110 is highly effective and is employed preferably within a range of 0.01 to 10 mg/m², more preferably 0.1 to 5 mg/m².

Other Additives

1) Mercapto, Disulfide and Thion

In the invention, for the purposes of controlling development by suppression or acceleration, improving an efficiency of spectral sensitization, improving storability before and after the development, etc., there may be included a mercapto compound, a disulfide compound or a thion compound such as those described in JP-A No. 10-62899, paragraphs 0067-0069, those represented by Formula (I) in JP-A No. 10-186572 and specific examples described in paragraphs 0033-0052 thereof, and those described in EP-A No. 0803764A1, page 20, lines 36-56. Among these, particularly preferred is a mercapto-substituted heteroaromatic compound described for example in JP-A Nos. 9-297367, 9-304875, 2001-100358, 2002-303954 and 2002-303951.

2) Color Toning Agent

In the photothermographic material of the invention, a color toning agent is preferably added. The color toning agent is described in JP-A No. 10-62899, paragraphs 0054-0055, EP-A No. 0803764A1, p.21, lines 23 to 48, JP-A Nos. 2000-356317 and 2000-187298, and there is preferred a phthalazinone (phthalazinone, a phthalazinone derivative or a metal salt thereof, such as 4-(1-naphthyl)phthalazinone, 6-chlorophthalazinone, 5,7-dimethoxyphthazinone or 2,3-dihydro-1,4-phthalazindione); a combination of a phthalazinone and a phthalic acid (such as phthalic acid, 4-methylphthalic acid, 4-nitrophthalic acid, diammonium phthalate, sodium phthalate, potassium phthalate or tetrachlorophthalic anhydride); a phthalazine (phthalazine, a phthalazine derivative or a metal salt thereof, such as 4-(1-naphtyl)phthalazine, 6-isopropylphthalazine, 6-t-butylphthalazine, 6-chlorophthalazine, 5,7-dimethoxyphthalazine or 2,3-dihydrophthalazine); or a combination of a phthalazine and a phthalic acid, and, there is more preferred a combination of a phthalazine and a phthalic acid. Among such combination, a combination of 6-isopropylphthazine and phthalic acid or 4-methylphthalic acid is particularly preferable.

3) Plasticizer, Lubricant

In the invention, a plasticizer or a lubricant already known may be used in order to improve physical properties of the film. It is particularly preferable to employ a lubricant such as liquid paraffin, a long-chain fatty acid, a fatty acid amide or a fatty acid ester in order to improve a handling property at the manufacture or a scratch resistance at the thermal development. There is particularly preferred liquid paraffin from which low-boiling components are removed or a fatty acid ester of a ramified structure with a molecular weight of 1,000 or higher.

A plasticizer and a lubricant preferably employable in the invention are described in JP-A Nos. 11-65021, paragraph 0117, and 2000-5137, and Japanese Patent Applications Nos. 2003-8015, 2003-8071 and 2003-132815.

4) Dye, Pigment

In the photosensitive layer of the invention, for the purposes of color tone improvement, prevention of interference fringes at the laser exposure and prevention of irradiation, there may be employed various dyes and pigments (for example C. I. Pigment Blue 60, C. I. Pigment Blue 64, or C. I. Pigment Blue 15:6). These are described in detail for example in WO98/36322, and JP-A Nos. 10-268465 and 11-338098.

5) Ultra-Hard Gradation Enhancing Agent

For forming an ultra high contrast image suitable for printing plate preparation, it is preferable to add an ultra-hard gradation enhancing agent in the image forming layer. The ultra-hard gradation enhancing agent, a method of addition thereof and an amount of addition thereof are described for example in JP-A No. 11-65021, paragraph 0118, JP-A No. 11-223898, paragraphs 0136-0193, JP-A No. 2000-284399, formulas (H), (1) to (3), (A) and (B), and Japanese Patent Application No.11-91652, general formulas (III) to (V) (specific compounds in formulas 21-24), while a hard gradation accelerating agent is described in JP-A No. 11-65021, paragraph 0102 and JP-A No. 11-223898, paragraphs 0194-0195.

In order to employ formic acid or a formate salt as a strong fogging substance, it is preferably added in a side having the image forming layer, containing photosensitive silver halide, in an amount of 5 mmol. or less per 1 mole of silver, more preferably 1 mmol. or less.

In the case of employing an ultra-hard gradation enhancing agent in the photothermographic material of the invention, it is preferable to use, in combination, an acid formed by hydration of phosphorous pentoxide or a salt thereof. Examples of the acid formed by hydration of phosphorous pentoxide or a salt thereof include metaphosphoric acid (and salt thereof), pyrophosphoric acid (and salt thereof), orthophosphoric acid (and salt thereof), triphosphoric acid (and salt thereof), tetraphosphoric acid (and salt thereof), and hexametaphosphoric acid (and salt thereof). An acid formed by hydration of phosphorous pentoxide or a salt thereof, that can be particularly preferably employed, is orthophosphoric acid (and salt thereof), or hexametaphosphoric acid (and salt thereof). Specific examples of salt include sodium orthophosphate, sodium dihydrogen orthophosphate, sodium hexametaphosphate and ammonium hexametaphosphate.

An amount of use (coating amount per 1 m² of the photosensitive material) of the acid formed by hydration of phosphorous pentoxide or the salt thereof may be suitably selected according to desired performances such as the sensitivity or the fog level, however is preferably 0.1 to 500 mg/m² and more preferably 0.5 to 100 mg/m².

The reducing agent, the hydrogen bonding compound, the development accelerator and the polyhalogen compound of the invention are preferably used as a solid dispersion, and a preferable producing method of such solid dispersion is described in JP-A No. 2002-55405.

3. Explanation on Layer Configuration and Other Constituent Components

The photothermographic material of the invention may have a non-photosensitive layer in addition to the image forming layer. The non-photosensitive layer can be classified, based on a position thereof, into (a) a surface protective layer provided on the image forming layer (namely farther from the substrate), (b) an intermediate layer provided between plural image forming layers or between an image forming layer and a protective layer, (c) an undercoat layer formed between an image forming layer and the substrate, and (d) a back layer formed at a side opposite to the image forming layer.

There may also be provided a layer functioning as an optical filter, which is formed as a layer (a) or (b). Also an antihalation layer is provided as a layer (c) or (d) in the photosensitive material.

1) Surface Protective Layer

The photothermographic material of the invention may have a surface protective layer, for example for preventing sticking of the image forming layer. The surface protective layer may be formed by a single layer or by plural layers. The surface protective layer is described in JP-A No. 11-65021, paragraphs 0119-0120, and Japanese Patent Application No. 2000-171936.

As a binder for the surface protective layer, any polymer may be utilized. Examples of the binder include polyester, gelatin, polyvinyl alcohol and a cellulose derivative, but a cellulose derivative is preferred. Examples of the cellulose derivative are shown in the following, but such examples are not restrictive. Examples of the cellulose derivative include cellulose acetate, cellulose acetate butyrate, cellulose propionate, hydroxypropyl cellulose, hydroxypropylmethyl cellulose, methyl cellulose, hydroxyethyl cellulose, carboxymethyl cellulose and a mixture thereof. The surface protective layer preferably has a thickness of 1 to 10 μm, particularly preferably 1 to 5 μm.

In the surface protective layer, any sticking preventing material may be used. Examples of the sticking preventing material include wax, liquid paraffin, silica particles, styrene-containing elastomeric block copolymer (such as styrene-butadiene-styrene or styrene-isoprene-styrene), cellulose acetate, cellulose acetate butyrate, cellulose propionate and a mixture thereof.

In the surface protective layer, a lubricant such as liquid paraffin or an aliphatic ester is preferably employed. The lubricant is used in an amount within a range of 1 to 200 mg/m², preferably 10 to 150 mg/m² and more preferably 20 to 100 mg/m².

2) Antihalation Layer

In the photothermographic material of the invention, an antihalation layer may be provided at a side farther than the photosensitive layer from the exposure light source. The antihalation layer is described in JP-A No. 11-65021, paragraphs 0123-0124, JP-A Nos. 11-223898, 9-230531, 10-36695, 10-104779, 11-231457, 11-352625 and 11-352626.

The antihalation layer includes an antihalation dye having an absorption in the exposing wavelength. In the case the exposure wavelength is in an infrared region, an infrared-absorbing dye may be employed, and, in such case, there is preferred a dye which has no absorption in the visible region.

In the case of executing antihalation with a dye having an absorption in the visible region, it is preferable that the color of the dye does not substantially remain after the image formation. It is preferable to employ means for eliminating color by the heat at the thermal development, and particularly preferable to add a thermally color-removable dye and a base precursor in the non-photosensitive layer thereby achieving a function as an antihalation layer. Such technology is described for example in JP-A No. 11-231457.

An amount of addition of the color-removable dye is determined according to the purpose of the dye. In general it is used in such an amount that the optical density (absorbance) measured at an object wavelength is higher than 0.1. The optical density is preferably within a range from 0.2 to 2. An amount of the dye used for obtaining such optical density is generally within a range of about 0.001 to 1 g/m².

By removing the color of the dye in such manner, it is possible to reduce the optical density after thermal development to 0.1 or less. It is also possible to use two or more color-removable dyes in combination, in a thermally color-removable recording material or in a photothermographic material. Similarly, it is possible to use two or more base precursors in combination.

In such thermal color removal utilizing a color-removable dye and a base precursor, it is preferable, for the thermal color-removing property, to use in combination a substance (such as diphenylsulfon, or 4-chlorophenyl(phenyl)sulfon) that can lower the melting point by 3° C. or more when mixed with the base precursor, as described in JP-A No. 11-352626.

3) Back Layer

A back layer that can be employed in the invention is described in JP-A No. 11-65021, paragraphs 0128-0130.

As a binder for the back layer, there is utilized a natural polymer, a synthetic resin, a polymer, a copolymer or another film-forming medium that is transparent or semi-transparent and generally colorless, for example gelatin, gum Arabic, poly(vinyl alcohol), hydroxyethyl cellulose, cellulose acetate, cellulose acetate butyrate, poly(vinylpyrrolidone), casein, starch, poly(acrylic acid), poly(methylmethacrylic acid), poly(vinyl chloride), poly(methacrylic acid), copoly(styrene-maleic anhydride), copoly(styrene-acrylonitrile), copoly(styrene-butadiene), poly(vinylacetal) (such as poly(vinylformal) or poly(vinylbutyral)), poly(ester), poly(urethane), a phenoxy resin, poly(vinylidene chloride), poly(epoxide), poly(carbonate), poly(vinyl acetate), a cellulose ester, or poly(amide). The binder may be formed into a coating from water, an organic solvent or an emulsion.

In the invention, a coloring agent having an absorption maximum at 300 to 450 nm may be added in order to improve a color tone of silver image and a time-dependent change of the image. Such coloring agent is described for example in JP-A Nos. 62-210458, 63-104046, 63-103235, 63-208846, 63-306436, 63-314535, 01-61745 and 2001-100363. Such coloring agent is added usually within a range of 0.1 mg/m² to 1 g/m², and preferably added in a back layer formed at an opposite side of the photosensitive layer.

4) Antistatic Layer

In the invention, an antistatic layer including a metal oxide or a conductive polymer, of various kinds known in the art, may be provided. The antistatic layer may be formed as the undercoat layer, the back layer or the surface protective layer, or may be formed separately. The antistatic layer may be based on technologies described in JP-A No. 11-65021, paragraph 0135, JP-A Nos. 56-143430, 56-143431, 58-62646, 56-120519, and 11-84573, paragraphs 0040-0051, U.S. Pat. No. 5,575,957 and JP-A No. 11-223898, paragraphs 0078-0084.

5) Additives

5-1) Matting Agent

In the invention, it is preferable to add a matting agent for improving transporting property. The matting agent is described in JP-A No. 11-65021, paragraphs 0126-0127. An amount of the matting agent, in a coating amount per 1 m² of the photosensitive material, is preferably 1 to 400 mg/m², more preferably 5 to 300 mg/m².

In the invention, the matting agent may have a fixed shape or an amorphous shape, however it is preferably of a fixed shape, and a spherical shape is employed preferably.

The matting agent to be used in the emulsion surface preferably has a sphere-corresponding diameter, in a volume-weighted average, of 0.3 to 10 μm, further preferably 0.5 to 7 μm. Also a fluctuation factor of the size distribution of the matting agent is preferably 5 to 80%, more preferably 20 to 80%. The fluctuation factor is represented by (standard deviation of particle size)/(average of particle size)×100. It is also possible to use, in combination, two or more matting agents having different average particle sizes. In such case, a matting agent with a largest average particle size and a matting agent with a smallest average particle size preferably have a difference in the particle size of 2 to 8 μm, more preferably 2 to 6 μm.

The matting agent to be used in the back side preferably has a sphere-corresponding diameter, in a volume-weighted average, of 1 to 15 μm, further preferably 3 to 10 μm. Also a fluctuation factor of the size distribution of the matting agent is preferably 3 to 50%, more preferably 5 to 30%. For the matting agent of the back side, it is also possible to use, in combination, two or more matting agents having different average particle sizes. In such case, a matting agent with a largest average particle size and a matting agent with a smallest average particle size preferably have a difference in the particle size of 2 to 14 μm, more preferably 2 to 9 μm.

A matting degree of an emulsion surface may be arbitrarily selected within an extent that so-called stardust failure dose not occur, but is preferably within a range of Beck's smoothness of 30 to 2000 seconds, particularly preferably 40 to 1500 seconds. The Beck's smoothness can be easily determined according to the known smoothness testing method with Beck's tester for paper and board and TAPPI standard method T479.

In the invention, a matting degree of the back layer is preferably within a range of Beck's smoothness of 1200 to 10 seconds, more preferably 800 to 20 seconds and further preferably 500 to 40 seconds.

In the invention, the matting agent is preferably included in an outermost surface layer of the photosensitive material, a layer functioning as an outermost surface layer, or a layer close to the external surface, or it is preferably included in a layer functioning as a protective layer.

5-2) Film Hardening Agent

A film hardening agent may be used in the photosensitive layer, the protective layer, or the back layer of the invention.

Examples of the film hardening agent are described in T. H. James, “The Theory of the Photographic Process Fourth Edition” (Macmillan Publishing Co. Inc., 1977) pp77-87, and there can be preferably employed chromium alum, sodium 2,4-dichloro-6-hydroxy-s-triazine, N,N-ethylenebis(vinylsulfonacetamide), N,N-propylenebis(vinylsulfonacetamide), a polyvalent metal ion described in p. 78 of the aforementioned reference, a polyisocyanate described in U.S. Pat. No. 4,281,060, JP-A No. 6-208193, etc., an epoxy compound described in U.S. Pat. No. 4,791,042, etc. and a vinylsulfone compound described in JP-A No. 62-89048, etc. A vinylsulfone compound is particularly preferable, and a vinylsulfone compound made resistant to diffusion is further preferable.

The film hardening agent is added as a solution, and a timing of addition of such solution to the coating liquid for the protective layer is within a period from 180 minutes before the coating operation to a time immediately before the coating operation, preferably within a period from 60 minutes before the coating operation to 10 seconds before the coating operation, but a mixing method and a mixing condition are not particularly restricted as long as the effect of the invention can be sufficiently exhibited.

Specific examples of the mixing method include a mixing method in a tank for obtaining a desired average stay time based on a flow rate of addition and a liquid supply rate to a coater, and a method of utilizing a static mixer, as described in N. Harnby, M. F. Edwards, A. W. Nienow, “Liquid Mixing Technologies” (translated by Koji Takahashi, Nikkan Kogyo Shimbunsha, 1989), chapter 8.

5-3) Other Additives

In the photothermographic material, there may be further added an antioxidant, a stabilizer, a plasticizer, an ultraviolet absorber or an auxiliary coating agent in the respective layers. It is also possible to add a solvent described in JP-A No. 11-65021, paragraph No. 0133. These additives are added either in the photosensitive layer or in the non-photosensitive layer. For these, reference may be made for example to WO No. 98/36322, EP No. 803764A1, JP-A Nos. 10-186567 and 10-18568.

6) Film Surface pH

The photothermographic material of the invention preferably has a film surface pH of 7.0 or less before the thermal development, more preferably 6.6 or less. The lower limit of the film surface pH is not particularly restricted but is generally about 3. A most preferred pH range is from 4 to 6.2.

For regulating the film surface pH, there is preferably employed an organic acid such as a phthalic acid derivative, a non-volatile acid such as sulfuric acid, or a volatile base such as ammonia, in view of lowering the film surface pH. In particular, ammonia is preferable for attaining a low film surface pH, as it is easily volatile and can be removed in the coating step or before the thermal development.

It is also preferable to employ a non-volatile base such as sodium hydroxide, potassium hydroxide or lithium hydroxide in combination with ammonia. A measuring method for the film surface pH is described in Japanese Patent Application No. 11-87297, paragraph 0123.

7) Substrate

Examples of a substrate include a polyester film, an undercoated polyester film, a poly(ethylene terephthalate) film, a polyethylene naphthalate film, a cellulose nitrate film, a cellulose ester film, a poly(vinyl acetal) film, a polycarbonate film, a related or resinous material, glass, paper, a metal, etc. It is also possible to employ a flexible substrate, particularly a paper substrate which is partially acetylated or coated with baryta and/or an α-olefin polymer, particularly a polymer of an α-olefin with 2 to 10 carbon atoms such as polyethylene, polypropylene or an ethylene-butene copolymer. The substrate can be transparent or opaque, but is preferably transparent.

For the substrate, there is preferably employed a polyester, particularly polyethylene terephthalate, subjected to a heat treatment in a temperature range of 130 to 185° C. in order to relax an internal strain remaining in the film at a biaxial drawing thereby eliminating a thermal shrinking strain generated at the thermal development.

In a photothermographic material for medical use, the transparent substrate may be colored with a blue dye (for example a dye 1 described in examples of JP-A No. 8-240877), or may be colorless. Specific examples of the substrate are described in JP-A No. 11-65021, paragraph 0134.

For the substrate, there is preferably applied an undercoating process for example with a water-soluble polyester described in JP-A No. 11-84574, a styrene-butadiene copolymer described in JP-A No. 10-186565, or a vinylidene chloride copolymer described in JP-A No. 2000-39684 and Japanese Patent Application No. 11-106881, paragraphs 0063-0080.

8) Coating Method

The photothermographic material of the invention may be coated by any coating method. More specifically, various coating methods are applicable, including extrusion coating, slide coating, curtain coating, dip coating, knife coating, flow coating and extrusion coating utilizing a hopper of a kind described in U.S. Pat. No. 2,681,294, and there is preferably employed extrusion coating described in Stephen F. Kistler and Petert M. Schweizer, “Liquid Film Coating” (Chapman & Hall, 1997), pp.399-536, or slide coating, and particularly preferably extrusion coating.

9) Other Applicable Technologies

In the photothermographic material of the invention, other technologies are also applicable, such as those described in EP No. 803764A1, EP No. 883022A1, WO No. 98/36322, JP-A Nos. 56-62648, 58-62644, 9-43766, 9-281637, 9-297367, 9-304869, 9-311405, 9-329865, 10-10669, 10-62899, 10-69023, 10-186568, 10-90823, 10-171063, 10-186565, 10-186567, 10-186569 to 10-186572, 10-197974, 10-197982, 10-197983, 10-197985 to 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099, 11-343420, 2001-200414, 2001-234635, 2002-020699, 2001-275471, 2001-275461, 2000-313204, 2001-292844, 2000-324888, 2001-293864, 2001-348546, and 2000-187298.

10) Color Image Formation

In a multi-color photothermographic material, a combination of these two layers may be included for each color, or all the components may be included in a single layer as described in U.S. Pat. No. 4,708,928.

In a multi-color photothermographic material, the emulsion layers are maintained in a mutually separated manner, as described in U.S. Pat. No. 4,460,681, by employing a functional or non-functional barrier layer between the photosensitive layers.

4. Image Forming Method

1) Exposure

There is utilized an He—Ne laser emitting red to infrared light, a semiconductor laser emitting red light, an Ar⁺, He—Ne or He—Cd laser emitting blue to green light, or a semiconductor laser emitting blue light. A semiconductor laser emitting red to infrared light is preferable, and a peak wavelength of the laser light is 600 to 900 nm, preferably 620 to 850 nm.

On the other hand, a laser output apparatus of a short wavelength region is recently attracting particular attention, with the development of an integrated module of a second harmonic generator (SHG) element and a semiconductor laser, and of a blue light-emitting semiconductor laser. Demand for the blue light-emitting semiconductor laser is anticipated to increase in the future, since such laser is capable of recording a high-definition image, achieving an increase in the recording density and providing a stable output with a long service life. A peak wavelength of the blue laser light is 300 to 500 nm, preferably 400 to 500 nm.

A laser light oscillated in a longitudinal multi mode for example by a high frequency superposing method can also be employed advantageously.

2) Thermal Development

The photothermographic material of the invention may be developed in any method, but the development is usually executed by elevating the temperature of the photothermographic material which has been exposed imagewise. A developing temperature is 80 to 250° C., preferably 100 to 140° C., and more preferably 110 to 130° C. A developing time is preferably 1 to 60 seconds, more preferably 3 to 30 seconds and further preferably 5 to 25 seconds, particularly preferably 3 to 13 seconds.

For thermal development, a drum heater or a plate heater can be employed, however a plate heater method is preferable. For thermal development with a plate heater method, a method described in JP-A No. 11-133572 is preferable, employing a thermal development apparatus which brings a photothermographic material containing a latent image in contact with heating means in a thermal development unit thereby obtaining a visible image, wherein the heating means is constituted of a plate heater, while plural pressing rollers are positioned along a surface of the plate heater, and the photothermographic material is passed between the pressing rollers and the plate heater to execute thermal development. It is preferable to divide the plate heater into 2 to 6 stages and to lower the temperature by 1 to 10° C. in an entrance end stage. An example utilizes four sets of plate heaters which can be independently temperature controlled and which are respectively controlled at 112, 119, 121 and 120° C. Such method, described also in JP-A No. 54-30032, allows to eliminate moisture or organic solvent, contained in the photothermographic material, from the system, and to suppress a change in the shape of the substrate of the photothermographic material, resulting from a rapid heating thereof.

For downsizing the thermal developing apparatus and reducing the thermal developing time, a stabler heater control is preferable, and it is also preferable to execute an exposure from a leading end of a photosensitive sheet and to initiate the thermal development before the exposure reaches a trailing end. An imager capable of rapid process preferable for the invention is described for example in JP-A Nos. 2002-289804 and 2002-287668. Such imager allows to execute a thermal development in 14 seconds with 3-stage plate heaters controlled at 107° C.-121° C.-121° C., and to shorten an output time of a first sheet to about 60 seconds.

3) System

An example of a laser imager system for medical use, having an exposure unit and a thermal development unit, is Fuji Medical Dry Imager FM-DPL and DRYPIX 7000. The FM-DPL is described in Fuji Medical Review No. 8, p. 39-55, and such described technology is naturally applicable to a laser imager of the photothermographic material of the invention. Also it can be utilized as a photothermographic material for a laser imager in an AD Network, proposed by Fujifilm Medical Co. as a network system meeting the DICOM standard.

5. Application of the Invention

The photothermographic material of the invention forms a black-and-white image by a silver image, and is preferably utilized as a photothermographic material for medical diagnosis, a photothermographic material for industrial photography, a photothermographic material for printing and a photothermographic material for COM.

### EXAMPLES

In the following, the present invention will be further clarified by examples thereof, but the invention is not limited by such examples.

### Example 1

1. Preparation of PET Substrate and Undercoating

1-1. Film Formation

Terephthalic acid and ethylene glycol were employed in an ordinary method to obtain a PET of an intrinsic viscosity IV=0.66 (measured at 25° C. in phenol/tetrachloroethane=6/4 (weight ratio)). It was pelletized, then dried for 4 hours at 130° C., fused at 300° C., and a dye BB of the following structure was blended by 0.04 mass %. Then it was extruded from a T-die and cooled rapidly to obtain an undrawn film of such a thickness as to provide a film thickness of 175 μm after thermal fixation.

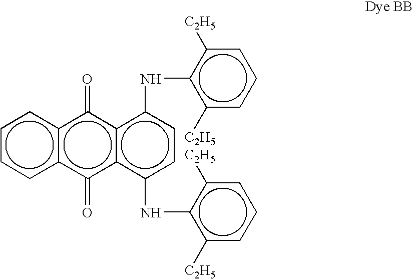

The film was then subjected to a drawing of 3.3 times in a longitudinal direction with rollers of different peripheral speeds, and a drawing of 4.5 times in a transversal direction with a tenter. The temperatures were 110° C. and 130° C., respectively. Then, after a thermal fixation for 20 seconds at 240° C., a relaxation of 4% in the transversal direction was executed at a same temperature. Then, after portions chucked by the tenter were slit off, a knurling was applied to both sides, and the film was wound under a tension of 4 kg/cm² to obtain a roll of a film of a thickness of 175 μm.

1-2. Surface Treatment with Corona Discharge

A solid-state corona discharge treating apparatus model 6KVA, manufactured by Pillar Inc., was employed to treat both sides of the substrate at a speed of 20 m/min at the room temperature. Based on current and voltage values read in this operation, it was identified that the substrate was treated under a condition of 0.375 kV˜A·min/m². In this treatment, a frequency was 9.6 kHz and a clearance between an electrode and a dielectric roll was 1.6 mm.

2. Preparation and Coating of Back Layer Coating Liquid

In 830 g of MEK under agitation, 84.2 g of cellulose acetate butyrate (trade name: CAB381-20, manufactured by Eastman Chemical Co.) and 4.5 g of polyester resin (trade name: Vitel PE2200B, manufactured by Bostic Inc.) were added and dissolved. In thus obtained solution, 0.30 g of a dye-1 was added, and 4.5 g of a fluorinated surfactant (trade name: Surflon KH40, manufactured by Asahi Glass Co.) and 2.3 g of a fluorinated surfactant (trade name: Megafac F120K, manufactured by Dai-Nippon Ink and Industry Inc.), dissolved in 43.2 g of methanol, were added and sufficiently agitated until dissolution. Finally, 75 g of silica (trade name: Silloid 64×6000, manufactured by W. R. Grace Co.), dispersed by a dissolver-type homogenizer at a concentration of 1 mass % in methyl ethyl ketone, was added and agitated to obtain a coating liquid for the back side.

Thus prepared coating liquid for the protective layer on the back side was coated with an extrusion coater and dried on the substrate, so as to obtain a dry film thickness of 3.5 μm. The drying was conducted for 5 minutes with drying air of a drying temperature of 100° C. and a dew point temperature of 10° C.

3. Image Forming Layer and Surface Protective Layer

1) Silver Halide Emulsion

Preparation of Silver Halide Emulsion-1

While a first solution, obtained by dissolving 30 g of phthalated gelatin and 71.4 mg of KBr in 1500 ml of deionized water and adjusted to pH 5.0 with 3 mol/L nitric acid, is maintained at 34° C., a solution obtained by dissolving 27.4 g of KBr and 3.3 g of KI in 275 ml of deionized water and a solution obtained by dissolving 42.5 g of silver nitrate in 364 ml of deionized water were simultaneously added over 9.5 minutes, and then a solution obtained by dissolving 179 g of KBr and 10 mg of dipotassium hexachloroiridate in 812 ml of deionized water and a solution obtained by dissolving 127 g of silver nitrate in 1090 ml of deionized water were simultaneously added over 28.5 minutes. A pAg value was maintained constant by a pAg feedback control loop described in Research Disclosure No. 17643 and U.S. Pat. Nos. 3,415,650, 3,782,954 and 3,821,002. An emulsion thus obtained was washed with water and desalted. An average particle size, measured with a transmission electron microscope (TEM), was 0.045 μm.

The obtained core/shell type silver iodobromide emulsion had an iodine content of 8 mol. % in the core and 0 mol. % in the shell, a total iodine content of 0 mol. %, and contained iridium by 2.1×10⁻⁵ moles per 1 mole of silver halide.

2) Preparation of Silver Halide/Organic Silver Salt Dispersion

Preparation of Silver Halide/Organic Silver Salt Dispersion-1

688 g of fatty acids containing 55 mol. % of behenic acid, 28 mol. % of arachidic acid and 17 mol. % of stearic acid were dissolved at 80° C. in 13 L of water, and, after mixing for 15 minutes, a solution obtained by dissolving 89.18 g of NaOH in 1.5 L of water of 80° C. was added and mixed for 5 minutes to obtain a dispersion. At 80° C., this dispersion was added with a solution obtained by diluting 19 ml of concentrated nitric acid with 50 ml of water, then cooled to 55° C., agitated for 25 minutes and maintained at 55° C. Then a diluted emulsion, obtained by dissolving 700 g (containing 1 mole of silver halide) of the aforementioned iridium-doped silver halide emulsion in 1.25 L of water at 42° C., was added, by an amount corresponding to 0.1 moles of silver halide, to the dispersion and mixed for 5 minutes. Then 336.5 g of silver nitrate was dissolved in 2.5 L of water and added over 10 minutes at 55° C. Subsequently, the obtained organic silver salt dispersion was transferred to a washing container, was added with and agitated with deionized water, and was let to stand still for separating the organic silver salt dispersion by floating, whereupon water-soluble salts in the lower part was eliminated. Thereafter, washing with deionized water and dehydration were repeated until the conductivity of the discharged water reached 2 μS/cm, and, after dehydration by centrifuging, drying was executed by a circulating dryer with warm air of an oxygen partial pressure of 10 vol. % at 45° C. until a weight loss was no longer observed.

Preparation of Silver Halide/Organic Silver Salt Dispersions-2 to -5

A silver halide/organic silver salt dispersion-2 was prepared in the same manner as the silver halide/organic silver salt dispersion-1 except that the fatty acids employed therein were changed to those of a composition of 45 mol. % of behenic acid, 33 mol. % of arachidic acid and 22 mol. % of stearic acid.

Also silver halide/organic silver salt dispersions-3 to -5 were prepared similarly with modifications of the fatty acids as shown in Table 2.

TABLE 2

| silver halide/organic silver | | | |
|---|---|---|---|
| salt dispersion | behenic acid | arachidic acid | stearic acid |
| 1 | 55 | 28 | 17 |
| 2 | 45 | 33 | 22 |
| 3 | 75 | 20 | 5 |
| 4 | 85 | 12 | 3 |
| 5 | 98 | 2 | 0 |

3) Re-Dispersion of Organic Silver Salt Containing Photosensitive Silver Halide into Organic Solvent

209 g of the aforementioned powdered organic silver salt and 11 g of polyvinyl butyral powder (trade name: Butvar B-79, manufactured by Monsant Co.) were dissolved in 780 g of methyl ethyl ketone (MEK), then agitated in a dissolver (trade name: DISPERMAT CA-40M, manufactured by VMA-GETZMANN Co.) and was let to stand overnight at 7° C. to obtain a slurry.

This slurry was subjected to 2-pass dispersions in a pressurized homogenizer GM-2, manufactured by SMT Co., to prepare an organic silver salt dispersion containing photosensitive emulsion. In this operation, a process pressure in one pass was 6000 psi.

4) Preparation of Coating Liquid for Image Forming Layer Preparation of Image Forming Layer Coating Liquid-1

50 g of the aforementioned organic silver salt dispersion was added with 15.1 g of MEK, then maintained at 21° C. under agitation at 1000 rpm in a dissolver-type homogenizer, further added with 390 μl of a 10 mass % methanol solution of an associate material of 2 molecules of N,N-dimethylacetamide/1 molecule of hydrobromic acid/1 molecule of bromine, and agitated for 30 minutes. Then 494 μl of a 10 mass % methanol solution of calcium bromide was added and agitation was executed for 20 minutes.

Then 167 mg of a methanol solution containing 15.9 mass % of dibenzo-18-crown-6 and 4.9 mass % of potassium acetate were added, and agitation was executed for 10 minutes. Then 18.3 mass % of 2-chlorobenzoic acid, 34.2 mass % of salicylic acid-p-toluenesulfonate and 2.6 g of sensitizing dye-1 (0.24 mass % MEK solution) were added and agitation was conducted for 1 hour. Then the temperature was lowered to 13° C. and agitation was conducted further for 30 minutes. Then, while the temperature was maintained at 13° C., 13.31 g of polyvinylbutyral (trade name: Butvar B-79, manufactured by Monsant Co.) was added, followed by agitation for 30 minutes, then 1.08 g of a 9.4 mass % solution of tetrachlorophthalic acid was added and agitation was conducted for 15 minutes. Under continued agitation, the reducing agent-1 was added by 0.4 moles per 1 mole of silver.

12.4 g of a 1.1 mass % MEK solution of 4-methylphthalic acid and dye-1 were added, then 1.5 g of 10 mass % of aliphatic isocyanate (trade name: Desmodur N3300, manufactured by Mobey Co.) was added in succession, and 13.7 g of a 7.4 mass % MEK solution of polyhalogen compound-1 and 4.27 g of a 7.2 mass % MEK solution of phthalazine were added to obtain an image forming layer coating liquid-1.

Preparation of Image Forming Layer Coating Liquids-2 to -23

Image forming layer coating liquids-2 to -23 were prepared in the same manner as in the image forming layer coating liquid-1 except that polyvinyl butyral (trade name: Butvar B-79, manufactured by Monsant Co.) used therein was replaced with binders shown in Table 3, the reducing agent-1 was replaced with reducing agents shown in Table 3, and the silver halide/organic silver salt dispersion-1 was replaced with any one of silver halide/organic silver salt dispersions-2 to -5.

In these preparations, the organic silver salt dispersion was prepared in such a manner that the binder employed in the image forming layer coating liquid is the same as the binder employed in the organic silver salt dispersion.

5) Preparation of Surface Protective Layer Coating Liquid

In 865 g of MEK, 96 g of cellulose acetate butyrate (trade name: CAB171-15, manufactured by Eastman Chemical Co.), 4.5 g of polymethylmethacrylic acid (Paraloid A-21, manufactured by Rohm & Haas Co.), 1.5 g of 1,3-di(vinylsulfonyl)-2-propanol, 1.0 g of benzotriazole and 1.0 g of a fluorinated surfactant (trade name: Surflon KH40, manufactured by Asahi Glass Co.) were dissolved under agitation, and 30 g of a dispersion, obtained by dispersing 13.6 mass % of cellulose acetate butyrate (trade name: CAB171-15, manufactured by Eastman Chemical Co.) and 9 mass % of calcium carbonate (trade name: Super-Pflex 200, manufactured by Speciality Minerals Inc.) in MEK by a dissolver-type homogenizer for 30 minutes at 8000 rpm, were added and agitated to obtain a surface protective layer coating liquid.

4. Preparation of Photothermographic Material

Any one of the image forming layer coating liquids-1 to -18, prepared as explained above, and the surface protective layer coating liquid were subjected to a simultaneous superposed coating by a dual-knife coater, on a side opposite to the back side of the substrate coated with the back layer. The coating was executed in such a manner that the image forming layer had a silver coating amount of 1.8 g/m² and the surface protective layer had a dry film thickness of 3.4 μm. The coating apparatus was constituted of two coating knife blades positioned in parallel. The substrate was cut into a length matching the volumes of the used liquids, and then placed on a coater bed after the hinged knives were lifted. Then the knives were lowered and fixed at predetermined positions. The height of each knife was regulated with a wedge of which position was controlled by a screw knob and measured by an ammeter. A knife #1 was elevated to a gap corresponding to a total thickness equal to a sum of the thickness of the substrate and a desired wet thickness of the image forming layer (layer #1). Also a knife #2 was elevated to a height corresponding to a total thickness equal to a sum of the thickness of the substrate+the wet thickness of the image forming layer (layer #1)+a desired thickness of the surface protective layer (layer #2).

Photothermographic materials-1 to -23 were completed by drying for 5 minutes at 75° C., and by post-heating under drying conditions as shown in Table 3.

In the following, there are shown chemical structures of compounds employed in the examples of the invention. 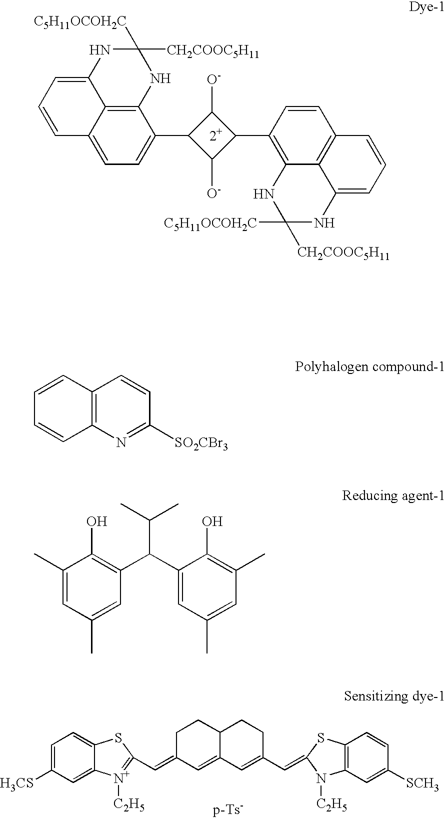
5. Evaluation of Photographic Performance Preparation

An obtained sample was cut into a folio size (43 cm in length by 35 cm in width), then promptly packed in the following packaging material in an environment of 25° C. and 50% RH, and stored for 2 weeks at a normal temperature.

Packaging Material

A sheet of PET 10 μm/PE 12μm/aluminum foil 9 μm/nylon 15 μm/polyethylene 50 μm containing 3 mass % of carbon;
oxygen permeation rate: 0.02 ml/atm·m²·25° C.·day, moisture permeation rate: 0.10 g/atm·m²·25° C.·day.
   Exposure and Development of Photosensitive Material

An exposure apparatus was prepared employing, as an exposure light source, a semiconductor laser of high-frequency superposed longitudinal multi mode with a wavelength of 800 to 820 nm, and each of the prepared samples Nos. 1-20 was exposed by laser scanning in the aforementioned exposure apparatus from the side of the image forming layer. In this operation, an image was recorded with an incident angle of 75° of the scanning laser beam entering an exposed surface of the photosensitive material. Then a thermal development was executed for 13 seconds at 124° C. in an automatic development equipment provided with a heat drum, in such a manner that the protective layer at the side of the image forming layer of the photosensitive material was in contact with the drum surface, and an obtained image was evaluated with a densitometer.

Measurement of Humidity in Bag

The humidity in the bag was determined by forming a small hole in a part of the bag packaging the photosensitive material, sealing the hole after promptly inserting a detector therein, and measuring a relative humidity after storing for 3 hours or longer in an environment of 25° C.

Measurement of Water Content of Photothermographic Materials-1 to -23

The water content of the photosensitive material was measured in the following manner.

The packaging material was opened in an environment of 25° C. and a relative humidity same as that in the bag. The photosensitive material promptly taken out was cut into a size of 5×26 cm, then, after a mass measurement, was cut into small pieces and heated at 120° C., and an evaporated water amount was measured by Karl-Fischer method. The measurement was executed with a Karl-Fischer moisture meter (trade name: MKA-510N, manufactured by Kyoto Denshi Co.).

Evaluation of Maximum Developed Color Density

A photosensitive material, packaged in the aforementioned packaging material and stored for 2 weeks at 25° C., was subjected, immediately after opening the package, to an exposure and a thermal development as explained before and a maximum developed color density (Dmax) was measured with a Macbeth TD904 densitometer (visible density). The obtained values are represented by relative values, taking the sample 1 as 100.

Evaluation of Storage Stability

A photosensitive material, packaged in the aforementioned packaging material and stored for 2 weeks at 25° C., was subjected, immediately after opening the package, to an exposure and a thermal development as explained before and a color tone of a portion having a density of 1.0 was measured with a calorimeter (trade name: Spectrolino, manufactured by Gretag-Macbeth Inc.), utilizing a fluorescent lamp F6 as a light source, to determine a coordinate value A(L*_{A}, a*_{A}, b*_{A}) on a CIELAB space. Also a sample, packaged in the aforementioned packaging sample and stored for 1 month under an environment of 32° C. and 70% RH, was subjected to an exposure and a thermal development as explained above and a coordinate value B (L*_{B}, a*_{B}, b*_{B}) of a color tone was determined in a portion of an exposure amount same as in A. A color difference ΔE was determined from L*a*b* values of A and B, thus evaluating a color change when the photosensitive material was stored.
ΔE was calculated by the following calculation formula:
   ΔE={(ΔL*)²+(Δa*)²+(Δb*)^{1/2}
   wherein ΔL*=L*_{A}-L*_{B}, Δa*=a*_{A}-a*_{B}, Δb*=b*_{A}-b*_{B}.

Results of evaluation are shown in Table 3.

TABLE 3

| | | | Behenic acid | | Drying condition | In-bag | Photosensitive | | | |
|---|---|---|---|---|---|---|---|---|---|---|
| Sample | Binder | | content | Reducing | (post heating | humidity | material water | Storage stability | | |
| No. | Type | Tg(° C.) | (mol. %) | agent | condition) | (% RH) | content (mass %) | ΔE | ΔDmax | Remarks |
| 1 | comp-1 | 65 | 55 | red.agent-1 | 90° C., 2 min. | 40 | 1.3 | 0.5 | 100 | invention |
| 2 | comp-1 | 65 | 70 | red.agent-1 | 90° C., 2 min. | 32 | 0.9 | 0.3 | 99 | invention |
| 3 | comp-1 | 65 | 85 | red.agent-1 | 90° C., 2 min. | 35 | 1.0 | 0.2 | 100 | invention |
| 4 | comp-1 | 65 | 98 | red.agent-1 | 90° C., 2 min. | 30 | 0.3 | 0.2 | 100 | invention |
| 5 | comp-1 | 65 | 45 | red.agent-1 | 90° C., 2 min. | 35 | 1.1 | 2.8 | 102 | comp. ex. |
| 6 | comp-1 | 65 | 55 | red.agent-1 | none | 55 | 3.3 | 3.9 | 99 | comp. ex. |
| 7 | comp-1 | 65 | 45 | red.agent-1 | none | 58 | 4.5 | 4.0 | 99 | comp. ex. |
| 8 | comp-2 | 131 | 45 | red.agent-1 | 90° C., 2 min. | 42 | 1.5 | 0.7 | 78 | comp. ex. |
| 9 | P-2 | 75 | 45 | red.agent-1 | 90° C., 1 min. | 39 | 1.1 | 0.3 | 100 | invention |
| 10 | P-5 | 88 | 45 | red.agent-1 | 90° C., 1 min. | 35 | 1.0 | 0.2 | 101 | invention |
| 11 | P-6 | 104 | 45 | red.agent-1 | none | 32 | 0.9 | 0.2 | 99 | invention |
| 12 | comp-1 | 65 | 45 | R-5 | 90° C., 2 min. | 39 | 1.2 | 0.4 | 101 | invention |
| 13 | comp-1 | 65 | 45 | R-4 | 90° C., 2 min. | 35 | 1.0 | 0.3 | 102 | invention |
| 14 | comp-1 | 65 | 45 | R-6 | 90° C., 2 min. | 38 | 1.2 | 0.5 | 100 | invention |
| 15 | comp-1 | 65 | 45 | R-9 | 90° C., 2 min. | 35 | 1.0 | 0.4 | 102 | invention |
| 16 | comp-1 | 65 | 45 | R-10 | 90° C., 2 min. | 35 | 0.9 | 0.3 | 102 | invention |
| 17 | comp-1 | 65 | 45 | R-12 | 90° C., 2 min. | 34 | 0.9 | 0.2 | 100 | invention |
| 18 | P-2 | 75 | 55 | R-5 | 90° C., 1 min. | 39 | 1.2 | 0.2 | 104 | invention |
| 19 | P-5 | 88 | 55 | R-5 | 90° C., 1 min. | 40 | 1.2 | 0.3 | 105 | invention |
| 20 | P-6 | 104 | 55 | R-5 | 90° C., 1 min. | 42 | 1.3 | 0.3 | 103 | invention |
| 21 | P-5 | 88 | 55 | R-4 | 90° C., 1 min. | 38 | 1.0 | 0.3 | 102 | invention |
| 22 | P-5 | 88 | 55 | R-6 | 90° C., 1 min. | 35 | 0.9 | 0.2 | 103 | invention |
| 23 | P-5 | 88 | 55 | R-9 | 90° C., 1 min. | 37 | 0.9 | 0.4 | 104 | invention |

As shown in Table 3, a photothermographig material of a satisfactory storability could be obtained when the humidity at 25° C. in the bag was 50% RH or less and in the case at least one is satisfied among conditions that (1) the binder had a glass transition temperature from 70 to 110° C., (2) the reducing agent was a compound represented by the following Formula (R), and (3) the organic silver salt had a silver behenate content of 50 mol. % or more. Particularly satisfactory results were obtained in the samples 18 to 23, which had a water content of 3 mass % or less and met all the conditions (1) to (3).

### Example 2

Image forming layer coating liquids-201 to -223 were prepared in the same manner as the image forming layer coating liquids-1 to -23, except that the sensitizing dye-1 therein was replaced with a sensitizing dye-2. The image forming layer coating liquids-201 to -223 were subjected to coating, drying, development, etc. in the same manner as in Example 1 to prepare photothermographic materials-201 to -223. 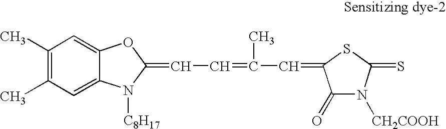
Exposure and Development of Photosensitive Material

The photothermographic materials-201 to -220 thus prepared were subjected, in a Fuji Medical dry laser imager FM-DPL (trade name) incorporating a 660 nm semiconductor laser of a maximum output of 60 mW (IIIB), to an exposure and a thermal development (24 seconds in total with 4 panels set at 112° C.-119° C.-121° C.-121° C.).

Evaluation of Photographic Performance and Result

Performance was evaluated in the same manner as in Example 1.

Also in the present case where the sensitizing dye was changed to the sensitizing dye-2 for a red laser and the exposure was made with a red laser, a photothermographic material of a high Dmax and a satisfactory storability could be obtained when the humidity at 25° C. in the bag was 50% RH or less and in the case at least one is satisfied among conditions that (1) the binder had a glass transition temperature from 70 to 110° C., (2) the reducing agent was a compound represented by Formula (B), and (3) the organic silver salt had a silver behenate content of 50 mol. % or more.

### Example 3

1) Preparation of Image Forming Layer Coating Liquid Preparation of Coating Liquid for Sample 301

As in Example 1, 15.1 g of MEK was added to 50 g of an organic silver salt dispersion under agitation and in a nitrogen flow, and the mixture was maintained at 24° C. Then 2.5 ml of a 10 mass % methanol solution of the following antifogging agent 1 were added, and agitation was conducted for 15 minutes. Then 2.5 g of a sensitizing dye-3 (in 0.24 mass % MEK solution) and 1.8 ml of a solution, in which the following dye adsorption promoter and potassium acetate were present in 1:5 mass ratio and the dye adsorption promoter was present at 20 mass %, were added and agitation was conducted for 15 minutes. Subsequently, 7 ml of a mixed solution of 4-chloro-2-benzoylbenzoic acid and 5-methyl-2-mercaptobenzimidazole, which is a super sensitizer, (mixing mass ratio=25:2, 3.0 mass % in total in methanol), and 3.5×10⁻³ moles of a polyhalogen compound-1 were added and agitation was conducted for 1 hour. Thereafter the temperature was lowered to 13° C. and agitation was further conducted for 30 minutes. While the temperature was maintained at 13° C., 15 g of a binder shown in Table 4 was added, and, after sufficient dissolving thereof, the following additives were added. All these operations were conducted under a nitrogen flow.

| | |
|---|---|
| phthalazine | 1.5 g |
| tetrachlorophthalic acid | 0.5 g |
| 4-methylphthalic acid | 0.5 g |
| hydrogen bonding compound-1 | 0.67 g |
| reducing agent-1 | 0.92 g |
| development accelerator-1 | 0.046 g |
| development accelerator-2 | 0.039 g |
| dye 2 | 2.0 g |
| aliphatic isocyanate | 1.10 g |
| (trade name: Desmodur N3300, manufactured by Mobey) | |

Preparation of Coating Liquids for Samples −302 to −325

Coating liquids were prepared in the same manner as the coating liquid for the sample 301 except that the binder, organic silver and reducing agent were replaced with those shown in Table 4. The binder was replaced with a same weight, the organic silver salt was replaced with a same silver amount, and the reducing agent was replaced with an equimolar amount. 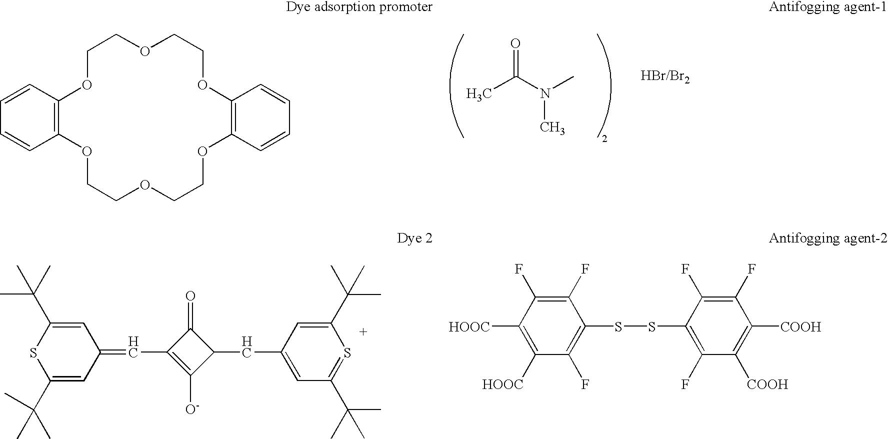 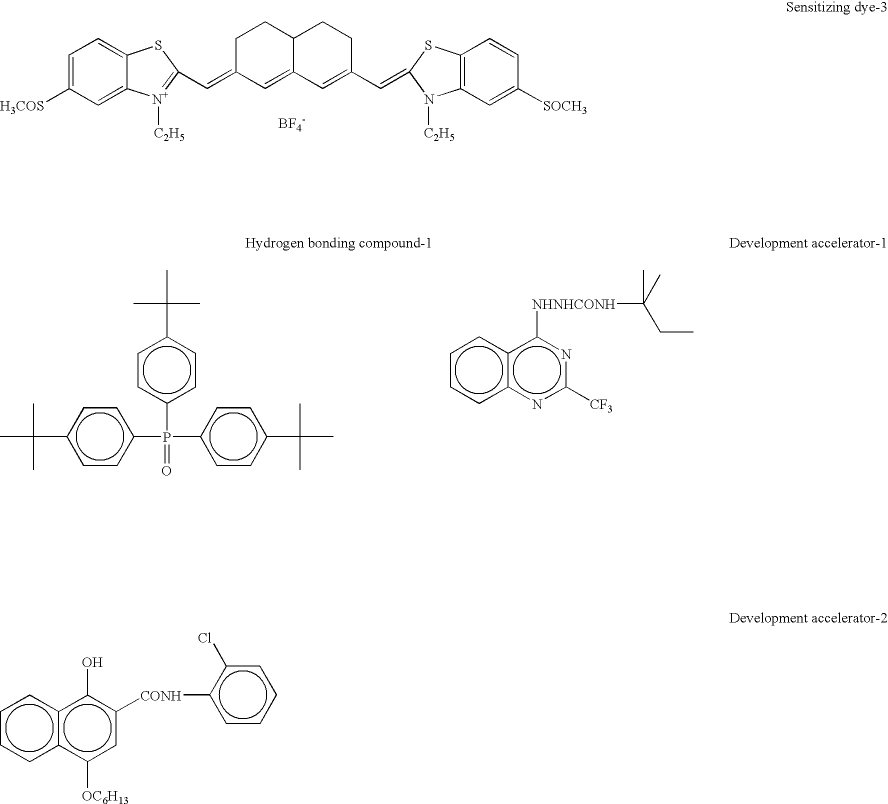
2) Coating

Image forming layer: a coating liquid obtained above was dehydrated with a dehydrating agent shown in Table 4 and was then coated with a silver coating amount of 1.7 g/m² on a side opposite to a side, coated with a back layer, of a substrate bearing the back layer same as in Example 1.

Surface protective layer: the following coating liquid was coated with a wet coating thickness of 100 μm:

| | | |
|---|---|---|
| acetone | 175 | ml |
| 2-propanol | 40 | ml |
| methanol | 15 | ml |
| cellulose acetate | 8 | g |
| phthalazine | 1.5 | g |
| 4-methylphthalazine | 0.72 | g |
| tetrachlorophthalic acid | 0.22 | g |
| tetrachlorophthalic anhydride | 0.5 | g |
| mono-dispersion silica with average particle size of 4 μm | 0.5 | g |
| (variation factor 20%): 1 mass % to binder fluorinated | | |
| surfactant (trade name: Surflon KH40, Asahi Glass Co.) | | |

3) Exposure and Thermal Development

After drying as shown in Table 4, an exposure and a thermal development were executed as in Example 1.

Performance of the obtained image was measured as in Example 1, and obtained results are shown in Table 4.

TABLE 4

| | | | Behenic acid | | | In-bag | Photosensitive | | | |
|---|---|---|---|---|---|---|---|---|---|---|
| Sample | Binder | | content | | | humidity | material water | Storage | | |
| No. | Type | Tg(° C.) | (mol. %) | Reducing agent | Dehydrating agent | (% RH) | content (mass %) | stability ΔE | Dmax | Remarks |
| 301 | comp-1 | 65 | 55 | red.agent-1 | none | 55 | 3.5 | 6.5 | 100 | comp. ex. |
| 302 | comp-1 | 65 | 55 | red.agent-1 | magnesium sulfate | 32 | 0.3 | 0.4 | 100 | invention |
| 303 | comp-1 | 65 | 55 | red.agent-1 | sodium sulfate | 35 | 0.5 | 0.3 | 102 | invention |
| 304 | comp-1 | 65 | 55 | red.agent-1 | alumina | 47 | 1.6 | 0.5 | 101 | invention |
| 305 | comp-1 | 65 | 55 | red.agent-1 | silica gel | 45 | 1.7 | 0.4 | 100 | invention |
| 306 | comp-1 | 65 | 55 | red.agent-1 | magnesium sulfate | 32 | 0.3 | 0.5 | 102 | invention |
| 307 | comp-1 | 65 | 45 | red.agent-1 | magnesium sulfate | 45 | 1.5 | 3.5 | 102 | comp. ex. |
| 308 | comp-1 | 65 | 70 | red.agent-1 | magnesium sulfate | 36 | 0.4 | 0.3 | 102 | invention |
| 309 | comp-1 | 65 | 85 | red.agent-1 | magnesium sulfate | 30 | 0.3 | 0.1 | 101 | invention |
| 310 | comp-1 | 65 | 98 | red.agent-1 | magnesium sulfate | 32 | 0.3 | 0.1 | 103 | invention |
| 311 | P-2 | 75 | 45 | red.agent-1 | magnesium sulfate | 46 | 0.9 | 0.4 | 102 | invention |
| 312 | P-5 | 88 | 45 | red.agent-1 | magnesium sulfate | 37 | 0.4 | 0.4 | 100 | invention |
| 313 | P-6 | 104 | 45 | red.agent-1 | magnesium sulfate | 35 | 0.3 | 0.3 | 99 | invention |
| 314 | comp-1 | 65 | 45 | R-5 | magnesium sulfate | 42 | 0.9 | 0.3 | 102 | invention |
| 315 | comp-1 | 65 | 45 | R-4 | magnesium sulfate | 40 | 0.9 | 0.2 | 105 | invention |
| 316 | comp-1 | 65 | 45 | R-6 | magnesium sulfate | 38 | 0.8 | 0.4 | 103 | invention |
| 317 | comp-1 | 65 | 45 | R-8 | magnesium sulfate | 43 | 1 | 0.3 | 102 | invention |
| 318 | comp-1 | 65 | 45 | R-10 | magnesium sulfate | 35 | 0.5 | 0.1 | 100 | invention |
| 319 | comp-1 | 65 | 45 | R-18 | magnesium sulfate | 41 | 0.9 | 0.2 | 104 | invention |
| 320 | P-2 | 75 | 70 | R-5 | sodium sulfate | 35 | 0.5 | 0.4 | 102 | invention |
| 321 | P-5 | 88 | 70 | R-5 | sodium sulfate | 38 | 0.6 | 0.3 | 100 | invention |
| 322 | P-6 | 104 | 70 | R-5 | sodium sulfate | 32 | 0.4 | 0.3 | 102 | invention |
| 323 | P-5 | 88 | 85 | R-4 | sodium sulfate | 33 | 0.4 | 0.4 | 100 | invention |
| 324 | P-5 | 88 | 85 | R-6 | sodium sulfate | 32 | 0.5 | 0.2 | 103 | invention |
| 325 | P-5 | 88 | 98 | R-9 | sodium sulfate | 33 | 0.3 | 0.2 | 101 | invention |

Table 4 indicates that the samples constituting combinations of the present invention provided photothermographic materials showing a low fog level and an excellent image storability.

### Example 4

Samples of photothermographic materials-401 to -403 were prepared in the same manner as in Example 1, except for preparing the image forming layer coating liquids by adding, in the photothermographic material-18 in Example 1, development accelerators of the invention by 5 mol. % to the reducing agent.

The sample-18 and the samples-401 to -403 were subjected to a sensitivity measurement. The sensitivity was determined from a logarithmic value of an exposure amount providing a density of 1.5, and given as a relative value, taking the sample No. 18 as reference.

TABLE 5

| | | | Behenic | | | | | | | | | |
|---|---|---|---|---|---|---|---|---|---|---|---|---|
| | Binder | | acid | | | | In-bag | Photosensitive | | Storage | | |
| Sample | | Tg | content | Reducing | Development | Drying | humidity | material water | | stability | | |
| No. | Type | (° C.) | (mol. %) | agent | accelerator | condition | (% RH) | content (mass %) | Sensitivity | ΔE | Dmax | Remarks |
| 18 | P-2 | 75 | 55 | R-5 | none | 90° C., | 39 | 1.2 | 100 | 0.2 | 104 | invention |
| | | | | | | 1 min. | | | | | | |
| 401 | P-2 | 75 | 55 | R-5 | A-1 | 90° C., | 35 | 1.1 | 108 | 0.3 | 109 | invention |
| | | | | | | 1 min. | | | | | | |
| 402 | P-2 | 75 | 55 | R-5 | A-7 | 90° C., | 33 | 1.0 | 110 | 0.2 | 110 | invention |
| | | | | | | 1 min. | | | | | | |
| 403 | P-2 | 75 | 55 | R-5 | A-12 | 90° C., | 45 | 1.5 | 110 | 0.4 | 109 | invention |
| | | | | | | 1 min. | | | | | | |

As shown in Table 5, the addition of a development accelerator enabled to increase the development activity and to improve the apparent sensitivity. On the other hand, the storage stability was not deteriorated, and there could be obtained photothermographic materials satisfactory in all the performances including the sensitivity and Dmax.

As detailedly explained in the foregoing, the present invention provides a packaged member of a photothermographic material capable of satisfactory storage of the photosensitive material over time, thereby enabling to utilize a method that is good for satisfactory image formation with the photothermographic material.

1. A packaged member which comprises a photothermographic material and a packaging bag, wherein
an interior of the packaging bag into which the photothermographic material is packed has a humidity of 50% RH or less at 25° C.,
the photothermographic material includes, on one surface of a substrate, an image forming layer comprising a photosensitive silver halide, a non-photosensitive organic silver salt, a reducing agent and a binder, and
at least one of the following conditions (1) to (4) is satisfied:
(1) 50 mass % or more of the binder is a polymer having a glass transition temperature from 70 to 110° C.;
(2) 50 mol. % or more of the non-photosensitive organic silver salt is silver behenate;
(3) the reducing agent is a compound represented by the following Formula (B): 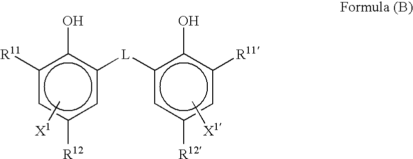
wherein R¹¹ and R^{11′} each independently represent a secondary or tertiary alkyl group having 3 to 15 carbon atoms; R¹² and R^{12′} each independently represent a hydrogen atom or a substituent on a benzene ring; L represents an —S— group or a CHR¹³— group; R¹³ represents a hydrogen atom or an alkyl group having 1 to 20 carbon atoms; and X¹ and X^{1′} each independently represent a hydrogen atom or a substituent on a benzene ring; and
(4) the photothermographic material includes a development accelerator.

2. The packaged member of claim 1, wherein the condition (1) is satisfied.

3. The packaged member of claim 1, wherein the condition (2) is satisfied.

4. The packaged member of claim 1, wherein the condition (3) is satisfied.

5. The packaged member of claim 1, wherein the condition (4) is satisfied.

6. The packaged member of claim 1, wherein the conditions (1) and (2) are satisfied.

7. The packaged member of claim 1, wherein the conditions (1), (2) and (3) are satisfied.

8. The packaged member of claim 1, wherein the conditions (1), (2), (3) and (4) are satisfied.

9. The packaged member of claim 1, wherein the interior of the bag has a humidity of 10 to 40% RH at 25° C.

10. The packaged member of claim 1, wherein the photothermographic material immediately after being taken out from the bag has a water content of 3 mass % or less at 25° C.

11. The packaged member of claim 1, wherein the binder includes polyvinyl acetal.

12. The packaged member of claim 1, wherein a coating liquid for forming the photothermographic material includes an organic solvent.

13. The packaged member of claim 1, wherein the image forming layer contains silver in an amount of 1.9 g/m² or less.

14. A image forming method which comprises exposing a photothermographic material and thermally developing the photothermographic material within a developing time from 1 to 60 seconds, wherein
the photothermographic material is packaged in a packaging bag before being exposed,
an interior of the packaging bag has a humidity of 50% RH or less at 25° C.,
the photothermographic material includes, on one surface of a substrate, an image forming layer comprising a photosensitive silver halide, a non-photosensitive organic silver salt, a reducing agent and a binder, and
at least one of the following conditions (1) to (4) is satisfied:
(1) 50 mass % or more of the binder is a polymer having a glass transition temperature from 70 to 110° C.;
(2) 50 mol. % or more of the non-photosensitive organic silver salt is silver behenate;
(3) the reducing agent is a compound represented by the following Formula (B): 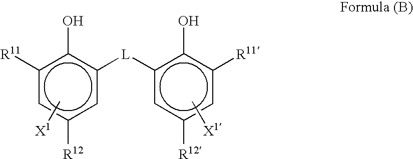
wherein R¹¹ and R^{11′} each independently represent a secondary or tertiary alkyl group having 3 to 15 carbon atoms; R¹² and R^{12′} each independently represent a hydrogen atom or a substituent on a benzene ring; L represents an —S— group or a CHR¹³— group; R¹³ represents a hydrogen atom or an alkyl group having 1 to 20 carbon atoms; and X¹ and X^{1′} each independently represent a hydrogen atom or a substituent on a benzene ring; and
(4) the photothermographic material includes a development accelerator.

15. The image forming method of claim 14, wherein the thermal developing is conducted within a developing time from 3 to 13 seconds.

16. The image forming method of claim 14, wherein the thermal developing utilizes a heat drum and is executed by heating the photothermographic material from a side of the substrate at which photosensitive silver halide and the non-photosensitive organic silver salt are disposed.
